(19) United States
(12) Patent Application Publication
(10) Pub. No.: US 2011/0118427 A1
(43) Pub. Date: May 19, 2011

(54) Transition Metal Complex And Process For Production Thereof, Olefin Polymerization Catalyst, Process For Production of Polyolefin Resin, And Substituted Fluorene Compound And Process For Production Thereof

(75) Inventors: Takahiro Hino, Chiba (JP); Hidenori Hanaoka, Osaka (JP); Taichi Senda, Osaka (JP)

(73) Assignee: SUMITOMO CHEMICAL COMPANY, LIMITED

(21) Appl. No.: 13/002,974

(22) PCT Filed: Jul. 7, 2009
(86) PCT No.: PCT/JP2009/062649

§ 371 Date: Jan. 6, 2011

(30) Foreign Application Priority Data
Jul. 9, 2008 (JP) 2008-178871

(51) Int. Cl. C08F 4/76; C07F 7/28; C07F 7/08

(52) U.S. Cl. 526/126; 556/11; 556/448; 556/445; 556/482; 556/467

(57) ABSTRACT

Disclosed are a transition metal complex represented by the formula (1) and a method for producing the same; a substituted fluorene compound represented by the formula (2) and a method for producing the same; an olefin polymerization catalyst including the transition metal complex as a constituent component; and a method for producing a polyolefin resin, which includes polymerizing an olefin in the presence of the olefin polymerization catalyst.

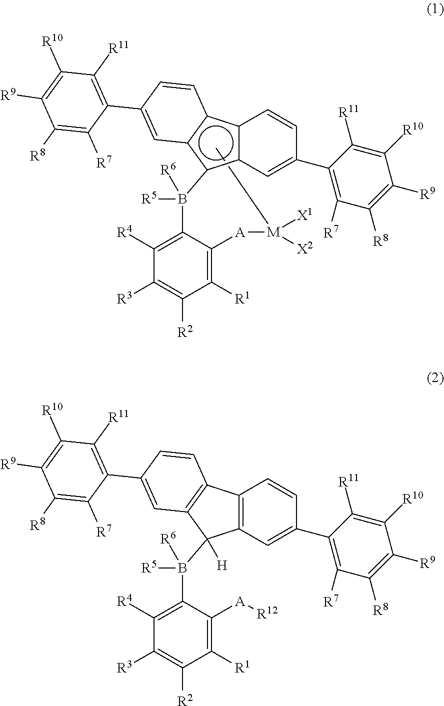

### TECHNICAL FIELD

The present invention relates to a transition metal complex and a method for producing the same, an olefin polymerization catalyst, a method for producing a polyolefin resin, and a substituted fluorene compound and a method for producing the same.

### BACKGROUND ART

Various reports have been made on a method for producing an olefin polymer using a metallocene complex.

For example, a method for producing an olefin polymer using a metallocene complex and aluminoxane has been reported (JP-A-58-19309).

Also, there has been reported a method for producing a copolymer of ethylene and α-olefin using a transition metal complex having a ligand in which an aromatic ring having a hetero substituent and a cyclopentadienyl ring are linked via a covalent bond group (JP-A-9-87313 and JP-A-2007-217284).

The method of the prior art, as described, for example, in JP-A-58-19309, in which olefin polymerization is conducted using bis(cyclopentadienyl)zirconium dichloride and methylaluminoxane as catalysts, has a problem that the obtained olefin polymer has a low molecular weight.

In order to solve such a problem, in the case where an ethylene-based copolymer is produced using a transition metal catalyst described in JP-A-9-87313 and JP-A-2007-217284, it was observed a tendency that, as the content of α-olefin in a copolymer to be produced increases, a molecular weight of the obtained copolymer decreases.

### DISCLOSURE OF THE INVENTION

Under these circumstances, an object of the present invention is to provide a transition metal complex which is useful for producing of a poly-1-butene polymer, and a method for producing the same; an olefin polymerization catalyst, and a method for producing a polyolefin resin using the olefin catalyst; and a substituted fluorene compound which is useful as a precursor of the transition metal complex, and a method for producing the same.

As a result of intensive studies, the present inventors have found that the above problems can be solved by means of the following <1> to <25>, and thus the present invention has been completed.

<1> A transition metal complex represented by the following formula (1):

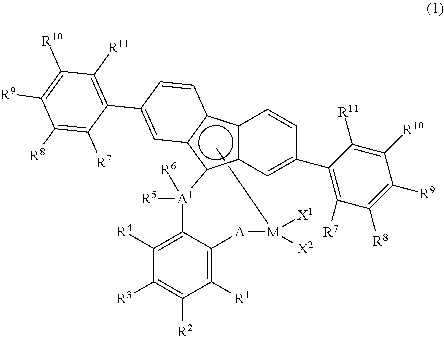

in the formula (1), M represents a Group 4 transition metal atom of the Periodic Table of elements; A represents a Group 16 atom of the Periodic Table of elements; A¹ represents a Group 14 atom of the Periodic Table of elements; X¹ and X² each independently represents a hydrogen atom, a halogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom, or a hydrocarbon disubstituted amino group having 2 to 20 carbon atoms; R¹, R², R³ and R⁴ each independently represents a hydrogen atom, a halogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, a hydrocarbon-substituted silyl group having 1 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom, or a hydrocarbon disubstituted amino group having 2 to 20 carbon atoms; R⁵ and R⁶ each independently represents a hydrogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, a hydrocarbon-substituted silyl group having 1 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom, or a hydrocarbon disubstituted amino group having 2 to 20 carbon atoms and, in R¹, R², R³, R⁴, R⁵ and R⁶, adjacent groups are optionally joined to form a ring; and R⁷, R⁸, R⁹, R¹⁰ and R¹¹ each independently represents a hydrogen atom or an alkyl group having 1 to 20 carbon atoms optionally substituted with a halogen atom and at least one of them is not a hydrogen atom.
<2> The transition metal complex according to <1>, wherein R⁷ and R¹¹ are hydrogen atoms.
<3> The transition metal complex according to <1> or <2>, wherein A is an oxygen atom.
<4> The transition metal complex according to any one of <1> to <3>, wherein R¹ is an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, or a hydrocarbon-substituted silyl group having 1 to 20 carbon atoms optionally substituted with a halogen atom.
<5> The transition metal complex according to any one of <1> to <4>, wherein M is a titanium atom.
<6> The transition metal complex according to any one of <1> to <5>, wherein A¹ is a silicon atom.
<7> The transition metal complex according to any one of <1> to <6>, wherein X¹ and X² each independently is a halogen atom.
<8> The transition metal complex according to any one of <1> to <7>, wherein at least one of R⁸, R⁹ and R¹⁰ is an alkyl group having 1 to 20 carbon atoms.
<9> The transition metal complex according to any one of <1> to <8>, wherein R⁹ is an alkyl group having 1 to 20 carbon atoms.
<10> The transition metal complex according to <9>, wherein R⁹ is a n-butyl group.
<11> The transition metal complex according to any one of <1> to <9>, wherein R⁹ is an alkyl group having 1 to 20 carbon atoms, and all of R⁷, R⁸, R¹⁰ and R¹¹ are hydrogen atoms.
<12> The transition metal complex according to <11>, wherein R⁹ is a n-butyl group, and all of R⁷, R⁸, R¹⁰ and R¹¹ are hydrogen atoms.
<13> The transition metal complex according to any one of <1> to <12>, which is a transition metal complex represented by the following formula (1-1):

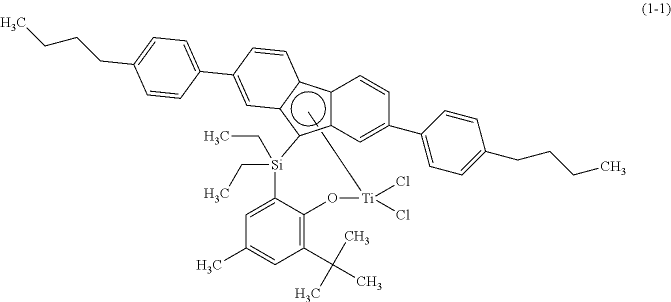

<14> A method for producing the transition metal complex according to any one of <1> to <13>, which comprises

step I of reacting a substituted fluorene compound represented by the formula (2) with a metal element-containing basic compound, and

step II of reacting the compound obtained by step I with a dihalogenated diamido transition metal complex represented by the formula (3).

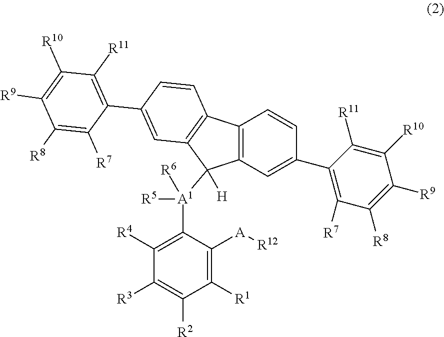

in the formula (2), A represents a Group 16 atom of the Periodic Table of elements; A¹ represents a Group 14 atom of the Periodic Table of elements; R¹, R², R³ and R⁴ each independently represents a hydrogen atom, a halogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, a hydrocarbon-substituted silyl group having 1 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom, or a hydrocarbon disubstituted amino group having 2 to 20 carbon atoms; R⁵ and R⁶ each independently represents a hydrogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, a hydrocarbon-substituted silyl group having 1 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom, or a hydrocarbon disubstituted amino group having 2 to 20 carbon atoms and, in R¹, R², R³, R⁴, R⁵ and R⁶, adjacent groups are optionally joined to form a ring; R⁷, R⁸, R⁹, R¹⁰ and R¹¹ each independently represents a hydrogen atom, or an alkyl group having 1 to 20 carbon atoms optionally substituted with a halogen atom, and at least one of them is not a hydrogen atom; and R¹² represents a hydrocarbon group or a trisubstituted silyl group, and the hydrocarbon group is optionally substituted with a halogen atom or an alkoxy group;

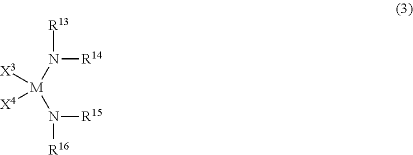

in the formula (3), M represents a Group 4 element of the Periodic Table of elements; R¹³, R¹⁴, R¹⁵ and R¹⁶ each independently represents an alkyl group having 1 to 20 carbon atoms, an aryl group having 6 to 20 carbon atoms, or an aralkyl group having 7 to 20 carbon atoms and, in R¹³, R¹⁴, R¹⁵ and R¹⁶, the alkyl group, the aryl group or the aralkyl group is optionally substituted with a halogen atom, R¹³ and R¹⁴ are optionally joined to form a ring, R¹⁵ and R¹⁶ are optionally joined to form a ring; and X³ and X⁴ represent halogen atoms.
<15> The method for producing the transition metal complex according to <14>, which further comprises step III of reacting the complex obtained by step II with a halogenated silyl compound represented by the formula (4):

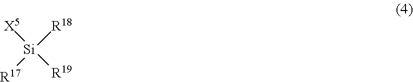

in the formula (4), R¹⁷, R¹⁸ and R¹⁹ each independently represents a halogen atom, an alkyl group having 1 to 20 carbon atoms, an aryl group having 6 to 20 carbon atoms, or an aralkyl group having 7 to 20 carbon atoms and, in R¹⁷, R¹⁸ and R¹⁹, the alkyl group, the aryl group or the aralkyl group is optionally substituted with a halogen atom, and two of R¹⁷, R¹⁸ and R¹⁹ are optionally joined to form a ring; and X⁵ represents a halogen atom.
<16> An olefin polymerization catalyst comprising the transition metal complex according to any one of <1> to <13> as a constituent component.
<17> The olefin polymerization catalyst according to <16>, which is for homopolymerization of 1-butene.
<18> A method for producing a polyolefin resin, which comprises the step of polymerizing an olefin in the presence of the olefin polymerization catalyst according to <16>.
<19> The method for producing a polyolefin resin according to <18>, wherein the olefin is 1-butene.
<20> A substituted fluorene compound represented by the formula (2):

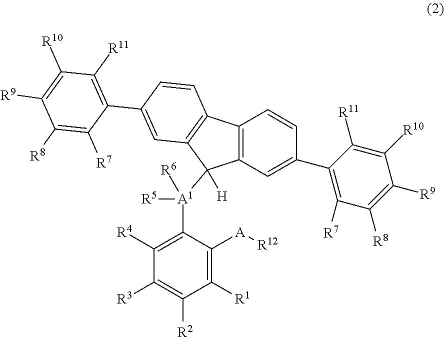

in the formula (2), A represents a Group 16 atom of the Periodic Table of elements; A¹ represents a Group 14 atom of the Periodic Table of elements; R¹, R², R³ and R⁴ each independently represents a hydrogen atom, a halogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, a hydrocarbon-substituted silyl group having 1 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom, or a hydrocarbon disubstituted amino group having 2 to 20 carbon atoms; R⁵ and R⁶ each independently represents a hydrogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, a hydrocarbon-substituted silyl group having 1 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom, or a hydrocarbon disubstituted amino group having 2 to 20 carbon atoms and, in R¹, R², R³, R⁴, R⁵ and R⁶, adjacent groups are optionally joined to form a ring; R⁷, R⁸, R⁹, R¹⁰ and R¹¹ each independently represents a hydrogen atom or an alkyl group having 1 to 20 carbon atoms optionally substituted with a halogen atom, and at least one of them is not a hydrogen atom; and R¹² represents a hydrocarbon group or a trisubstituted silyl group, and the hydrocarbon group is optionally substituted with a halogen atom or an alkoxy group.
<21> The substituted fluorene compound according to <20>, wherein R⁷ and R¹¹ are hydrogen atoms.
<22> The substituted fluorene compound according to <20> or <21>, wherein A¹ is a silicon atom.
<23> The substituted fluorene compound according to <20> or <21>, which is a ligand precursor of a transition metal complex.
<24> The substituted fluorene compound according to any one of <20> to <23>, which is a ligand precursor of a transition metal complex for homopolymerization of 1-butene.
<25> A method for producing the substituted fluorene compound according to claim 20 or 21, which comprises:

step Ia of reacting a substituted fluorene compound represented by the formula (5) with a metal element-containing basic compound, and

step IIa of reacting the compound obtained by step Ia with a compound represented by the formula (6):

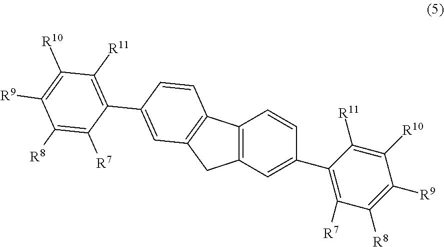

in the formulas (5), R⁷, R⁸, R⁹, R¹⁰ and R¹¹ each independently represents a hydrogen atom or an alkyl group having 1 to 20 carbon atoms optionally substituted with a halogen atom, and at least one of R⁷, R⁸, R⁹, R¹⁰ and R¹¹ is not a hydrogen atom;

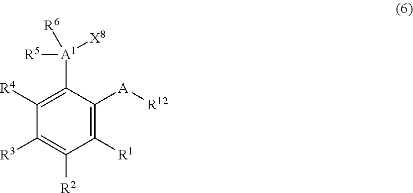

in the formula (6), A represents a Group 16 atom of the Periodic Table of elements; A¹ represents a Group 14 atom of the Periodic Table of elements; R¹, R², R³ and R⁴ each independently represents a hydrogen atom, a halogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, a hydrocarbon-substituted silyl group having 1 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom, or a hydrocarbon disubstituted amino group having 2 to 20 carbon atoms; R⁵ and R⁶ each independently represents a hydrogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, a hydrocarbon-substituted silyl group having 1 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom or a hydrocarbon disubstituted amino group having 2 to 20 carbon atoms and, in R¹, R², R³, R⁴, R⁵ and R⁶, adjacent groups are optionally joined to form a ring; R¹² represents a hydrocarbon group or a trisubstituted silyl group, and the hydrocarbon group is optionally substituted with a halogen atom or an alkoxy group; and X⁸ represents a halogen atom.

### EFFECTS OF THE INVENTION

According to the present invention, it is possible to provide a transition metal complex which is useful for producing a poly-1-butene polymer, and a method for producing the same; an olefin polymerization catalyst, and a method for producing a polyolefin resin using the olefin catalyst; and a substituted fluorene compound which is useful as a precursor of the transition metal complex, and a method for producing the same.

### MODE FOR CARRYING OUT THE INVENTION

Hereinafter, the present invention will be described in detail.

### [Transition Metal Complex]

The transition metal complex of the present invention is a transition metal complex represented by the following formula (1) (hereinafter referred to as a transition metal complex (1)):

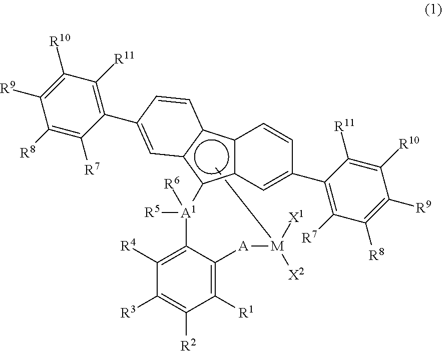

in the formula (1), M, A, A¹, X¹, X², R¹, R², R³, R⁴, R⁵, R⁶, R⁷, R⁸, R⁹, R¹⁰ and R¹¹ are respectively as defined above.

The transition metal atom in M is a Group 4 transition metal atom of the Periodic Table of elements (IUPAC Inorganic Chemistry Nomenclature, Revised Edition, 1989) and includes, for example, a titanium atom, a zirconium atom and a hafnium atom, preferably a titanium atom.

The Group 16 atom of the Periodic Table of elements in A includes, for example, an oxygen atom, a sulfur atom and a selenium atom, preferably an oxygen atom.

The Group 14 atom of the Periodic Table of elements in A¹ includes, for example, a carbon atom, a silicon atom and a germanium atom, preferably a silicon atom.

Examples of the halogen atom in the substituents X¹, X², R¹, R², R³ and R⁴ include a fluorine atom, a chlorine atom, a bromine atom and an iodine atom, preferably a chlorine atom.

In the substituents X¹, X², R¹, R², R³, R⁴, R⁵ and R⁶, examples of the alkyl group having 1 to 20 carbon atoms optionally substituted with a halogen atom include the following alkyl group having 1 to 20 carbon atoms and the following alkyl group having 1 to 20 carbon atoms substituted with a halogen atom.

The alkyl group having 1 to 20 carbon atoms includes, for example, a methyl group, an ethyl group, a n-propyl group, an isopropyl group, a n-butyl group, a sec-butyl group, a tert-butyl group, a n-pentyl group, a neopentyl group, an amyl group, a n-hexyl group, a n-octyl group, a n-decyl group, a n-dodecyl group, a n-pentadecyl group and a n-eicosyl group, preferably an alkyl group having 1 to 5 carbon atoms such as a methyl group, an ethyl group, an isopropyl group, a n-butyl group, a tert-butyl group and an amyl group.

Examples of the alkyl group having 1 to 20 carbon atoms substituted with a halogen atom include groups in which any one of these alkyl groups is substituted with a halogen atom such as a fluorine atom, a chlorine atom, a bromine atom and an iodine atom.

The alkyl group having 1 to 20 carbon atoms substituted with a halogen atom includes, for example, a fluoromethyl group, a difluoromethyl group, a trifluoromethyl group, a chloromethyl group, a dichloromethyl group, a trichloromethyl group, a bromomethyl group, a dibromomethyl group, a tribromomethyl group, an iodomethyl group, a diiodomethyl group, a triiodomethyl group, a fluoroethyl group, a difluoroethyl group, a trifluoroethyl group, a tetrafluoroethyl group, a pentafluoroethyl group, a chloroethyl group, a dichloroethyl group, a trichloroethyl group, a tetrachloroethyl group, a pentachloroethyl group, a bromoethyl group, a dibromoethyl group, a tribromoethyl group, a tetrabromoethyl group, a pentabromoethyl group, a perfluoropropyl group, a perfluorobutyl group, a perfluoropentyl group, a perfluorohexyl group, a perfluorooctyl group, a perfluorododecyl group, a perfluoropentadecyl group, a perfluoroeicosyl group, a perchloropropyl group, a perchlorobutyl group, a perchloropentyl group, a perchlorohexyl group, a perchlorooctyl group, a perchlorododecyl group, a perchloropentadecyl group, a perchloroeicosyl group, a perbromopropyl group, a perbromobutyl group, a perbromopentyl group, a perbromohexyl group, a perbromooctyl group, a perbromododecyl group, a perbromopentadecyl group and a perbromoeicosyl group.

In the substituents X¹, X², R¹, R², R³, R⁴, R⁵ and R⁶, the aralkyl group having 7 to 20 carbon atoms optionally substituted with a halogen atom includes the following aralkyl group having 1 to 20 carbon atoms and the following aralkyl group having 7 to 20 carbon atoms substituted with a halogen atom.

The aralkyl group having 7 to 20 carbon atoms includes, for example, a benzyl group, a (2-methylphenyl)methyl group, a (3-methylphenyl)methyl group, a (4-methylphenyl)methyl group, a (2,3-dimethylphenyl)methyl group, a (2,4-dimethylphenyl)methyl group, a (2,5-dimethylphenyl)methyl group, a (2,6-dimethylphenyl)methyl group, a (3,4-dimethylphenyl)methyl group, a (4,6-dimethylphenyl)methyl group, a (2,3,4-trimethylphenyl)methyl group, a (2,3,5-trimethylphenyl)methyl group, a (2,3,6-trimethylphenyl)methyl group, a (3,4,5-trimethylphenyl)methyl group, a (2,4,6-trimethylphenyl)methyl group, a (2,3,4,5-tetramethylphenyl)methyl group, a (2,3,4,6-tetramethylphenyl)methyl group, a (2,3,5,6-tetramethylphenyl)methyl group, a (pentamethylphenyl)methyl group, an (ethylphenyl)methyl group, a (n-propylphenyl)methyl group, an (isopropylphenyl)methyl group, a (n-butylphenyl)methyl group, a (sec-butylphenyl)methyl group, a (tert-butylphenyl)methyl group, a (n-pentylphenyl)methyl group, a (neopentylphenyl)methyl group, a (n-hexylphenyl)methyl group, a (n-octylphenyl)methyl group, a (n-decylphenyl)methyl group, a (n-decylphenyl)methyl group, a naphthylmethyl group and an anthracenylmethyl group, preferably a benzyl group.

Examples of the aralkyl group having 7 to 20 carbon atoms substituted with a halogen atom include groups in which any one of these aralkyl groups is substituted with a halogen atom such as a fluorine atom, a chlorine atom, a bromine atom and an iodine atom.

In the substituents X¹, X², R¹, R², R³, R⁴, R⁵ and R⁶, examples of the aryl group having 6 to 20 carbon atoms optionally substituted with a halogen atom include the following aryl group having 6 to 20 carbon atoms and the following aryl group having 6 to 20 carbon atoms substituted with a halogen atom.

The aryl group having 6 to 20 carbon atoms includes, for example, a phenyl group, a 2-tolyl group, a 3-tolyl group, a 4-tolyl group, a 2,3-xylyl group, a 2,4-xylyl group, a 2,5-xylyl group, a 2,6-xylyl group, a 3,4-xylyl group, a 3,5-xylyl group, a 2,3,4-trimethylphenyl group, a 2,3,5-trimethylphenyl group, a 2,3,6-trimethylphenyl group, a 2,4,6-trimethylphenyl group, a 3,4,5-trimethylphenyl group, a 2,3,4,5-tetramethylphenyl group, a 2,3,4,6-tetramethylphenyl group, a 2,3,5,6-tetramethylphenyl group, a pentamethylphenyl group, an ethylphenyl group, a n-propylphenyl group, an isopropylphenyl group, a n-butylphenyl group, a sec-butylphenyl group, a tert-butylphenyl group, a n-pentylphenyl group, a neopentylphenyl group, a n-hexylphenyl group, a n-octylphenyl group, a n-decylphenyl group, a n-dodecylphenyl group, a n-tetradecylphenyl group, a naphthyl group and an anthracenyl group, preferably a phenyl group.

Examples of the aryl group having 6 to 20 carbon atoms substituted with a halogen atom include any of these aryl groups which has been substituted with a halogen atom such as a fluorine atom, a chlorine atom, a bromine atom and an iodine atom.

In the substituents R¹, R², R³, R⁴, R⁵ and R⁶, examples of the hydrocarbon-substituted silyl group having 1 to 20 carbon atoms optionally substituted with a halogen atom include the following hydrocarbon-substituted silyl group and the following hydrocarbon-substituted silyl group substituted with a halogen atom.

The hydrocarbon-substituted silyl group is a silyl group substituted with a hydrocarbon group having 1 to 20 carbon atoms.

Herein, the hydrocarbon group includes, for example, an alkyl group having 1 to 10 carbon atoms such as a methyl group, an ethyl group, a n-propyl group, an isopropyl group, a n-butyl group, a sec-butyl group, a tert-butyl group, an isobutyl group, a n-pentyl group, a n-hexyl group and a cyclohexyl group; and an aryl group such as a phenyl group.

The hydrocarbon-substituted silyl group includes, for example, a hydrocarbon-monosubstituted silyl group having 1 to 20 carbon atoms such as a methylsilyl group, an ethylsilyl group and a phenylsilyl group; a hydrocarbon-disubstituted silyl group having 2 to 20 carbon atoms such as a dimethylsilyl group, a diethylsilyl group and a diphenylsilyl group; and a hydrocarbon-trisubstituted silyl group having 3 to 20 carbon atoms such as a trimethylsilyl group, a triethylsilyl group, a tri-n-propylsilyl group, a triisopropylsilyl group, a tri-n-butylsilyl group, a tri-sec-butylsilyl group, a tri-tert-butylsilyl group, a tri-isobutylsilyl group, a tert-butyldimethylsilyl group, a tri-n-pentylsilyl group, a tri-n-hexylsilyl group, a tricyclohexylsilyl group and a triphenylsilyl group; preferably a hydrocarbon trisubstituted silyl group having 3 to 20 carbon atoms, and more preferably a trimethylsilyl group, a tert-butyldimethylsilyl group and a triphenylsilyl group.

Examples of the hydrocarbon-substituted silyl group substituted with a halogen atom include groups in which a hydrocarbon group in any one of these hydrocarbon-substituted silyl groups is substituted with a halogen atom such as a fluorine atom, a chlorine atom, a bromine atom and an iodine atom.

In the substituents X¹, X², R¹, R², R³, R⁴, R⁵ and R⁶, examples of the alkoxy group having 1 to 20 carbon atoms optionally substituted with a halogen atom include the following alkoxy group having 1 to 20 carbon atoms and the following alkoxy group having 1 to 20 carbon atoms substituted with a halogen atom.

The alkoxy group having 1 to 20 carbon atoms includes, for example, a methoxy group, an ethoxy group, a n-propoxy group, an isopropoxy group, a n-butoxy group, a sec-butoxy group, a tert-butoxy group, a n-pentoxy group, a neopentoxy group, a n-hexoxy group, a n-octoxy group, a n-dodesoxy group, a n-pentadesoxy group and a n-icosoxy group, preferably an alkoxy group having 1 to 4 carbon atoms such as a methoxy group, an ethoxy group and a tert-butoxy group.

Examples of the alkoxy group having 1 to 20 carbon atoms substituted with a halogen atom include groups in which any one of these alkoxy groups is substituted with a halogen atom such as a fluorine atom, a chlorine atom, a bromine atom and an iodine atom.

In the substituents X¹, X², R¹, R², R³, R⁴, R⁵ and R⁶, examples of the aralkyloxy group having 7 to 20 carbon atoms optionally substituted with a halogen atom include the following aralkyloxy group having 7 to 20 carbon atoms and the following aralkyloxy group having 7 to 20 carbon atoms substituted with a halogen atom.

The aralkyloxy group having 7 to 20 carbon atoms includes, for example, a benzyloxy group, a (2-methylphenyl)methoxy group, a (3-methylphenyl)methoxy group, a (4-methylphenyl)methoxy group, a (2,3-dimethylphenyl)methoxy group, a (2,4-dimethylphenyl)methoxy group, a (2,5-dimethylphenyl)methoxy group, a (2,6-dimethylphenyl)methoxy group, a (3,4-dimethylphenyl)methoxy group, a (3,5-dimethylphenyl)methoxy group, a (2,3,4-trimethylphenyl)methoxy group, a (2,3,5-trimethylphenyl)methoxy group, a (2,3,6-trimethylphenyl)methoxy group, a (2,4,5-trimethylphenyl)methoxy group, a (2,4,6-trimethylphenyl)methoxy group, a (3,4,5-trimethylphenyl)methoxy group, a (2,3,4,5-tetramethylphenyl)methoxy group, a (2,3,4,6-tetramethylphenyl)methoxy group, a (2,3,5,6-tetramethylphenyl)methoxy group, a (pentamethylphenyl)methoxy group, an (ethylphenyl)methoxy group, a (n-propylphenyl)methoxy group, an (isopropylphenyl)methoxy group, a (n-butylphenyl)methoxy group, a (sec-butylphenyl)methoxy group, a (tert-butylphenyl)methoxy group, a (n-hexylphenyl)methoxy group, a (n-octylphenyl)methoxy group, a (n-decylphenyl)methoxy group, a naphthylmethoxy group and an anthracenylmethoxy group, preferably a benzyloxy group.

Examples of the following aralkyloxy group having 7 to 20 carbon atoms substituted with a halogen atom include groups in which any one of these aralkyloxy groups is substituted with a halogen atom such as a fluorine atom, a chlorine atom, a bromine atom and an iodine atom.

In the substituents X¹, X², R¹, R², R³, R⁴, R⁵ and R⁶, examples of the aryloxy group having 6 to 20 carbon atoms optionally substituted with a halogen atom include the following aryloxy group having 6 to 20 carbon atoms and the following aryloxy group having 6 to 20 carbon atoms substituted with a halogen atom.

The aryloxy group having 6 to 20 carbon atoms includes, for example, a phenoxy group, a 2-methylphenoxy group, a 3-methylphenoxy group, a 4-methylphenoxy group, a 2,3-dimethylphenoxy group, a 2,4-dimethylphenoxy group, a 2,5-dimethylphenoxy group, a 2,6-dimethylphenoxy group, a 3,4-dimethylphenoxy group, a 3,5-dimethylphenoxy group, a 2,3,4-trimethylphenoxy group, a 2,3,5-trimethylphenoxy group, a 2,3,6-trimethylphenoxy group, a 2,4,5-trimethylphenoxy group, a 2,4,6-trimethylphenoxy group, a 3,4,5-trimethylphenoxy group, a 2,3,4,5-tetramethylphenoxy group, a 2,3,4,6-tetramethylphenoxy group, a 2,3,5,6-tetramethylphenoxy group, a pentamethylphenoxy group, an ethylphenoxy group, a n-propylphenoxy group, an isopropylphenoxy group, a n-butylphenoxy group, a sec-butylphenoxy group, a tert-butylphenoxy group, a n-hexylphenoxy group, a n-octylphenoxy group, a n-decylphenoxy group, a n-tetradecylphenoxy group, a naphthoxy group and an anthracenoxy group.

Examples of the following aryloxy group having 6 to 20 carbon atoms substituted with a halogen atom include groups in which any one of these aryloxy groups is substituted with a halogen atom such as a fluorine atom, a chlorine atom, a bromine atom and an iodine atom.

The hydrocarbon disubstituted amino group having 2 to 20 carbon atoms in the substituents X¹, X², R¹, R², R³, R⁴, R⁵ and R⁶ is an amino group substituted with two hydrocarbon groups.

Herein, the hydrocarbon group includes, for example, an alkyl group having 1 to 20 carbon atoms such as a methyl group, an ethyl group, a n-propyl group, an isopropyl group, a n-butyl group, a sec-butyl group, a tert-butyl group, an isobutyl group, a n-pentyl group, a n-hexyl group and an cyclohexyl group; and an aryl group such as a phenyl group.

The hydrocarbon disubstituted amino group having 2 to 20 carbon atoms includes, for example, a dimethylamino group, a diethylamino group, a di-n-propylamino group, diisopropylamino group, a di-n-butylamino group, a di-sec-butylamino group, a di-tert-butylamino group, a di-isobutylamino group, a tert-butylisopropylamino group, a di-n-hexylamino group, a di-n-octylamino group, a di-n-decylamino group and a diphenylamino group, preferably a hydrocarbon disubstituted amino group in which two hydrocarbons are alkyl groups having 1 to 4 carbon atoms, and more preferably a dimethylamino group and a diethylamino group.

In the substituents R¹, R², R³, R⁴, R⁵ and R⁶, adjacent groups are optionally joined to form a ring.

When adjacent groups among the substituents R¹, R², R³, R⁴, R⁵ and R⁶ are joined to form a ring, these substituents are optionally combined with the rings to which they are attached to form a fused polycyclic group such as a naphthyl group.

X¹ and X² are preferably halogen atoms, alkyl groups, aralkyl groups and the like, more preferably halogen atoms, and still more preferably chlorine atoms.

R¹ is preferably an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, a hydrocarbon-substituted silyl group having 1 to 20 carbon atoms optionally substituted with a halogen atom and the like, more preferably an alkyl group having 1 to 20 carbon atoms optionally substituted with a halogen atom, still more preferably a branched alkyl group having 3 to 20 carbon atoms, and particularly preferably a tert-butyl group.

R² and R⁴ are preferably hydrogen atoms.

R³ is preferably an alkyl group having 1 to 20 carbon atoms optionally substituted with a halogen atom, more preferably an alkyl group having 1 to 4 carbon atoms, and still more preferably a methyl group.

R⁵ and R⁶ each independently is preferably an alkyl group having 1 to 20 carbon atoms optionally substituted with a halogen atom, an aralkyl group having 7 to 20 carbon atoms optionally substituted with a halogen atom or an aryl group having 6 to 20 carbon atoms optionally substituted with a halogen atom, more preferably an alkyl group having 1 to 20 carbon atoms optionally substituted with a halogen atom, still more preferably an alkyl group having 1 to 5 carbon atoms, and particularly preferably an ethyl group.

R⁵ and R⁶ are preferably the same groups.

In the substituents R⁷, R⁸, R⁹, R¹⁰ and R¹¹, examples of the alkyl group having 1 to 20 carbon atoms optionally substituted with a halogen atom include the following alkyl group having 1 to 20 carbon atoms and the following alkyl group having 1 to 20 carbon atoms substituted with a halogen atom. The alkyl group having 1 to 20 carbon atoms includes, for example, a methyl group, an ethyl group, a n-propyl group, an isopropyl group, a n-butyl group, a sec-butyl group, a tert-butyl group, a n-pentyl group, a neopentyl group, an amyl group, a n-hexyl group, a n-octyl group, a n-decyl group, a n-dodecyl group, a n-pentadecyl group and a n-eicosyl group, preferably an alkyl group having 1 to 5 carbon atoms such as a methyl group and a n-butyl group, and more preferably a n-butyl group.

Examples of the following alkyl group having 1 to 20 carbon atoms substituted with a halogen atom include groups in which any one of these alkyl groups is substituted with a halogen atom such as a fluorine atom, a chlorine atom, a bromine atom and an iodine atom.

The alkyl group having 1 to 20 carbon atoms substituted with a halogen atom includes, for example, a fluoromethyl group, a difluoromethyl group, a trifluoromethyl group, a chloromethyl group, a dichloromethyl group, a trichloromethyl group, a bromomethyl group, a dibromomethyl group, a tribromomethyl group, an iodomethyl group, a diiodomethyl group, a triiodomethyl group, a fluoroethyl group, a difluoroethyl group, a trifluoroethyl group, a tetrafluoroethyl group, a pentafluoroethyl group, a chloroethyl group, a dichloroethyl group, a trichloroethyl group, a tetrachloroethyl group, a pentachloroethyl group, a bromoethyl group, a dibromoethyl group, a tribromoethyl group, a tetrabromoethyl group, a pentabromoethyl group, a perfluoropropyl group, a perfluorobutyl group, a perfluoropentyl group, a perfluorohexyl group, a perfluorooctyl group, a perfluorododecyl group, a perfluoropentadecyl group, a perfluoroeicosyl group, a perchloropropyl group, a perchlorobutyl group, a perchloropentyl group, a perchlorohexyl group, a perchlorooctyl group, a perchlorododecyl group, a perchloropentadecyl group, a perchloroeicosyl group, a perbromopropyl group, a perbromobutyl group, a perbromopentyl group, a perbromohexyl group, a perbromooctyl group, a perbromododecyl group, a perbromopentadecyl group and a perbromoeicosyl group.

In the transition metal complex (1), R⁷ and R¹¹ are preferably hydrogen atoms. At least one of R⁸, R⁹ and R¹⁰ is preferably an alkyl group having 1 to 20 carbon atoms, and R⁷, R⁸, R¹⁰ and R¹¹ are more preferably hydrogen atoms. Further preferably, R⁷, R⁸, R¹⁰ and R¹¹ are hydrogen atoms and R⁹ is an alkyl group having 1 to 20 carbon atoms. R⁹ is preferably an alkyl group having 1 to 20 carbon atoms, more preferably an alkyl group having 1 to 5 carbon atoms optionally substituted with a halogen atom, still more preferably an alkyl group having 1 to 5 carbon atoms, and particularly preferably a n-butyl group.

In the transition metal complex (1), particularly preferably R⁷, R⁸, R¹⁰ and R¹¹ are hydrogen atoms and also R⁹ is an alkyl group having 1 to 5 carbon atoms optionally substituted with a halogen atom, and most preferably R⁷, R⁸, R¹⁰ and R¹¹ are hydrogen atoms and also R⁹ is a n-butyl group.

In the formula (1), when A, A¹, X¹, X², R¹, R², R³, R⁴, R⁵, R⁶, R⁷, R⁸, R⁹, R¹⁰ and/or R¹¹ are preferable groups described above, it is useful for producing a poly-1-butene polymer, particularly a high molecular weight poly-1-butene polymer.

The multidentate nature η in the linkage between M and a fluorenyl group in the transition metal complex (1) is not particularly limited and may be any value which can be taken by the fluorenyl group. The multidentate nature includes, for example, pentadentate, tetradentate, tridentate, bidentate and monodentate, preferably pentadentate, tridentate or monodentate, and more preferably pentadentate or tridentate.

As the transition metal complex (1), the followings can be specifically mentioned.

<Specific Examples of Transition Metal Complex (1) in which A¹ is Carbon Atom>

Methylene[2,7-di(2-methylphenyl)fluoren-9-yl](3,5-dimethyl-2-phenoxy)titaniumdichloride, methylene[2,7-di(2-methylphenyl)fluoren-9-yl](3-tert-butyl-2-phenoxy)titaniumdichloride, methylene[2,7-di(2-methylphenyl)fluoren-9-yl](3-tert-butyl-5-methyl-2-phenoxy)titaniumdichloride, methylene[2,7-di(2-methylphenyl)fluoren-9-yl](3-phenyl-2-phenoxy)titaniumdichloride, methylene[2,7-di(2-methylphenyl)fluoren-9-yl](3-tert-butyldimethylsilyl-5-methyl-2-phenoxy)titaniumdichloride, methylene[2,7-di(2-methylphenyl)fluoren-9-yl](3-trimethylsilyl-5-methyl-2-phenoxy)titaniumdichloride, methylene[2,7-di(2-methylphenyl)fluoren-9-yl](3-tert-butyl-5-methoxy-2-phenoxy)titaniumdichloride and methylene[2,7-di(2-methylphenyl)fluoren-9-yl](3-tert-butyl-5-chloro-2-phenoxy)titaniumdichloride.

Methylene[2,7-di(3-methylphenyl)fluoren-9-yl](3,5-dimethyl-2-phenoxy)titaniumdichloride, methylene[2,7-di(3-methylphenyl)fluoren-9-yl](3-tert-butyl-2-phenoxy) titaniumdichloride, methylene[2,7-di(3-methylphenyl)fluoren-9-yl](3-tert-butyl-5-methyl-2-phenoxy) titaniumdichloride, methylene[2,7-di(3-methylphenyl)fluoren-9-yl](3-phenyl-2-phenoxy) titaniumdichloride, methylene[2,7-di(3-methylphenyl)fluoren-9-yl](3-tert-butyldimethylsilyl-5-methyl-2-phenoxy)titaniumdichloride, methylene[2,7-di(3-methylphenyl)fluoren-9-yl](3-trimethylsilyl-5-methyl-2-phenoxy)titaniumdichloride, methylene[2,7-di(3-methylphenyl)fluoren-9-yl](3-tert-butyl-5-methoxy-2-phenoxy)titaniumdichloride and methylene[2,7-di(3-methylphenyl)fluoren-9-yl](3-tert-butyl-5-chloro-2-phenoxy) titaniumdichloride.

Methylene[2,7-di(4-methylphenyl)fluoren-9-yl](3,5-dimethyl-2-phenoxy)titaniumdichloride, methylene[2,7-di(4-methylphenyl)fluoren-9-yl](3-tert-butyl-2-phenoxy) titaniumdichloride, methylene[2,7-di(4-methylphenyl)fluoren-9-yl](3-tert-butyl-5-methyl-2-phenoxy) titaniumdichloride, methylene[2,7-di(4-methylphenyl)fluoren-9-yl](3-phenyl-2-phenoxy) titaniumdichloride, methylene[2,7-di(4-methylphenyl)fluoren-9-yl](3-tert-butyldimethylsilyl-5-methyl-2-phenoxy)titaniumdichloride, methylene[2,7-di(4-methylphenyl)fluoren-9-yl](3-trimethylsilyl-5-methyl-2-phenoxy)titaniumdichloride, methylene[2,7-di(4-methylphenyl)fluoren-9-yl](3-tert-butyl-5-methoxy-2-phenoxy)titaniumdichloride and methylene[2,7-di(4-methylphenyl)fluoren-9-yl](3-tert-butyl-5-chloro-2-phenoxy) titaniumdichloride.

Methylene[2,7-di(2-ethylphenyl)fluoren-9-yl](3,5-dimethyl-2-phenoxy)titaniumdichloride, methylene[2,7-di(2-ethylphenyl)fluoren-9-yl](3-tert-butyl-2-phenoxy) titaniumdichloride, methylene[2,7-di(2-ethylphenyl)fluoren-9-yl](3-tert-butyl-5-methyl-2-phenoxy)titaniumdichloride, methylene[2,7-di(2-ethylphenyl)fluoren-9-yl](3-phenyl-2-phenoxy)titaniumdichloride, methylene[2,7-di(2-ethylphenyl)fluoren-9-yl](3-tert-butyldimethylsilyl-5-methyl-2-phenoxy)titaniumdichloride, methylene[2,7-di(2-ethylphenyl)fluoren-9-yl](3-trimethylsilyl-5-methyl-2-phenoxy)titaniumdichloride, methylene[2,7-di(2-ethylphenyl)fluoren-9-yl](3-tert-butyl-5-methoxy-2-phenoxy) titaniumdichloride and methylene[2,7-di(2-ethylphenyl)fluoren-9-yl](3-tert-butyl-5-chloro-2-phenoxy) titaniumdichloride.

Methylene[2,7-di(3-ethylphenyl)fluoren-9-yl](3,5-dimethyl-2-phenoxy)titaniumdichloride, methylene[2,7-di(3-ethylphenyl)fluoren-9-yl](3-tert-butyl-2-phenoxy) titaniumdichloride, methylene[2,7-di(3-ethylphenyl)fluoren-9-yl](3-tert-butyl-5-methyl-2-phenoxy)titaniumdichloride, methylene[2,7-di(3-ethylphenyl)fluoren-9-yl](3-phenyl-2-phenoxy)titaniumdichloride, methylene[2,7-di(3-ethylphenyl)fluoren-9-yl](3-tert-butyldimethylsilyl-5-methyl-2-phenoxy)titaniumdichloride, methylene[2,7-di(3-ethylphenyl)fluoren-9-yl](3-trimethylsilyl-5-methyl-2-phenoxy)titaniumdichloride, methylene[2,7-di(3-ethylphenyl)fluoren-9-yl](3-tert-butyl-5-methoxy-2-phenoxy) titaniumdichloride and methylene[2,7-di(3-ethylphenyl)fluoren-9-yl](3-tert-butyl-5-chloro-2-phenoxy) titaniumdichloride.

Methylene[2,7-di(4-ethylphenyl)fluoren-9-yl](3,5-dimethyl-2-phenoxy)titaniumdichloride, methylene[2,7-di(4-ethylphenyl)fluoren-9-yl](3-tert-butyl-2-phenoxy) titaniumdichloride, methylene[2,7-di(4-ethylphenyl)fluoren-9-yl](3-tert-butyl-5-methyl-2-phenoxy)titaniumdichloride, methylene[2,7-di(4-ethylphenyl)fluoren-9-yl](3-phenyl-2-phenoxy)titaniumdichloride, methylene[2,7-di(4-ethylphenyl)fluoren-9-yl](3-tert-butyldimethylsilyl-5-methyl-2-phenoxy)titaniumdichloride, methylene[2,7-di(4-ethylphenyl)fluoren-9-yl](3-trimethylsilyl-5-methyl-2-phenoxy)titaniumdichloride, methylene[2,7-di(4-ethylphenyl)fluoren-9-yl](3-tert-butyl-5-methoxy-2-phenoxy) titaniumdichloride and methylene[2,7-di(4-ethylphenyl)fluoren-9-yl](3-tert-butyl-5-chloro-2-phenoxy) titaniumdichloride.

Methylene[2,7-di(2-n-butylphenyl)fluoren-9-yl](3,5-dimethyl-2-phenoxy)titaniumdichloride, methylene[2,7-di(2-n-butylphenyl)fluoren-9-yl](3-tert-butyl-2-phenoxy) titaniumdichloride, methylene[2,7-di(2-n-butylphenyl)fluoren-9-yl](3-tert-butyl-5-methyl-2-phenoxy) titaniumdichloride, methylene[2,7-di(2-n-butylphenyl)fluoren-9-yl](3-phenyl-2-phenoxy) titaniumdichloride, methylene[2,7-di(2-n-butylphenyl)fluoren-9-yl](3-tert-butyldimethylsilyl-5-methyl-2-phenoxy)titaniumdichloride, methylene[2,7-di(2-n-butylphenyl)fluoren-9-yl](3-trimethylsilyl-5-methyl-2-phenoxy)titaniumdichloride, methylene[2,7-di(2-n-butylphenyl)fluoren-9-yl](3-tert-butyl-5-methoxy-2-phenoxy) titaniumdichloride and methylene[2,7-di(2-n-butylphenyl)fluoren-9-yl](3-tert-butyl-5-chloro-2-phenoxy) titaniumdichloride.

Methylene[2,7-di(3-n-butylphenyl)fluoren-9-yl](3,5-dimethyl-2-phenoxy)titaniumdichloride, methylene[2,7-di(3-n-butylphenyl)fluoren-9-yl](3-tert-butyl-2-phenoxy) titaniumdichloride, methylene[2,7-di(3-n-butylphenyl)fluoren-9-yl](3-tert-butyl-5-methyl-2-phenoxy) titaniumdichloride, methylene[2,7-di(3-n-butylphenyl)fluoren-9-yl](3-phenyl-2-phenoxy) titaniumdichloride, methylene[2,7-di(3-n-butylphenyl)fluoren-9-yl](3-tert-butyldimethylsilyl-5-methyl-2-phenoxy)titaniumdichloride, methylene[2,7-di(3-n-butylphenyl)fluoren-9-yl](3-trimethylsilyl-5-methyl-2-phenoxy)titaniumdichloride, methylene[2,7-di(3-n-butylphenyl)fluoren-9-yl](3-tert-butyl-5-methoxy-2-phenoxy) titaniumdichloride and methylene[2,7-di(3-n-butylphenyl)fluoren-9-yl](3-tert-butyl-5-chloro-2-phenoxy) titaniumdichloride.

Methylene[2,7-di(4-n-butylphenyl)fluoren-9-yl](3,5-dimethyl-2-phenoxy)titaniumdichloride, methylene[2,7-di(4-n-butylphenyl)fluoren-9-yl](3-tert-butyl-2-phenoxy) titaniumdichloride, methylene[2,7-di(4-n-butylphenyl)fluoren-9-yl](3-tert-butyl-5-methyl-2-phenoxy) titaniumdichloride, methylene[2,7-di(4-n-butylphenyl)fluoren-9-yl](3-phenyl-2-phenoxy) titaniumdichloride, methylene[2,7-di(4-n-butylphenyl)fluoren-9-yl](3-tert-butyldimethylsilyl-5-methyl-2-phenoxy)titaniumdichloride, methylene[2,7-di(4-n-butylphenyl)fluoren-9-yl](3-trimethylsilyl-5-methyl-2-phenoxy)titaniumdichloride, methylene[2,7-di(4-n-butylphenyl)fluoren-9-yl](3-tert-butyl-5-methoxy-2-phenoxy) titaniumdichloride and methylene[2,7-di(4-n-butylphenyl)fluoren-9-yl](3-tert-butyl-5-chloro-2-phenoxy) titaniumdichloride.

Methylene[2,7-di(2-sec-butylphenyl)fluoren-9-yl](3,5-dimethyl-2-phenoxy)titaniumdichloride, methylene[2,7-di(2-sec-butylphenyl)fluoren-9-yl](3-tert-butyl-2-phenoxy)titaniumdichloride, methylene[2,7-di(2-sec-butylphenyl)fluoren-9-yl](3-tert-butyl-5-methyl-2-phenoxy)titaniumdichloride, methylene[2,7-di(2-sec-butylphenyl)fluoren-9-yl](3-phenyl-2-phenoxy) titaniumdichloride, methylene[2,7-di(2-sec-butylphenyl)fluoren-9-yl](3-tert-butyldimethylsilyl-5-methyl-2-phenoxy)titaniumdichloride, methylene[2,7-di(2-sec-butylphenyl)fluoren-9-yl](3-trimethylsilyl-5-methyl-2-phenoxy)titaniumdichloride, methylene[2,7-di(2-sec-butylphenyl)fluoren-9-yl](3-tert-butyl-5-methoxy-2-phenoxy) titaniumdichloride and methylene[2,7-di(2-sec-butylphenyl)fluoren-9-yl](3-tert-butyl-5-chloro-2-phenoxy) titaniumdichloride.

Methylene[2,7-di(3-sec-butylphenyl)fluoren-9-yl](3,5-dimethyl-2-phenoxy)titaniumdichloride, methylene[2,7-di(3-sec-butylphenyl)fluoren-9-yl](3-tert-butyl-2-phenoxy)titaniumdichloride, methylene[2,7-di(3-sec-butylphenyl)fluoren-9-yl](3-tert-butyl-5-methyl-2-phenoxy)titaniumdichloride, methylene[2,7-di(3-sec-butylphenyl)fluoren-9-yl](3-phenyl-2-phenoxy) titaniumdichloride, methylene[2,7-di(3-sec-butylphenyl)fluoren-9-yl](3-tert-butyldimethylsilyl-5-methyl-2-phenoxy)titaniumdichloride, methylene[2,7-di(3-sec-butylphenyl)fluoren-9-yl](3-trimethylsilyl-5-methyl-2-phenoxy)titaniumdichloride, methylene[2,7-di(3-sec-butylphenyl)fluoren-9-yl](3-tert-butyl-5-methoxy-2-phenoxy) titaniumdichloride and methylene[2,7-di(3-sec-butylphenyl)fluoren-9-yl](3-tert-butyl-5-chloro-2-phenoxy) titaniumdichloride.

Methylene[2,7-di(4-sec-butylphenyl)fluoren-9-yl](3,5-dimethyl-2-phenoxy)titaniumdichloride, methylene[2,7-di(4-sec-butylphenyl)fluoren-9-yl](3-tert-butyl-2-phenoxy)titaniumdichloride, methylene[2,7-di(4-sec-butylphenyl)fluoren-9-yl](3-tert-butyl-5-methyl-2-phenoxy)titaniumdichloride, methylene[2,7-di(4-sec-butylphenyl)fluoren-9-yl](3-phenyl-2-phenoxy) titaniumdichloride, methylene[2,7-di(4-sec-butylphenyl)fluoren-9-yl](3-tert-butyldimethylsilyl-5-methyl-2-phenoxy)titaniumdichloride, methylene[2,7-di(4-sec-butylphenyl)fluoren-9-yl](3-trimethylsilyl-5-methyl-2-phenoxy)titaniumdichloride, methylene[2,7-di(4-sec-butylphenyl)fluoren-9-yl](3-tert-butyl-5-methoxy-2-phenoxy) titaniumdichloride and methylene[2,7-di(4-sec-butylphenyl)fluoren-9-yl](3-tert-butyl-5-chloro-2-phenoxy) titaniumdichloride.

Methylene[2,7-di(2-t-butylphenyl)fluoren-9-yl](3,5-dimethyl-2-phenoxy)titaniumdichloride, methylene[2,7-di(2-t-butylphenyl)fluoren-9-yl](3-tert-butyl-2-phenoxy) titaniumdichloride, methylene[2,7-di(2-t-butylphenyl)fluoren-9-yl](3-tert-butyl-5-methyl-2-phenoxy) titaniumdichloride, methylene[2,7-di(2-t-butylphenyl)fluoren-9-yl](3-phenyl-2-phenoxy) titaniumdichloride, methylene[2,7-di(2-t-butylphenyl)fluoren-9-yl](3-tert-butyldimethylsilyl-5-methyl-2-phenoxy)titaniumdichloride, methylene[2,7-di(2-t-butylphenyl)fluoren-9-yl](3-trimethylsilyl-5-methyl-2-phenoxy)titaniumdichloride, methylene[2,7-di(2-t-butylphenyl)fluoren-9-yl](3-tert-butyl-5-methoxy-2-phenoxy) titaniumdichloride and methylene[2,7-di(2-t-butylphenyl)fluoren-9-yl](3-tert-butyl-5-chloro-2-phenoxy) titaniumdichloride.

Methylene[2,7-di(3-t-butylphenyl)fluoren-9-yl](3,5-dimethyl-2-phenoxy)titaniumdichloride, methylene[2,7-di(3-t-butylphenyl)fluoren-9-yl](3-tert-butyl-2-phenoxy) titaniumdichloride, methylene[2,7-di(3-t-butylphenyl)fluoren-9-yl](3-tert-butyl-5-methyl-2-phenoxy) titaniumdichloride, methylene[2,7-di(3-t-butylphenyl)fluoren-9-yl](3-phenyl-2-phenoxy) titaniumdichloride, methylene[2,7-di(3-t-butylphenyl)fluoren-9-yl](3-tert-butyldimethylsilyl-5-methyl-2-phenoxy)titaniumdichloride, methylene[2,7-di(3-t-butylphenyl)fluoren-9-yl](3-trimethylsilyl-5-methyl-2-phenoxy)titaniumdichloride, methylene[2,7-di(3-t-butylphenyl)fluoren-9-yl](3-tert-butyl-5-methoxy-2-phenoxy) titaniumdichloride and methylene[2,7-di(3-t-butylphenyl)fluoren-9-yl](3-tert-butyl-5-chloro-2-phenoxy) titaniumdichloride.

Methylene[2,7-di(4-t-butylphenyl)fluoren-9-yl](3,5-dimethyl-2-phenoxy)titaniumdichloride, methylene[2,7-di(4-t-butylphenyl)fluoren-9-yl](3-tert-butyl-2-phenoxy) titaniumdichloride, methylene[2,7-di(4-t-butylphenyl)fluoren-9-yl](3-tert-butyl-5-methyl-2-phenoxy) titaniumdichloride, methylene[2,7-di-t-n-butylphenyl]fluoren-9-yl](3-phenyl-2-phenoxy) titaniumdichloride, methylene[2,7-di(4-t-butylphenyl)fluoren-9-yl](3-tert-butyldimethylsilyl-5-methyl-2-phenoxy)titaniumdichloride, methylene[2,7-di(4-t-butylphenyl)fluoren-9-yl](3-trimethylsilyl-5-methyl-2-phenoxy)titaniumdichloride, methylene[2,7-di(4-t-butylphenyl)fluoren-9-yl](3-tert-butyl-5-methoxy-2-phenoxy) titaniumdichloride and methylene[2,7-di(4-t-butylphenyl)fluoren-9-yl](3-tert-butyl-5-chloro-2-phenoxy) titaniumdichloride.

Isopropylidene[2,7-di(2-methylphenyl)fluoren-9-yl](3,5-dimethyl-2-phenoxy)titaniumdichloride, isopropylidene[2,7-di(2-methylphenyl)fluoren-9-yl](3-tert-butyl-2-phenoxy)titaniumdichloride, isopropylidene[2,7-di(2-methylphenyl)fluoren-9-yl](3-tert-butyl-5-methyl-2-phenoxy)titaniumdichloride, isopropylidene[2,7-di(2-methylphenyl)fluoren-9-yl](3-phenyl-2-phenoxy) titaniumdichloride, isopropylidene[2,7-di(2-methylphenyl)fluoren-9-yl](3-tert-butyldimethylsilyl-5-methyl-2-phenoxy)titaniumdichloride, isopropylidene[2,7-di(2-methylphenyl)fluoren-9-yl](3-trimethylsilyl-5-methyl-2-phenoxy)titaniumdichloride, isopropylidene[2,7-di(2-methylphenyl)fluoren-9-yl](3-tert-butyl-5-methoxy-2-phenoxy)titaniumdichloride and isopropylidene[2,7-di(2-methylphenyl)fluoren-9-yl](3-tert-butyl-5-chloro-2-phenoxy) titaniumdichloride.

Isopropylidene[2,7-di(3-methylphenyl)fluoren-9-yl](3,5-dimethyl-2-phenoxy)titaniumdichloride, isopropylidene[2,7-di(3-methylphenyl)fluoren-9-yl](3-tert-butyl-2-phenoxy)titaniumdichloride, isopropylidene[2,7-di(3-methylphenyl)fluoren-9-yl](3-tert-butyl-5-methyl-2-phenoxy)titaniumdichloride, isopropylidene[2,7-di(3-methylphenyl)fluoren-9-yl](3-phenyl-2-phenoxy) titaniumdichloride, isopropylidene[2,7-di(3-methylphenyl)fluoren-9-yl](3-tert-butyldimethylsilyl-5-methyl-2-phenoxy)titaniumdichloride, isopropylidene[2,7-di(3-methylphenyl)fluoren-9-yl](3-trimethylsilyl-5-methyl-2-phenoxy)titaniumdichloride, isopropylidene[2,7-di(3-methylphenyl)fluoren-9-yl](3-tert-butyl-5-methoxy-2-phenoxy)titaniumdichloride and isopropylidene[2,7-di(3-methylphenyl)fluoren-9-yl](3-tert-butyl-5-chloro-2-phenoxy) titaniumdichloride.

Isopropylidene[2,7-di(4-methylphenyl)fluoren-9-yl](3,5-dimethyl-2-phenoxy)titaniumdichloride, isopropylidene[2,7-di(4-methylphenyl)fluoren-9-yl](3-tert-butyl-2-phenoxy)titaniumdichloride, isopropylidene[2,7-di(4-methylphenyl)fluoren-9-yl](3-tert-butyl-5-methyl-2-phenoxy)titaniumdichloride, isopropylidene[2,7-di(4-methylphenyl)fluoren-9-yl](3-phenyl-2-phenoxy) titaniumdichloride, isopropylidene[2,7-di(4-methylphenyl)fluoren-9-yl](3-tert-butyldimethylsilyl-5-methyl-2-phenoxy)titaniumdichloride, isopropylidene[2,7-di(4-methylphenyl)fluoren-9-yl](3-trimethylsilyl-5-methyl-2-phenoxy)titaniumdichloride and isopropylidene[2,7-di(4-methylphenyl)fluoren-9-yl](3-tert-butyl-5-methoxy-2-phenoxy)titaniumdichloride and isopropylidene[2,7-di(4-methylphenyl)fluoren-9-yl](3-tert-butyl-5-chloro-2-phenoxy) titaniumdichloride.

Isopropylidene[2,7-di(2-ethylphenyl)fluoren-9-yl](3,5-dimethyl-2-phenoxy)titaniumdichloride, isopropylidene[2,7-di(2-ethylphenyl)fluoren-9-yl](3-tert-butyl-2-phenoxy)titaniumdichloride, isopropylidene[2,7-di(2-ethylphenyl)fluoren-9-yl](3-tert-butyl-5-methyl-2-phenoxy)titaniumdichloride, isopropylidene[2,7-di(2-ethylphenyl)fluoren-9-yl](3-phenyl-2-phenoxy) titaniumdichloride, isopropylidene[2,7-di(2-ethylphenyl)fluoren-9-yl](3-tert-butyldimethylsilyl-5-methyl-2-phenoxy)titaniumdichloride, isopropylidene[2,7-di(2-ethylphenyl)fluoren-9-yl](3-trimethylsilyl-5-methyl-2-phenoxy)titaniumdichloride, isopropylidene[2,7-di(2-ethylphenyl)fluoren-9-yl](3-tert-butyl-5-methoxy-2-phenoxy) titaniumdichloride and isopropylidene[2,7-di(2-ethylphenyl)fluoren-9-yl](3-tert-butyl-5-chloro-2-phenoxy) titaniumdichloride.

Isopropylidene[2,7-di(3-ethylphenyl)fluoren-9-yl](3,5-dimethyl-2-phenoxy)titaniumdichloride, isopropylidene[2,7-di(3-ethylphenyl)fluoren-9-yl](3-tert-butyl-2-phenoxy)titaniumdichloride, isopropylidene[2,7-di(3-ethylphenyl)fluoren-9-yl](3-tert-butyl-5-methyl-2-phenoxy)titaniumdichloride, isopropylidene[2,7-di(3-ethylphenyl)fluoren-9-yl](3-phenyl-2-phenoxy) titaniumdichloride, isopropylidene[2,7-di(3-ethylphenyl)fluoren-9-yl](3-tert-butyldimethylsilyl-5-methyl-2-phenoxy)titaniumdichloride, isopropylidene[2,7-di(3-ethylphenyl)fluoren-9-yl](3-trimethylsilyl-5-methyl-2-phenoxy)titaniumdichloride, isopropylidene[2,7-di(3-ethylphenyl)fluoren-9-yl](3-tert-butyl-5-methoxy-2-phenoxy) titaniumdichloride and isopropylidene[2,7-di(3-ethylphenyl)fluoren-9-yl](3-tert-butyl-5-chloro-2-phenoxy) titaniumdichloride.

Isopropylidene[2,7-di(4-ethylphenyl)fluoren-9-yl](3,5-dimethyl-2-phenoxy)titaniumdichloride, isopropylidene[2,7-di(4-ethylphenyl)fluoren-9-yl](3-tert-butyl-2-phenoxy)titaniumdichloride, isopropylidene[2,7-di(4-ethylphenyl)fluoren-9-yl](3-tert-butyl-5-methyl-2-phenoxy)titaniumdichloride, isopropylidene[2,7-di(4-ethylphenyl)fluoren-9-yl](3-phenyl-2-phenoxy) titaniumdichloride, isopropylidene[2,7-di(4-ethylphenyl)fluoren-9-yl](3-tert-butyldimethylsilyl-5-methyl-2-phenoxy)titaniumdichloride, isopropylidene[2,7-di(4-ethylphenyl)fluoren-9-yl](3-trimethylsilyl-5-methyl-2-phenoxy)titaniumdichloride, isopropylidene[2,7-di(4-ethylphenyl)fluoren-9-yl](3-tert-butyl-5-methoxy-2-phenoxy) titaniumdichloride and isopropylidene[2,7-di(4-ethylphenyl)fluoren-9-yl](3-tert-butyl-5-chloro-2-phenoxy) titaniumdichloride.

Isopropylidene[2,7-di(2-n-butylphenyl)fluoren-9-yl](3,5-dimethyl-2-phenoxy)titaniumdichloride, isopropylidene[2,7-di(2-n-butylphenyl)fluoren-9-yl](3-tert-butyl-2-phenoxy)titaniumdichloride, isopropylidene[2,7-di(2-n-butylphenyl)fluoren-9-yl](3-tert-butyl-5-methyl-2-phenoxy)titaniumdichloride, isopropylidene[2,7-di(2-n-butylphenyl)fluoren-9-yl](3-phenyl-2-phenoxy) titaniumdichloride, isopropylidene[2,7-di(2-n-butylphenyl)fluoren-9-yl](3-tert-butyldimethylsilyl-5-methyl-2-phenoxy)titaniumdichloride, isopropylidene[2,7-di(2-n-butylphenyl)fluoren-9-yl](3-trimethylsilyl-5-methyl-2-phenoxy)titaniumdichloride, isopropylidene[2,7-di(2-n-butylphenyl)fluoren-9-yl](3-tert-butyl-5-methoxy-2-phenoxy) titaniumdichloride and isopropylidene[2,7-di(2-n-butylphenyl)fluoren-9-yl](3-tert-butyl-5-chloro-2-phenoxy) titaniumdichloride.

Isopropylidene[2,7-di(3-n-butylphenyl)fluoren-9-yl](3,5-dimethyl-2-phenoxy)titaniumdichloride, isopropylidene[2,7-di(3-n-butylphenyl)fluoren-9-yl](3-tert-butyl-2-phenoxy)titaniumdichloride, isopropylidene[2,7-di(3-n-butylphenyl)fluoren-9-yl](3-tert-butyl-5-methyl-2-phenoxy)titaniumdichloride, isopropylidene[2,7-di(3-n-butylphenyl)fluoren-9-yl](3-phenyl-2-phenoxy) titaniumdichloride, isopropylidene[2,7-di(3-n-butylphenyl)fluoren-9-yl](3-tert-butyldimethylsilyl-5-methyl-2-phenoxy)titaniumdichloride, isopropylidene[2,7-di(3-n-butylphenyl)fluoren-9-yl](3-trimethylsilyl-5-methyl-2-phenoxy)titaniumdichloride, isopropylidene[2,7-di(3-n-butylphenyl)fluoren-9-yl](3-tert-butyl-5-methoxy-2-phenoxy) titaniumdichloride and isopropylidene[2,7-di(3-n-butylphenyl)fluoren-9-yl](3-tert-butyl-5-chloro-2-phenoxy) titaniumdichloride.

Isopropylidene[2,7-di(4-n-butylphenyl)fluoren-9-yl](3,5-dimethyl-2-phenoxy)titaniumdichloride, isopropylidene[2,7-di(4-n-butylphenyl)fluoren-9-yl](3-tert-butyl-2-phenoxy)titaniumdichloride, isopropylidene[2,7-di(4-n-butylphenyl)fluoren-9-yl](3-tert-butyl-5-methyl-2-phenoxy)titaniumdichloride, isopropylidene[2,7-di(4-n-butylphenyl)fluoren-9-yl](3-phenyl-2-phenoxy) titaniumdichloride, isopropylidene[2,7-di(4-n-butylphenyl)fluoren-9-yl](3-tert-butyldimethylsilyl-5-methyl-2-phenoxy)titaniumdichloride, isopropylidene[2,7-di(4-n-butylphenyl)fluoren-9-yl](3-trimethylsilyl-5-methyl-2-phenoxy)titaniumdichloride, isopropylidene[2,7-di(4-n-butylphenyl)fluoren-9-yl](3-tert-butyl-5-methoxy-2-phenoxy) titaniumdichloride and isopropylidene[2,7-di(4-n-butylphenyl)fluoren-9-yl](3-tert-butyl-5-chloro-2-phenoxy) titaniumdichloride.

Isopropylidene[2,7-di(2-sec-butylphenyl)fluoren-9-yl](3,5-dimethyl-2-phenoxy)titaniumdichloride, isopropylidene[2,7-di(2-sec-butylphenyl)fluoren-9-yl](3-tert-butyl-2-phenoxy)titaniumdichloride, isopropylidene[2,7-di(2-sec-butylphenyl)fluoren-9-yl](3-tert-butyl-5-methyl-2-phenoxy)titaniumdichloride, isopropylidene[2,7-di(2-sec-butylphenyl)fluoren-9-yl](3-phenyl-2-phenoxy)titaniumdichloride, isopropylidene[2,7-di(2-sec-butylphenyl)fluoren-9-yl](3-tert-butyldimethylsilyl-5-methyl-2-phenoxy)titaniumdichloride, isopropylidene[2,7-di(2-sec-butylphenyl)fluoren-9-yl](3-trimethylsilyl-5-methyl-2-phenoxy)titaniumdichloride, isopropylidene[2,7-di(2-sec-butylphenyl)fluoren-9-yl](3-tert-butyl-5-methoxy-2-phenoxy)titaniumdichloride and isopropylidene[2,7-di(2-sec-butylphenyl)fluoren-9-yl](3-tert-butyl-5-chloro-2-phenoxy)titaniumdichloride.

Isopropylidene[2,7-di(3-sec-butylphenyl)fluoren-9-yl](3,5-dimethyl-2-phenoxy)titaniumdichloride, isopropylidene[2,7-di(3-sec-butylphenyl)fluoren-9-yl](3-tert-butyl-2-phenoxy)titaniumdichloride, isopropylidene[2,7-di(3-sec-butylphenyl)fluoren-9-yl](3-tert-butyl-5-methyl-2-phenoxy)titaniumdichloride, isopropylidene[2,7-di(3-sec-butylphenyl)fluoren-9-yl](3-phenyl-2-phenoxy)titaniumdichloride, isopropylidene[2,7-di(3-sec-butylphenyl)fluoren-9-yl](3-tert-butyldimethylsilyl-5-methyl-2-phenoxy)titaniumdichloride, isopropylidene[2,7-di(3-sec-butylphenyl)fluoren-9-yl](3-trimethylsilyl-5-methyl-2-phenoxy)titaniumdichloride, isopropylidene[2,7-di(3-sec-butylphenyl)fluoren-9-yl](3-tert-butyl-5-methoxy-2-phenoxy)titaniumdichloride and isopropylidene[2,7-di(3-sec-butylphenyl)fluoren-9-yl](3-tert-butyl-5-chloro-2-phenoxy)titaniumdichloride.

Isopropylidene[2,7-di(4-sec-butylphenyl)fluoren-9-yl](3,5-dimethyl-2-phenoxy)titaniumdichloride, isopropylidene[2,7-di(4-sec-butylphenyl)fluoren-9-yl](3-tert-butyl-2-phenoxy)titaniumdichloride, isopropylidene[2,7-di(4-sec-butylphenyl)fluoren-9-yl](3-tert-butyl-5-methyl-2-phenoxy)titaniumdichloride, isopropylidene[2,7-di(4-sec-butylphenyl)fluoren-9-yl](3-phenyl-2-phenoxy)titaniumdichloride, isopropylidene[2,7-di(4-sec-butylphenyl)fluoren-9-yl](3-tert-butyldimethylsilyl-5-methyl-2-phenoxy)titaniumdichloride, isopropylidene[2,7-di(4-sec-butylphenyl)fluoren-9-yl](3-trimethylsilyl-5-methyl-2-phenoxy)titaniumdichloride, isopropylidene[2,7-di(4-sec-butylphenyl)fluoren-9-yl](3-tert-butyl-5-methoxy-2-phenoxy)titaniumdichloride and isopropylidene[2,7-di(4-sec-butylphenyl)fluoren-9-yl](3-tert-butyl-5-chloro-2-phenoxy)titaniumdichloride.

Isopropylidene[2,7-di(2-t-butylphenyl)fluoren-9-yl](3,5-dimethyl-2-phenoxy)titaniumdichloride, isopropylidene[2,7-di(2-t-butylphenyl)fluoren-9-yl](3-tert-butyl-2-phenoxy)titaniumdichloride, isopropylidene[2,7-di(2-t-butylphenyl)fluoren-9-yl](3-tert-butyl-5-methyl-2-phenoxy)titaniumdichloride, isopropylidene[2,7-di(2-t-butylphenyl)fluoren-9-yl](3-phenyl-2-phenoxy) titaniumdichloride, isopropylidene[2,7-di(2-t-butylphenyl)fluoren-9-yl](3-tert-butyldimethylsilyl-5-methyl-2-phenoxy)titaniumdichloride, isopropylidene[2,7-di(2-t-butylphenyl)fluoren-9-yl](3-trimethylsilyl-5-methyl-2-phenoxy)titaniumdichloride, isopropylidene[2,7-di(2-t-butylphenyl)fluoren-9-yl](3-tert-butyl-5-methoxy-2-phenoxy) titaniumdichloride and isopropylidene[2,7-di(2-t-butylphenyl)fluoren-9-yl](3-tert-butyl-5-chloro-2-phenoxy) titaniumdichloride.

Isopropylidene[2,7-di(3-t-butylphenyl)fluoren-9-yl](3,5-dimethyl-2-phenoxy)titaniumdichloride, isopropylidene[2,7-di(3-t-butylphenyl)fluoren-9-yl](3-tert-butyl-2-phenoxy)titaniumdichloride, isopropylidene[2,7-di(3-t-butylphenyl)fluoren-9-yl](3-tert-butyl-5-methyl-2-phenoxy)titaniumdichloride, isopropylidene[2,7-di(3-t-butylphenyl)fluoren-9-yl](3-phenyl-2-phenoxy) titaniumdichloride, isopropylidene[2,7-di(3-t-butylphenyl)fluoren-9-yl](3-tert-butyldimethylsilyl-5-methyl-2-phenoxy)titaniumdichloride, isopropylidene[2,7-di(3-t-butylphenyl)fluoren-9-yl](3-trimethylsilyl-5-methyl-2-phenoxy)titaniumdichloride, isopropylidene[2,7-di(3-t-butylphenyl)fluoren-9-yl](3-tert-butyl-5-methoxy-2-phenoxy) titaniumdichloride and isopropylidene[2,7-di(3-t-butylphenyl)fluoren-9-yl](3-tert-butyl-5-chloro-2-phenoxy) titaniumdichloride.

Isopropylidene[2,7-di(4-t-butylphenyl)fluoren-9-yl](3,5-dimethyl-2-phenoxy)titaniumdichloride, isopropylidene[2,7-di(4-t-butylphenyl)fluoren-9-yl](3-tert-butyl-2-phenoxy)titaniumdichloride, isopropylidene[2,7-di(4-t-butylphenyl)fluoren-9-yl](3-tert-butyl-5-methyl-2-phenoxy)titaniumdichloride, isopropylidene[2,7-di(t-n-butylphenyl)]fluoren-9-yl](3-phenyl-2-phenoxy) titaniumdichloride, isopropylidene[2,7-di(4-t-butylphenyl)fluoren-9-yl](3-tert-butyldimethylsilyl-5-methyl-2-phenoxy)titaniumdichloride, isopropylidene[2,7-di(4-t-butylphenyl)fluoren-9-yl](3-trimethylsilyl-5-methyl-2-phenoxy)titaniumdichloride, isopropylidene[2,7-di(4-t-butylphenyl)fluoren-9-yl](3-tert-butyl-5-methoxy-2-phenoxy) titaniumdichloride and isopropylidene[2,7-di(4-t-butylphenyl)fluoren-9-yl](3-tert-butyl-5-chloro-2-phenoxy) titaniumdichloride.

Diphenylmethylene[2,7-di(2-methylphenyl)fluoren-9-yl](3,5-dimethyl-2-phenoxy)titaniumdichloride, diphenylmethylene[2,7-di(2-methylphenyl)fluoren-9-yl](3-tert-butyl-2-phenoxy)titaniumdichloride, diphenylmethylene[2,7-di(2-methylphenyl)fluoren-9-yl](3-tert-butyl-5-methyl-2-phenoxy)titaniumdichloride, diphenylmethylene[2,7-di(2-methylphenyl)fluoren-9-yl](3-phenyl-2-phenoxy)titaniumdichloride, diphenylmethylene[2,7-di(2-methylphenyl)fluoren-9-yl](3-tert-butyldimethylsilyl-5-methyl-2-phenoxy) titaniumdichloride, diphenylmethylene[2,7-di(2-methylphenyl)fluoren-9-yl](3-trimethylsilyl-5-methyl-2-phenoxy)titaniumdichloride, diphenylmethylene[2,7-di(2-methylphenyl)fluoren-9-yl](3-tert-butyl-5-methoxy-2-phenoxy)titaniumdichloride and diphenylmethylene[2,7-di(2-methylphenyl)fluoren-9-yl](3-tert-butyl-5-chloro-2-phenoxy) titaniumdichloride.

Diphenylmethylene[2,7-di(3-methylphenyl)fluoren-9-yl](3,5-dimethyl-2-phenoxy)titaniumdichloride, diphenylmethylene[2,7-di(3-methylphenyl)fluoren-9-yl](3-tert-butyl-2-phenoxy)titaniumdichloride, diphenylmethylene[2,7-di(3-methylphenyl)fluoren-9-yl](3-tert-butyl-5-methyl-2-phenoxy)titaniumdichloride, diphenylmethylene[2,7-di(3-methylphenyl)fluoren-9-yl](3-phenyl-2-phenoxy)titaniumdichloride, diphenylmethylene[2,7-di(3-methylphenyl)fluoren-9-yl](3-tert-butyldimethylsilyl-5-methyl-2-phenoxy) titaniumdichloride, diphenylmethylene[2,7-di(3-methylphenyl)fluoren-9-yl](3-trimethylsilyl-5-methyl-2-phenoxy)titaniumdichloride, diphenylmethylene[2,7-di(3-methylphenyl)fluoren-9-yl](3-tert-butyl-5-methoxy-2-phenoxy)titaniumdichloride and diphenylmethylene[2,7-di(3-methylphenyl)fluoren-9-yl](3-tert-butyl-5-chloro-2-phenoxy) titaniumdichloride.

Diphenylmethylene[2,7-di(4-methylphenyl)fluoren-9-yl](3,5-dimethyl-2-phenoxy)titaniumdichloride, diphenylmethylene[2,7-di(4-methylphenyl)fluoren-9-yl](3-tert-butyl-2-phenoxy)titaniumdichloride, diphenylmethylene[2,7-di(4-methylphenyl)fluoren-9-yl](3-tert-butyl-5-methyl-2-phenoxy)titaniumdichloride, diphenylmethylene[2,7-di(4-methylphenyl)fluoren-9-yl](3-phenyl-2-phenoxy)titaniumdichloride, diphenylmethylene[2,7-di(4-methylphenyl)fluoren-9-yl](3-tert-butyldimethylsilyl-5-methyl-2-phenoxy) titaniumdichloride, diphenylmethylene[2,7-di(4-methylphenyl)fluoren-9-yl](3-trimethylsilyl-5-methyl-2-phenoxy)titaniumdichloride, diphenylmethylene[2,7-di(4-methylphenyl)fluoren-9-yl](3-tert-butyl-5-methoxy-2-phenoxy)titaniumdichloride and diphenylmethylene[2,7-di(4-methylphenyl)fluoren-9-yl](3-tert-butyl-5-chloro-2-phenoxy) titaniumdichloride.

Diphenylmethylene[2,7-di(2-ethylphenyl)fluoren-9-yl](3,5-dimethyl-2-phenoxy)titaniumdichloride, diphenylmethylene[2,7-di(2-ethylphenyl)fluoren-9-yl](3-tert-butyl-2-phenoxy)titaniumdichloride, diphenylmethylene[2,7-di(2-ethylphenyl)fluoren-9-yl](3-tert-butyl-5-methyl-2-phenoxy)titaniumdichloride, diphenylmethylene[2,7-di(2-ethylphenyl)fluoren-9-yl](3-phenyl-2-phenoxy)titaniumdichloride, diphenylmethylene[2,7-di(2-ethylphenyl)fluoren-9-yl](3-tert-butyldimethylsilyl-5-methyl-2-phenoxy) titaniumdichloride, diphenylmethylene[2,7-di(2-ethylphenyl)fluoren-9-yl](3-trimethylsilyl-5-methyl-2-phenoxy)titaniumdichloride, diphenylmethylene[2,7-di(2-ethylphenyl)fluoren-9-yl](3-tert-butyl-5-methoxy-2-phenoxy) titaniumdichloride and diphenylmethylene[2,7-di(2-ethylphenyl)fluoren-9-yl](3-tert-butyl-5-chloro-2-phenoxy) titaniumdichloride.

Diphenylmethylene[2,7-di(3-ethylphenyl)fluoren-9-yl](3,5-dimethyl-2-phenoxy)titaniumdichloride, diphenylmethylene[2,7-di(3-ethylphenyl)fluoren-9-yl](3-tert-butyl-2-phenoxy)titaniumdichloride, diphenylmethylene[2,7-di(3-ethylphenyl)fluoren-9-yl](3-tert-butyl-5-methyl-2-phenoxy)titaniumdichloride, diphenylmethylene[2,7-di(3-ethylphenyl)fluoren-9-yl](3-phenyl-2-phenoxy)titaniumdichloride, diphenylmethylene[2,7-di(3-ethylphenyl)fluoren-9-yl](3-tert-butyldimethylsilyl-5-methyl-2-phenoxy) titaniumdichloride, diphenylmethylene[2,7-di(3-ethylphenyl)fluoren-9-yl](3-trimethylsilyl-5-methyl-2-phenoxy)titaniumdichloride, diphenylmethylene[2,7-di(3-ethylphenyl)fluoren-9-yl](3-tert-butyl-5-methoxy-2-phenoxy) titaniumdichloride and diphenylmethylene[2,7-di(3-ethylphenyl)fluoren-9-yl](3-tert-butyl-5-chloro-2-phenoxy) titaniumdichloride.

Diphenylmethylene[2,7-di(4-ethylphenyl)fluoren-9-yl](3,5-dimethyl-2-phenoxy)titaniumdichloride, diphenylmethylene[2,7-di(4-ethylphenyl)fluoren-9-yl](3-tert-butyl-2-phenoxy)titaniumdichloride, diphenylmethylene[2,7-di(4-ethylphenyl)fluoren-9-yl](3-tert-butyl-5-methyl-2-phenoxy)titaniumdichloride, diphenylmethylene[2,7-di(4-ethylphenyl)fluoren-9-yl](3-phenyl-2-phenoxy)titaniumdichloride, diphenylmethylene[2,7-di(4-ethylphenyl)fluoren-9-yl](3-tert-butyldimethylsilyl-5-methyl-2-phenoxy) titaniumdichloride, diphenylmethylene[2,7-di(4-ethylphenyl)fluoren-9-yl](3-trimethylsilyl-5-methyl-2-phenoxy)titaniumdichloride, diphenylmethylene[2,7-di(4-ethylphenyl)fluoren-9-yl](3-tert-butyl-5-methoxy-2-phenoxy) titaniumdichloride and diphenylmethylene[2,7-di(4-ethylphenyl)fluoren-9-yl](3-tert-butyl-5-chloro-2-phenoxy) titaniumdichloride.

Diphenylmethylene[2,7-di(2-n-butylphenyl)fluoren-9-yl](3,5-dimethyl-2-phenoxy)titaniumdichloride, diphenylmethylene[2,7-di(2-n-butylphenyl)fluoren-9-yl](3-tert-butyl-2-phenoxy)titaniumdichloride, diphenylmethylene[2,7-di(2-n-butylphenyl)fluoren-9-yl](3-tert-butyl-5-methyl-2-phenoxy)titaniumdichloride, diphenylmethylene[2,7-di(2-n-butylphenyl)fluoren-9-yl](3-phenyl-2-phenoxy)titaniumdichloride, diphenylmethylene[2,7-di(2-n-butylphenyl)fluoren-9-yl](3-tert-butyldimethylsilyl-5-methyl-2-phenoxy) titaniumdichloride, diphenylmethylene[2,7-di(2-n-butylphenyl)fluoren-9-yl](3-trimethylsilyl-5-methyl-2-phenoxy)titaniumdichloride, diphenylmethylene[2,7-di(2-n-butylphenyl)fluoren-9-yl](3-tert-butyl-5-methoxy-2-phenoxy) titaniumdichloride and diphenylmethylene[2,7-di(2-n-butylphenyl)fluoren-9-yl](3-tert-butyl-5-chloro-2-phenoxy) titaniumdichloride.

Diphenylmethylene[2,7-di(3-n-butylphenyl)fluoren-9-yl](3,5-dimethyl-2-phenoxy)titaniumdichloride, diphenylmethylene[2,7-di(3-n-butylphenyl)fluoren-9-yl](3-tert-butyl-2-phenoxy)titaniumdichloride, diphenylmethylene[2,7-di(3-n-butylphenyl)fluoren-9-yl](3-tert-butyl-5-methyl-2-phenoxy)titaniumdichloride, diphenylmethylene[2,7-di(3-n-butylphenyl)fluoren-9-yl](3-phenyl-2-phenoxy)titaniumdichloride, diphenylmethylene[2,7-di(3-n-butylphenyl)fluoren-9-yl](3-tert-butyldimethylsilyl-5-methyl-2-phenoxy) titaniumdichloride, diphenylmethylene[2,7-di(3-n-butylphenyl)fluoren-9-yl](3-trimethylsilyl-5-methyl-2-phenoxy)titaniumdichloride, diphenylmethylene[2,7-di(3-n-butylphenyl)fluoren-9-yl](3-tert-butyl-5-methoxy-2-phenoxy) titaniumdichloride and diphenylmethylene[2,7-di(3-n-butylphenyl)fluoren-9-yl](3-tert-butyl-5-chloro-2-phenoxy) titaniumdichloride.

Diphenylmethylene[2,7-di(4-n-butylphenyl)fluoren-9-yl](3,5-dimethyl-2-phenoxy)titaniumdichloride, diphenylmethylene[2,7-di(4-n-butylphenyl)fluoren-9-yl](3-tert-butyl-2-phenoxy)titaniumdichloride, diphenylmethylene[2,7-di(4-n-butylphenyl)fluoren-9-yl](3-tert-butyl-5-methyl-2-phenoxy)titaniumdichloride, diphenylmethylene[2,7-di(4-n-butylphenyl)fluoren-9-yl](3-phenyl-2-phenoxy)titaniumdichloride, diphenylmethylene[2,7-di(4-n-butylphenyl)fluoren-9-yl](3-tert-butyldimethylsilyl-5-methyl-2-phenoxy) titaniumdichloride, diphenylmethylene[2,7-di(4-n-butylphenyl)fluoren-9-yl](3-trimethylsilyl-5-methyl-2-phenoxy)titaniumdichloride, diphenylmethylene[2,7-di(4-n-butylphenyl)fluoren-9-yl](3-tert-butyl-5-methoxy-2-phenoxy) titaniumdichloride and diphenylmethylene[2,7-di(4-n-butylphenyl)fluoren-9-yl](3-tert-butyl-5-chloro-2-phenoxy) titaniumdichloride.

Diphenylmethylene[2,7-di(2-sec-butylphenyl)fluoren-9-yl](3,5-dimethyl-2-phenoxy)titaniumdichloride, diphenylmethylene[2,7-di(2-sec-butylphenyl)fluoren-9-yl](3-tert-butyl-2-phenoxy)titaniumdichloride, diphenylmethylene[2,7-di(2-sec-butylphenyl)fluoren-9-yl](3-tert-butyl-5-methyl-2-phenoxy)titaniumdichloride, diphenylmethylene[2,7-di(2-sec-butylphenyl)fluoren-9-yl](3-phenyl-2-phenoxy)titaniumdichloride, diphenylmethylene[2,7-di(2-sec-butylphenyl)fluoren-9-yl](3-test-butyldimethylsilyl-5-methyl-2-phenoxy) titaniumdichloride, diphenylmethylene[2,7-di(2-sec-butylphenyl)fluoren-9-yl](3-trimethylsilyl-5-methyl-2-phenoxy)titaniumdichloride, diphenylmethylene[2,7-di(2-sec-butylphenyl)fluoren-9-yl](3-tert-butyl-5-methoxy-2-phenoxy)titaniumdichloride and diphenylmethylene[2,7-di(2-sec-butylphenyl)fluoren-9-yl](3-tert-butyl-5-chloro-2-phenoxy)titaniumdichloride.

Diphenylmethylene[2,7-di(3-sec-butylphenyl)fluoren-9-yl](3,5-dimethyl-2-phenoxy)titaniumdichloride, diphenylmethylene[2,7-di(3-sec-butylphenyl)fluoren-9-yl](3-tert-butyl-2-phenoxy)titaniumdichloride, diphenylmethylene[2,7-di(3-sec-butylphenyl)fluoren-9-yl](3-tert-butyl-5-methyl-2-phenoxy)titaniumdichloride, diphenylmethylene[2,7-di(3-sec-butylphenyl)fluoren-9-yl](3-phenyl-2-phenoxy)titaniumdichloride, diphenylmethylene[2,7-di(3-sec-butylphenyl)fluoren-9-yl](3-tert-butyldimethylsilyl-5-methyl-2-phenoxy) titaniumdichloride, diphenylmethylene[2,7-di(3-sec-butylphenyl)fluoren-9-yl](3-trimethylsilyl-5-methyl-2-phenoxy)titaniumdichloride, diphenylmethylene[2,7-di(3-sec-butylphenyl)fluoren-9-yl](3-tert-butyl-5-methoxy-2-phenoxy)titaniumdichloride and diphenylmethylene[2,7-di(3-sec-butylphenyl)fluoren-9-yl](3-tert-butyl-5-chloro-2-phenoxy)titaniumdichloride.

Diphenylmethylene[2,7-di(4-sec-butylphenyl)fluoren-9-yl](3,5-dimethyl-2-phenoxy)titaniumdichloride, diphenylmethylene[2,7-di(4-sec-butylphenyl)fluoren-9-yl](3-tert-butyl-2-phenoxy)titaniumdichloride, diphenylmethylene[2,7-di(4-sec-butylphenyl)fluoren-9-yl](3-tert-butyl-5-methyl-2-phenoxy)titaniumdichloride, diphenylmethylene[2,7-di(4-sec-butylphenyl)fluoren-9-yl](3-phenyl-2-phenoxy)titaniumdichloride, diphenylmethylene[2,7-di(4-sec-butylphenyl)fluoren-9-yl](3-tert-butyldimethylsilyl-5-methyl-2-phenoxy) titaniumdichloride, diphenylmethylene[2,7-di(4-sec-butylphenyl)fluoren-9-yl](3-trimethylsilyl-5-methyl-2-phenoxy)titaniumdichloride, diphenylmethylene[2,7-di(4-sec-butylphenyl)fluoren-9-yl](3-tert-butyl-5-methoxy-2-phenoxy)titaniumdichloride and diphenylmethylene[2,7-di(4-sec-butylphenyl)fluoren-9-yl](3-tert-butyl-5-chloro-2-phenoxy)titaniumdichloride.

Diphenylmethylene[2,7-di(2-t-butylphenyl)fluoren-9-yl](3,5-dimethyl-2-phenoxy)titaniumdichloride, diphenylmethylene[2,7-di(2-t-butylphenyl)fluoren-9-yl](3-tert-butyl-2-phenoxy)titaniumdichloride, diphenylmethylene[2,7-di(2-t-butylphenyl)fluoren-9-yl](3-tert-butyl-5-methyl-2-phenoxy)titaniumdichloride, diphenylmethylene[2,7-di(2-t-butylphenyl)fluoren-9-yl](3-phenyl-2-phenoxy)titaniumdichloride, diphenylmethylene[2,7-di(2-t-butylphenyl)fluoren-9-yl](3-tert-butyldimethylsilyl-5-methyl-2-phenoxy) titaniumdichloride, diphenylmethylene[2,7-di(2-t-butylphenyl)fluoren-9-yl](3-trimethylsilyl-5-methyl-2-phenoxy)titaniumdichloride, diphenylmethylene[2,7-di(2-t-butylphenyl)fluoren-9-yl](3-tert-butyl-5-methoxy-2-phenoxy) titaniumdichloride and diphenylmethylene[2,7-di(2-t-butylphenyl)fluoren-9-yl](3-tert-butyl-5-chloro-2-phenoxy) titaniumdichloride.

Diphenylmethylene[2,7-di(3-t-butylphenyl)fluoren-9-yl](3,5-dimethyl-2-phenoxy)titaniumdichloride, diphenylmethylene[2,7-di(3-t-butylphenyl)fluoren-9-yl](3-tert-butyl-2-phenoxy)titaniumdichloride, diphenylmethylene[2,7-di(3-t-butylphenyl)fluoren-9-yl](3-tert-butyl-5-methyl-2-phenoxy)titaniumdichloride, diphenylmethylene[2,7-di(3-t-butylphenyl)fluoren-9-yl](3-phenyl-2-phenoxy)titaniumdichloride, diphenylmethylene[2,7-di(3-t-butylphenyl)fluoren-9-yl](3-tert-butyldimethylsilyl-5-methyl-2-phenoxy) titaniumdichloride, diphenylmethylene[2,7-di(3-t-butylphenyl)fluoren-9-yl](3-trimethylsilyl-5-methyl-2-phenoxy)titaniumdichloride, diphenylmethylene[2,7-di(3-t-butylphenyl)fluoren-9-yl](3-tert-butyl-5-methoxy-2-phenoxy) titaniumdichloride and diphenylmethylene[2,7-di(3-t-butylphenyl)fluoren-9-yl](3-tert-butyl-5-chloro-2-phenoxy) titaniumdichloride.

Diphenylmethylene[2,7-di(4-t-butylphenyl)fluoren-9-yl](3,5-dimethyl-2-phenoxy)titaniumdichloride, diphenylmethylene[2,7-di(4-t-butylphenyl)fluoren-9-yl](3-tert-butyl-2-phenoxy)titaniumdichloride, diphenylmethylene[2,7-di(4-t-butylphenyl)fluoren-9-yl](3-tert-butyl-5-methyl-2-phenoxy)titaniumdichloride, diphenylmethylene[2,7-di-t-n-butylphenyl]fluoren-9-yl](3-phenyl-2-phenoxy)titaniumdichloride, diphenylmethylene[2,7-di(4-t-butylphenyl)fluoren-9-yl](3-tert-butyldimethylsilyl-5-methyl-2-phenoxy) titaniumdichloride, diphenylmethylene[2,7-di(4-t-butylphenyl)fluoren-9-yl](3-trimethylsilyl-5-methyl-2-phenoxy)titaniumdichloride, diphenylmethylene[2,7-di(4-t-butylphenyl)fluoren-9-yl](3-tert-butyl-5-methoxy-2-phenoxy) titaniumdichloride, diphenylmethylene[2,7-di(4-t-butylphenyl)fluoren-9-yl](3-tert-butyl-5-chloro-2-phenoxy) titaniumdichloride, compounds in which titanium of these compounds is changed to zirconium or hafnium, compounds in which chloride is changed to bromide, iodide, dimethylamido, diethylamido, n-butoxide or isopropoxide, compounds in which 3,5-dimethyl-2-phenoxy is changed to 2-phenoxy, 3-methyl-2-phenoxy, 3,5-di-tert-butyl-2-phenoxy, 3-phenyl-5-methyl-2-phenoxy, 3-tert-butyldimethylsilyl-2-phenoxy or 3-trimethylsilyl-2-phenoxy, and compounds in which methylene is changed to diethylmethylene.

<Specific Examples of Transition Metal Complex (1) in which A¹ is Group 14 Atom of the Periodic Table of Elements Other than Carbon Atom>

Dimethylsilylene[2,7-di(2-methylphenyl)fluoren-9-yl](3,5-dimethyl-2-phenoxy)titaniumdichloride, dimethylsilylene[2,7-di(2-methylphenyl)fluoren-9-yl](3-tert-butyl-2-phenoxy)titaniumdichloride, dimethylsilylene[2,7-di(2-methylphenyl)fluoren-9-yl](3-tert-butyl-5-methyl-2-phenoxy)titaniumdichloride, dimethylsilylene[2,7-di(2-methylphenyl)fluoren-9-yl](3-phenyl-2-phenoxy)titaniumdichloride, dimethylsilylene[2,7-di(2-methylphenyl)fluoren-9-yl](3-tert-butyldimethylsilyl-5-methyl-2-phenoxy)titaniumdichloride, dimethylsilylene[2,7-di(2-methylphenyl)fluoren-9-yl](3-trimethylsilyl-5-methyl-2-phenoxy)titaniumdichloride, dimethylsilylene[2,7-di(2-methylphenyl)fluoren-9-yl](3-tert-butyl-5-methoxy-2-phenoxy)titaniumdichloride and dimethylsilylene[2,7-di(2-methylphenyl)fluoren-9-yl](3-tert-butyl-5-chloro-2-phenoxy)titaniumdichloride.

Dimethylsilylene[2,7-di(3-methylphenyl)fluoren-9-yl](3,5-dimethyl-2-phenoxy)titaniumdichloride, dimethylsilylene[2,7-di(3-methylphenyl)fluoren-9-yl](3-tert-butyl-2-phenoxy)titaniumdichloride, dimethylsilylene[2,7-di(3-methylphenyl)fluoren-9-yl](3-tert-butyl-5-methyl-2-phenoxy)titaniumdichloride, dimethylsilylene[2,7-di(3-methylphenyl)fluoren-9-yl](3-phenyl-2-phenoxy)titaniumdichloride, dimethylsilylene[2,7-di(3-methylphenyl)fluoren-9-yl](3-tert-butyldimethylsilyl-5-methyl-2-phenoxy)titaniumdichloride, dimethylsilylene[2,7-di(3-methylphenyl)fluoren-9-yl](3-trimethylsilyl-5-methyl-2-phenoxy)titaniumdichloride, dimethylsilylene[2,7-di(3-methylphenyl)fluoren-9-yl](3-tert-butyl-5-methoxy-2-phenoxy)titaniumdichloride and dimethylsilylene[2,7-di(3-methylphenyl)fluoren-9-yl](3-tert-butyl-5-chloro-2-phenoxy)titaniumdichloride.

Dimethylsilylene[2,7-di(4-methylphenyl)fluoren-9-yl](3,5-dimethyl-2-phenoxy)titaniumdichloride, dimethylsilylene[2,7-di(4-methylphenyl)fluoren-9-yl](3-tert-butyl-2-phenoxy)titaniumdichloride, dimethylsilylene[2,7-di(4-methylphenyl)fluoren-9-yl](3-tert-butyl-5-methyl-2-phenoxy)titaniumdichloride, dimethylsilylene[2,7-di(4-methylphenyl)fluoren-9-yl](3-phenyl-2-phenoxy)titaniumdichloride, dimethylsilylene[2,7-di(4-methylphenyl)fluoren-9-yl](3-tert-butyldimethylsilyl-5-methyl-2-phenoxy)titaniumdichloride, dimethylsilylene[2,7-di(4-methylphenyl)fluoren-9-yl](3-trimethylsilyl-5-methyl-2-phenoxy)titaniumdichloride, dimethylsilylene[2,7-di(4-methylphenyl)fluoren-9-yl](3-tert-butyl-5-methoxy-2-phenoxy)titaniumdichloride and dimethylsilylene[2,7-di(4-methylphenyl)fluoren-9-yl](3-tert-butyl-5-chloro-2-phenoxy)titaniumdichloride.

Dimethylsilylene[2,7-di(2-ethylphenyl)fluoren-9-yl](3,5-dimethyl-2-phenoxy)titaniumdichloride, dimethylsilylene[2,7-di(2-ethylphenyl)fluoren-9-yl](3-tert-butyl-2-phenoxy)titaniumdichloride, dimethylsilylene[2,7-di(2-ethylphenyl)fluoren-9-yl](3-tert-butyl-5-methyl-2-phenoxy)titaniumdichloride, dimethylsilylene[2,7-di(2-ethylphenyl)fluoren-9-yl](3-phenyl-2-phenoxy) titaniumdichloride, dimethylsilylene[2,7-di(2-ethylphenyl)fluoren-9-yl](3-tert-butyldimethylsilyl-5-methyl-2-phenoxy)titaniumdichloride, dimethylsilylene[2,7-di(2-ethylphenyl)fluoren-9-yl](3-trimethylsilyl-5-methyl-2-phenoxy)titaniumdichloride, dimethylsilylene[2,7-di(2-ethylphenyl)fluoren-9-yl](3-tert-butyl-5-methoxy-2-phenoxy) titaniumdichloride and dimethylsilylene[2,7-di(2-ethylphenyl)fluoren-9-yl](3-tert-butyl-5-chloro-2-phenoxy) titaniumdichloride.

Dimethylsilylene[2,7-di(3-ethylphenyl)fluoren-9-yl](3,5-dimethyl-2-phenoxy)titaniumdichloride, dimethylsilylene[2,7-di(3-ethylphenyl)fluoren-9-yl](3-tert-butyl-2-phenoxy)titaniumdichloride, dimethylsilylene[2,7-di(3-ethylphenyl)fluoren-9-yl](3-tert-butyl-5-methyl-2-phenoxy)titaniumdichloride, dimethylsilylene[2,7-di(3-ethylphenyl)fluoren-9-yl](3-phenyl-2-phenoxy) titaniumdichloride, dimethylsilylene[2,7-di(3-ethylphenyl)fluoren-9-yl](3-tert-butyldimethylsilyl-5-methyl-2-phenoxy)titaniumdichloride, dimethylsilylene[2,7-di(3-ethylphenyl)fluoren-9-yl](3-trimethylsilyl-5-methyl-2-phenoxy)titaniumdichloride, dimethylsilylene[2,7-di(3-ethylphenyl)fluoren-9-yl](3-tert-butyl-5-methoxy-2-phenoxy) titaniumdichloride and dimethylsilylene[2,7-di(3-ethylphenyl)fluoren-9-yl](3-tert-butyl-5-chloro-2-phenoxy) titaniumdichloride.

Dimethylsilylene[2,7-di(4-ethylphenyl)fluoren-9-yl](3,5-dimethyl-2-phenoxy)titaniumdichloride, dimethylsilylene[2,7-di(4-ethylphenyl)fluoren-9-yl](3-tert-butyl-2-phenoxy)titaniumdichloride, dimethylsilylene[2,7-di(4-ethylphenyl)fluoren-9-yl](3-tert-butyl-5-methyl-2-phenoxy)titaniumdichloride, dimethylsilylene[2,7-di(4-ethylphenyl)fluoren-9-yl](3-phenyl-2-phenoxy) titaniumdichloride, dimethylsilylene[2,7-di(4-ethylphenyl)fluoren-9-yl](3-tert-butyldimethylsilyl-5-methyl-2-phenoxy)titaniumdichloride, dimethylsilylene[2,7-di(4-ethylphenyl)fluoren-9-yl](3-trimethylsilyl-5-methyl-2-phenoxy)titaniumdichloride, dimethylsilylene[2,7-di(4-ethylphenyl)fluoren-9-yl](3-tert-butyl-5-methoxy-2-phenoxy) titaniumdichloride and dimethylsilylene[2,7-di(4-ethylphenyl)fluoren-9-yl](3-tert-butyl-5-chloro-2-phenoxy) titaniumdichloride.

Dimethylsilylene[2,7-di(2-n-butylphenyl)fluoren-9-yl](3,5-dimethyl-2-phenoxy)titaniumdichloride, dimethylsilylene[2,7-di(2-n-butylphenyl)fluoren-9-yl](3-tert-butyl-2-phenoxy)titaniumdichloride, dimethylsilylene[2,7-di(2-n-butylphenyl)fluoren-9-yl](3-tert-butyl-5-methyl-2-phenoxy)titaniumdichloride, dimethylsilylene[2,7-di(2-n-butylphenyl)fluoren-9-yl](3-phenyl-2-phenoxy)titaniumdichloride, dimethylsilylene[2,7-di(2-n-butylphenyl)fluoren-9-yl](3-tert-butyldimethylsilyl-5-methyl-2-phenoxy)titaniumdichloride, dimethylsilylene[2,7-di(2-n-butylphenyl)fluoren-9-yl](3-trimethylsilyl-5-methyl-2-phenoxy)titaniumdichloride, dimethylsilylene[2,7-di(2-n-butylphenyl)fluoren-9-yl](3-tert-butyl-5-methoxy-2-phenoxy)titaniumdichloride and dimethylsilylene[2,7-di(2-n-butylphenyl)fluoren-9-yl](3-tert-butyl-5-chloro-2-phenoxy)titaniumdichloride.

Dimethylsilylene[2,7-di(3-n-butylphenyl)fluoren-9-yl](3,5-dimethyl-2-phenoxy)titaniumdichloride, dimethylsilylene[2,7-di(3-n-butylphenyl)fluoren-9-yl](3-tert-butyl-2-phenoxy)titaniumdichloride, dimethylsilylene[2,7-di(3-n-butylphenyl)fluoren-9-yl](3-tert-butyl-5-methyl-2-phenoxy)titaniumdichloride, dimethylsilylene[2,7-di(3-n-butylphenyl)fluoren-9-yl](3-phenyl-2-phenoxy)titaniumdichloride, dimethylsilylene[2,7-di(3-n-butylphenyl)fluoren-9-yl](3-tert-butyldimethylsilyl-5-methyl-2-phenoxy)titaniumdichloride, dimethylsilylene[2,7-di(3-n-butylphenyl)fluoren-9-yl](3-trimethylsilyl-5-methyl-2-phenoxy)titaniumdichloride, dimethylsilylene[2,7-di(3-n-butylphenyl)fluoren-9-yl](3-tert-butyl-5-methoxy-2-phenoxy)titaniumdichloride and dimethylsilylene[2,7-di(3-n-butylphenyl)fluoren-9-yl](3-tert-butyl-5-chloro-2-phenoxy)titaniumdichloride.

Dimethylsilylene[2,7-di(4-n-butylphenyl)fluoren-9-yl](3,5-dimethyl-2-phenoxy)titaniumdichloride, dimethylsilylene[2,7-di(4-n-butylphenyl)fluoren-9-yl](3-tert-butyl-2-phenoxy)titaniumdichloride, dimethylsilylene[2,7-di(4-n-butylphenyl)fluoren-9-yl](3-tert-butyl-5-methyl-2-phenoxy)titaniumdichloride, dimethylsilylene[2,7-di(4-n-butylphenyl)fluoren-9-yl](3-phenyl-2-phenoxy)titaniumdichloride, dimethylsilylene[2,7-di(4-n-butylphenyl)fluoren-9-yl](3-tert-butyldimethylsilyl-5-methyl-2-phenoxy)titaniumdichloride, dimethylsilylene[2,7-di(4-n-butylphenyl)fluoren-9-yl](3-trimethylsilyl-5-methyl-2-phenoxy)titaniumdichloride, dimethylsilylene[2,7-di(4-n-butylphenyl)fluoren-9-yl](3-tert-butyl-5-methoxy-2-phenoxy)titaniumdichloride and dimethylsilylene[2,7-di(4-n-butylphenyl)fluoren-9-yl](3-tert-butyl-5-chloro-2-phenoxy)titaniumdichloride.

Dimethylsilylene[2,7-di(2-sec-butylphenyl)fluoren-9-yl](3,5-dimethyl-2-phenoxy)titaniumdichloride, dimethylsilylene[2,7-di(2-sec-butylphenyl)fluoren-9-yl](3-tert-butyl-2-phenoxy)titaniumdichloride, dimethylsilylene[2,7-di(2-sec-butylphenyl)fluoren-9-yl](3-tert-butyl-5-methyl-2-phenoxy)titaniumdichloride, dimethylsilylene[2,7-di(2-sec-butylphenyl)fluoren-9-yl](3-phenyl-2-phenoxy)titaniumdichloride, dimethylsilylene[2,7-di(2-sec-butylphenyl)fluoren-9-yl](3-tert-butyldimethylsilyl-5-methyl-2-phenoxy)titaniumdichloride, dimethylsilylene[2,7-di(2-sec-butylphenyl)fluoren-9-yl](3-trimethylsilyl-5-methyl-2-phenoxy)titaniumdichloride, dimethylsilylene[2,7-di(2-sec-butylphenyl)fluoren-9-yl](3-tert-butyl-5-methoxy-2-phenoxy)titaniumdichloride and dimethylsilylene[2,7-di(2-sec-butylphenyl)fluoren-9-yl](3-tert-butyl-5-chloro-2-phenoxy)titaniumdichloride.

Dimethylsilylene[2,7-di(3-sec-butylphenyl)fluoren-9-yl](3,5-dimethyl-2-phenoxy)titaniumdichloride, dimethylsilylene[2,7-di(3-sec-butylphenyl)fluoren-9-yl](3-tert-butyl-2-phenoxy)titaniumdichloride, dimethylsilylene[2,7-di(3-sec-butylphenyl)fluoren-9-yl](3-tert-butyl-5-methyl-2-phenoxy)titaniumdichloride, dimethylsilylene[2,7-di(3-sec-butylphenyl)fluoren-9-yl](3-phenyl-2-phenoxy)titaniumdichloride, dimethylsilylene[2,7-di(3-sec-butylphenyl)fluoren-9-yl](3-tert-butyldimethylsilyl-5-methyl-2-phenoxy)titaniumdichloride, dimethylsilylene[2,7-di(3-sec-butylphenyl)fluoren-9-yl](3-trimethylsilyl-5-methyl-2-phenoxy)titaniumdichloride, dimethylsilylene[2,7-di(3-sec-butylphenyl)fluoren-9-yl](3-tert-butyl-5-methoxy-2-phenoxy)titaniumdichloride and dimethylsilylene[2,7-di(3-sec-butylphenyl)fluoren-9-yl](3-tert-butyl-5-chloro-2-phenoxy)titaniumdichloride.

Dimethylsilylene[2,7-di(4-sec-butylphenyl)fluoren-9-yl](3,5-dimethyl-2-phenoxy)titaniumdichloride, dimethylsilylene[2,7-di(4-sec-butylphenyl)fluoren-9-yl](3-tert-butyl-2-phenoxy)titaniumdichloride, dimethylsilylene[2,7-di(4-sec-butylphenyl)fluoren-9-yl](3-tert-butyl-5-methyl-2-phenoxy)titaniumdichloride, dimethylsilylene[2,7-di(4-sec-butylphenyl)fluoren-9-yl](3-phenyl-2-phenoxy)titaniumdichloride, dimethylsilylene[2,7-di(4-sec-butylphenyl)fluoren-9-yl](3-tert-butyldimethylsilyl-5-methyl-2-phenoxy)titaniumdichloride, dimethylsilylene[2,7-di(4-sec-butylphenyl)fluoren-9-yl](3-trimethylsilyl-5-methyl-2-phenoxy)titaniumdichloride, dimethylsilylene[2,7-di(4-sec-butylphenyl)fluoren-9-yl](3-tert-butyl-5-methoxy-2-phenoxy)titaniumdichloride and dimethylsilylene[2,7-di(4-sec-butylphenyl)fluoren-9-yl](3-tert-butyl-5-chloro-2-phenoxy)titaniumdichloride.

Dimethylsilylene[2,7-di(2-t-butylphenyl)fluoren-9-yl](3,5-dimethyl-2-phenoxy)titaniumdichloride, dimethylsilylene[2,7-di(2-t-butylphenyl)fluoren-9-yl](3-tert-butyl-2-phenoxy)titaniumdichloride, dimethylsilylene[2,7-di(2-t-butylphenyl)fluoren-9-yl](3-tert-butyl-5-methyl-2-phenoxy)titaniumdichloride, dimethylsilylene[2,7-di(2-t-butylphenyl)fluoren-9-yl](3-phenyl-2-phenoxy)titaniumdichloride, dimethylsilylene[2,7-di(2-t-butylphenyl)fluoren-9-yl](3-tert-butyldimethylsilyl-5-methyl-2-phenoxy)titaniumdichloride, dimethylsilylene[2,7-di(2-t-butylphenyl)fluoren-9-yl](3-trimethylsilyl-5-methyl-2-phenoxy)titaniumdichloride, dimethylsilylene[2,7-di(2-t-butylphenyl)fluoren-9-yl](3-tert-butyl-5-methoxy-2-phenoxy)titaniumdichloride and dimethylsilylene[2,7-di(2-t-butylphenyl)fluoren-9-yl](3-tert-butyl-5-chloro-2-phenoxy)titaniumdichloride.

Dimethylsilylene[2,7-di(3-t-butylphenyl)fluoren-9-yl](3,5-dimethyl-2-phenoxy)titaniumdichloride, dimethylsilylene[2,7-di(3-t-butylphenyl)fluoren-9-yl](3-tert-butyl-2-phenoxy)titaniumdichloride, dimethylsilylene[2,7-di(3-t-butylphenyl)fluoren-9-yl](3-tert-butyl-5-methyl-2-phenoxy)titaniumdichloride, dimethylsilylene[2,7-di(3-t-butylphenyl)fluoren-9-yl](3-phenyl-2-phenoxy)titaniumdichloride, dimethylsilylene[2,7-di(3-t-butylphenyl)fluoren-9-yl](3-tert-butyldimethylsilyl-5-methyl-2-phenoxy)titaniumdichloride, dimethylsilylene[2,7-di(3-t-butylphenyl)fluoren-9-yl](3-trimethylsilyl-5-methyl-2-phenoxy)titaniumdichloride, dimethylsilylene[2,7-di(3-t-butylphenyl)fluoren-9-yl](3-tert-butyl-5-methoxy-2-phenoxy)titaniumdichloride and dimethylsilylene[2,7-di(3-t-butylphenyl)fluoren-9-yl](3-tert-butyl-5-chloro-2-phenoxy)titaniumdichloride.

Dimethylsilylene[2,7-di(4-t-butylphenyl)fluoren-9-yl](3,5-dimethyl-2-phenoxy)titaniumdichloride, dimethylsilylene[2,7-di(4-t-butylphenyl)fluoren-9-yl](3-tert-butyl-2-phenoxy)titaniumdichloride, dimethylsilylene[2,7-di(4-t-butylphenyl)fluoren-9-yl](3-tert-butyl-5-methyl-2-phenoxy)titaniumdichloride, dimethylsilylene[2,7-di(t-n-butylphenyl)fluoren-9-yl](3-phenyl-2-phenoxy)titaniumdichloride, dimethylsilylene[2,7-di(4-t-butylphenyl)fluoren-9-yl](3-tert-butyldimethylsilyl-5-methyl-2-phenoxy)titaniumdichloride, dimethylsilylene[2,7-di(4-t-butylphenyl)fluoren-9-yl](3-trimethylsilyl-5-methyl-2-phenoxy)titaniumdichloride, dimethylsilylene[2,7-di(4-t-butylphenyl)fluoren-9-yl](3-tert-butyl-5-methoxy-2-phenoxy)titaniumdichloride, dimethylsilylene[2,7-di(4-t-butylphenyl)fluoren-9-yl](3-tert-butyl-5-chloro-2-phenoxy)titaniumdichloride, compounds in which 2-phenoxy of these compounds is changed to 3-phenyl-2-phenoxy, 3-trimethylsilyl-2-phenoxy or 3-tert-butyldimethylsilyl-2-phenoxy, compounds in which dimethylsilylene is changed to diethylsilylene, diphenylsilylene, ethylmethylsilylene, methylphenylsilylene, dimethylgermirene or dimethoxysilylene, compounds in which titanium is changed to zirconium or hafnium, and compounds in which chloride is changed to bromide, iodide, dimethylamido, diethylamido, n-butoxide or isopropoxide.

Among them, the transition metal complex (1) is particularly preferably a transition metal complex represented by the following formula (1-1).

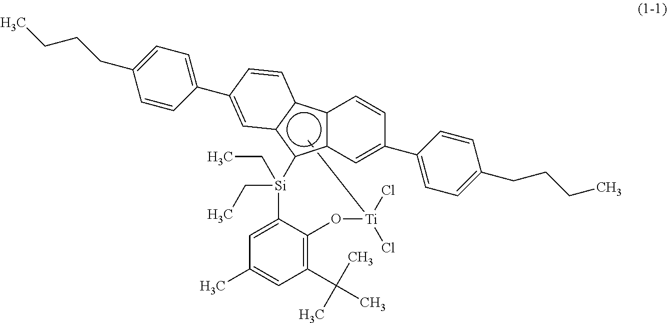

### [Method for Producing Transition Metal Complex]

The method for producing a transition metal complex of the present invention is not particularly limited as long as it is a method capable of obtaining the complex, and the method is preferably a method for producing a transition metal complex (hereinafter, this method is sometimes referred to as a production method of the present invention), which includes step I of reacting a substituted fluorene compound represented by the formula (2) (hereinafter referred to as a substituted fluorene compound (2)) with a metal element-containing basic compound, and step II of reacting the compound obtained by the base treatment step with a dihalogenated diamido transition metal complex represented by the formula (3) (hereinafter referred to as a dihalogenated diamido transition metal complex (3)). The transition metal complex (1) obtained by the method for producing a transition metal complex of the present invention has a structure in common with the substituted fluorene compound (2):

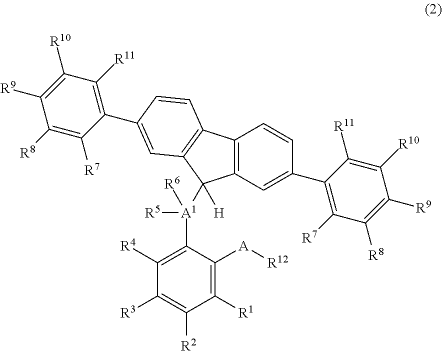

in the formula (2), A, A¹, R¹, R², R³, R⁴, R⁵, R⁶, R⁷, R⁸, R⁹, R¹⁰, R¹¹ and R¹² are respectively as defined above,

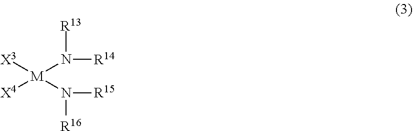

in the formula (3), M, R¹³, R¹⁴, R¹⁵, R¹⁶, X³ and X⁴ are respectively as defined above.

### <Substituted Fluorene Compound Represented by the Formula (2)>

A, A¹, R¹, R², R³, R⁴, R⁵, R⁶, R⁷, R⁸, R⁹, R¹⁰ and R¹¹ in the formula (2) respectively have the same meanings as those of A, A¹, R¹, R², R³, R⁴, R⁵, R⁶, R⁷, R⁸, R⁹, R¹⁰ and R¹¹ in the formula (1), and preferable range is also the same.

R¹² in the substituted fluorene compound (2) represents a hydrocarbon group or a trisubstituted silyl group, and the hydrocarbon group may be substituted with a halogen atom or an alkoxy group.

The hydrocarbon group in R¹² includes, for example, an alkyl group having 1 to 10 carbon atoms such as a methyl group, an ethyl group, a propyl group, a butyl group, a pentyl group, a hexyl group, a heptyl group, an octyl group, a nonyl group and a decyl group; an alkenyl group having 2 to 10 carbon atoms such as a vinyl group, an allyl group, a propenyl group, a 2-methyl-2-propenyl group, a homoallyl group, a pentenyl group, a hexenyl group, a heptenyl group, an octenyl group, a nonenyl group and a decenyl group; an aralkyl group having 7 to 12 carbon atoms such as a benzyl group, a (4-methylphenyl)methyl group and a (2,4,6-trimethylphenyl)methyl group; and an alkoxyalkyl group such as a methoxymethyl group and a methoxyethoxymethyl group.

Examples of the hydrocarbon group substituted with a halogen atom such as a fluorine atom, a chlorine atom, a bromine atom or an iodine atom include a 2-chloro-2-propenyl group.

The trisubstituted silyl group in R¹² includes, for example, a silyl group having an alkyl group as a substituent. The silyl group includes, for example, a trimethylsilyl group, a triethylsilyl group, a tri-n-propylsilyl group, a triisopropylsilyl group, a tri-n-butylsilyl group, a tri-sec-butylsilyl group, a tri-tert-butylsilyl group, a triisobutylsilyl group, a tert-butyl-dimethylsilyl group, a tri-n-pentylsilyl group, a tri-n-hexylsilyl group, a tricyclohexylsilyl group and a triphenylsilyl group.

R¹² is preferably an alkenyl group, more preferably an alkenyl group having 2 to 10 carbon atoms, and still more preferably an allyl group since the transition metal complex (1) can be effectively produced.

The substituted fluorene compound (2) can include, for example, the following compounds.

(2-allyloxyphenyl) [2,7-di(2-methylphenyl)fluoren-9-yl]dimethylsilane, (2-allyloxy-3-methylphenyl) [2,7-di(2-methylphenyl)fluoren-9-yl]dimethylsilane, (2-allyloxy-3,5-dimethylphenyl) [2,7-di(2-methylphenyl)fluoren-9-yl]dimethylsilane, (2-allyloxy-3-tert-butylphenyl) [2,7-di(2-methylphenyl)fluoren-9-yl]dimethylsilane, (2-allyloxy-3-tert-butyl-5-methylphenyl) [2,7-di(2-methylphenyl)fluoren-9-yl]dimethylsilane, (2-allyloxy-3,5-di-tert-butylphenyl) [2,7-di(2-methylphenyl)fluoren-9-yl]dimethylsilane, (2-allyloxy-5-methyl-3-phenylphenyl) [2,7-di(2-methylphenyl)fluoren-9-yl]dimethylsilane, (2-allyloxy-5-methyl-3-trimethylsilylphenyl) [2,7-di(2-methylphenyl)fluoren-9-yl]dimethylsilane, (2-allyloxy-3-tert-butyldimethylsilyl-5-methylphenyl) [2,7-di(2-methylphenyl)fluoren-9-yl]dimethylsilane, (2-allyloxy-3,5-diamylphenyl) [2,7-di(2-methylphenyl)fluoren-9-yl]dimethylsilane, (2-allyloxy-3-tert-butyl-5-methoxyphenyl) [2,7-di(2-methylphenyl)fluoren-9-yl]dimethylsilane, (2-allyloxy-5-tert-butyl-3-chlorophenyl) [2,7-di(2-methylphenyl)fluoren-9-yl]dimethylsilane and (1-allyloxynaphthalen-2-yl) [2,7-di(2-methylphenyl)fluoren-9-yl]dimethylsilane.

(2-allyloxyphenyl) [2,7-di(3-methylphenyl)fluoren-9-yl]dimethylsilane, (2-allyloxy-3-methylphenyl) [2,7-di(3-methylphenyl)fluoren-9-yl]dimethylsilane, (2-allyloxy-3,5-dimethylphenyl) [2,7-di(3-methylphenyl)fluoren-9-yl]dimethylsilane, (2-allyloxy-3-tert-butylphenyl) [2,7-di(3-methylphenyl)fluoren-9-yl]dimethylsilane, (2-allyloxy-3-tert-butyl-5-methylphenyl) [2,7-di(3-methylphenyl)fluoren-9-yl]dimethylsilane, (2-allyloxy-3,5-di-tert-butylphenyl) [2,7-di(3-methylphenyl)fluoren-9-yl]dimethylsilane, (2-allyloxy-5-methyl-3-phenylphenyl) [2,7-di(3-methylphenyl)fluoren-9-yl]dimethylsilane, (2-allyloxy-5-methyl-3-trimethylsilylphenyl) [2,7-di(3-methylphenyl)fluoren-9-yl]dimethylsilane, (2-allyloxy-3-tert-butyldimethylsilyl-5-methylphenyl) [2,7-di(3-methylphenyl)fluoren-9-yl]dimethylsilane, (2-allyloxy-3,5-diamylphenyl) [2,7-di(3-methylphenyl)fluoren-9-yl]dimethylsilane, (2-allyloxy-3-tert-butyl-5-methoxyphenyl) [2,7-di(3-methylphenyl)fluoren-9-yl]dimethylsilane, (2-allyloxy-5-tert-butyl-3-chlorophenyl) [2,7-di(3-methylphenyl)fluoren-9-yl]dimethylsilane and (1-allyloxynaphthalen-2-yl) [2,7-di(3-methylphenyl)fluoren-9-yl]dimethylsilane.

(2-allyloxyphenyl) [2,7-di(4-methylphenyl)fluoren-9-yl]dimethylsilane, (2-allyloxy-3-methylphenyl) [2,7-di(4-methylphenyl)fluoren-9-yl]dimethylsilane, (2-allyloxy-3,5-dimethylphenyl) [2,7-di(4-methylphenyl)fluoren-9-yl]dimethylsilane, (2-allyloxy-3-tert-butylphenyl) [2,7-di(4-methylphenyl)fluoren-9-yl]dimethylsilane, (2-allyloxy-3-tert-butyl-5-methylphenyl) [2,7-di(4-methylphenyl)fluoren-9-yl]dimethylsilane, (2-allyloxy-3,5-di-tert-butylphenyl) [2,7-di(4-methylphenyl)fluoren-9-yl]dimethylsilane, (2-allyloxy-5-methyl-3-phenylphenyl) [2,7-di(4-methylphenyl)fluoren-9-yl]dimethylsilane, (2-allyloxy-5-methyl-3-trimethylsilylphenyl) [2,7-di(4-methylphenyl)fluoren-9-yl]dimethylsilane, (2-allyloxy-3-tert-butyldimethylsilyl-5-methylphenyl) [2,7-di(4-methylphenyl)fluoren-9-yl]dimethylsilane, (2-allyloxy-3,5-diamylphenyl) [2,7-di(4-methylphenyl)fluoren-9-yl]dimethylsilane, (2-allyloxy-3-tert-butyl-5-methoxyphenyl) [2,7-di(4-methylphenyl)fluoren-9-yl]dimethylsilane, (2-allyloxy-5-tert-butyl-3-chlorophenyl) [2,7-di(4-methylphenyl)fluoren-9-yl]dimethylsilane and (1-allyloxynaphthalen-2-yl) [2,7-di(4-methylphenyl)fluoren-9-yl]dimethylsilane.

(2-allyloxyphenyl) [2,7-di(2-ethylphenyl)fluoren-9-yl]dimethylsilane, (2-allyloxy-3-methylphenyl) [2,7-di(2-ethylphenyl)fluoren-9-yl]dimethylsilane, (2-allyloxy-3,5-dimethylphenyl) [2,7-di(2-ethylphenyl)fluoren-9-yl]dimethylsilane, (2-allyloxy-3-tert-butylphenyl) [2,7-di(2-ethylphenyl)fluoren-9-yl]dimethylsilane, (2-allyloxy-3-tert-butyl-5-methylphenyl) [2,7-di(2-ethylphenyl)fluoren-9-yl]dimethylsilane, (2-allyloxy-3,5-di-tert-butylphenyl) [2,7-di(2-ethylphenyl)fluoren-9-yl]dimethylsilane, (2-allyloxy-5-methyl-3-phenylphenyl) [2,7-di(2-ethylphenyl)fluoren-9-yl]dimethylsilane, (2-allyloxy-5-methyl-3-trimethylsilylphenyl) [2,7-di(2-ethylphenyl)fluoren-9-yl]dimethylsilane, (2-allyloxy-3-tert-butyldimethylsilyl-5-methylphenyl) [2,7-di(2-ethylphenyl)fluoren-9-yl]dimethylsilane, (2-allyloxy-3,5-diamylphenyl) [2,7-di(2-ethylphenyl)fluoren-9-yl]dimethylsilane, (2-allyloxy-3-tert-butyl-5-methoxyphenyl) [2,7-di(2-ethylphenyl)fluoren-9-yl]dimethylsilane, (2-allyloxy-5-tert-butyl-3-chlorophenyl) [2,7-di(2-ethylphenyl)fluoren-9-yl]dimethylsilane and (1-allyloxynaphthalen-2-yl) [2,7-di(2-ethylphenyl)fluoren-9-yl]dimethylsilane.

(2-allyloxyphenyl) [2,7-di(3-ethylphenyl)fluoren-9-yl]dimethylsilane, (2-allyloxy-3-methylphenyl) [2,7-di(3-ethylphenyl)fluoren-9-yl]dimethylsilane, (2-allyloxy-3,5-dimethylphenyl) [2,7-di(3-ethylphenyl)fluoren-9-yl]dimethylsilane, (2-allyloxy-3-tert-butylphenyl) [2,7-di(3-ethylphenyl)fluoren-9-yl]dimethylsilane, (2-allyloxy-3-tert-butyl-5-methylphenyl) [2,7-di(3-ethylphenyl)fluoren-9-yl]dimethylsilane, (2-allyloxy-3,5-di-tert-butylphenyl) [2,7-di(3-ethylphenyl)fluoren-9-yl]dimethylsilane, (2-allyloxy-5-methyl-3-phenylphenyl) [2,7-di(3-ethylphenyl)fluoren-9-yl]dimethylsilane, (2-allyloxy-5-methyl-3-trimethylsilylphenyl) [2,7-di(3-ethylphenyl)fluoren-9-yl]dimethylsilane, (2-allyloxy-3-tert-butyldimethylsilyl-5-methylphenyl) [2,7-di(3-ethylphenyl)fluoren-9-yl]dimethylsilane, (2-allyloxy-3,5-diamylphenyl) [2,7-di(3-ethylphenyl)fluoren-9-yl]dimethylsilane, (2-allyloxy-3-tert-butyl-5-methoxyphenyl) [2,7-di(3-ethylphenyl)fluoren-9-yl]dimethylsilane, (2-allyloxy-5-tert-butyl-3-chlorophenyl) [2,7-di(3-ethylphenyl)fluoren-9-yl]dimethylsilane and (1-allyloxynaphthalen-2-yl) [2,7-di(3-ethylphenyl)fluoren-9-yl]dimethylsilane.

(2-allyloxyphenyl) [2,7-di(4-ethylphenyl)fluoren-9-yl]dimethylsilane, (2-allyloxy-3-methylphenyl) [2,7-di(4-ethylphenyl)fluoren-9-yl]dimethylsilane, (2-allyloxy-3,5-dimethylphenyl) [2,7-di(4-ethylphenyl)fluoren-9-yl]dimethylsilane, (2-allyloxy-3-tert-butylphenyl) [2,7-di(4-ethylphenyl)fluoren-9-yl]dimethylsilane, (2-allyloxy-3-tert-butyl-5-methylphenyl) [2,7-di(4-ethylphenyl)fluoren-9-yl]dimethylsilane, (2-allyloxy-3,5-di-tert-butylphenyl) [2,7-di(4-ethylphenyl)fluoren-9-yl]dimethylsilane, (2-allyloxy-5-methyl-3-phenylphenyl) [2,7-di(4-ethylphenyl)fluoren-9-yl]dimethylsilane, (2-allyloxy-5-methyl-3-trimethylsilylphenyl) [2,7-di(4-ethylphenyl)fluoren-9-yl]dimethylsilane, (2-allyloxy-3-tert-butyldimethylsilyl-5-methylphenyl) [2,-di(4-ethylphenyl)fluoren-9-yl]dimethylsilane, (2-allyloxy-3,5-diamylphenyl) [2,7-di(4-ethylphenyl)fluoren-9-yl]dimethylsilane, (2-allyloxy-3-tert-butyl-5-methoxyphenyl) [2,7-di(4-ethylphenyl)fluoren-9-yl]dimethylsilane, (2-allyloxy-5-tert-butyl-3-chlorophenyl) [2,7-di(4-ethylphenyl)fluoren-9-yl]dimethylsilane and (1-allyloxynaphthalen-2-yl) [2,7-di(4-ethylphenyl)fluoren-9-yl]dimethylsilane.

(2-allyloxyphenyl) [2,7-di(2-n-butylphenyl)fluoren-9-yl]dimethylsilane, (2-allyloxy-3-methylphenyl) [2,7-di(2-n-butylphenyl)fluoren-9-yl]dimethylsilane, (2-allyloxy-3,5-dimethylphenyl) [2,7-di(2-n-butylphenyl)fluoren-9-yl]dimethylsilane, (2-allyloxy-3-tert-butylphenyl) [2,7-di(2-n-butylphenyl)fluoren-9-yl]dimethylsilane, (2-allyloxy-3-tert-butyl-5-methylphenyl) [2,7-di(2-n-butylphenyl)fluoren-9-yl]dimethylsilane, (2-allyloxy-3,5-di-tert-butylphenyl) [2,7-di(2-n-butylphenyl)fluoren-9-yl]dimethylsilane, (2-allyloxy-5-methyl-3-phenylphenyl) [2,7-di(2-n-butylphenyl)fluoren-9-yl]dimethylsilane, (2-allyloxy-5-methyl-3-trimethylsilylphenyl) [2,7-di(2-n-butylphenyl)fluoren-9-yl]dimethylsilane, (2-allyloxy-3-tert-butyldimethylsilyl-5-methylphenyl) [2,7-di(2-n-butylphenyl)fluoren-9-yl]dimethylsilane, (2-allyloxy-3,5-diamylphenyl) [2,7-di(2-n-butylphenyl)fluoren-9-yl]dimethylsilane, (2-allyloxy-3-tert-butyl-5-methoxyphenyl) [2,7-di(2-n-butylphenyl)fluoren-9-yl]dimethylsilane, (2-allyloxy-5-tert-butyl-3-chlorophenyl) [2,7-di(2-n-butylphenyl)fluoren-9-yl]dimethylsilane and (1-allyloxynaphthalen-2-yl) [2,7-di(2-n-butylphenyl)fluoren-9-yl]dimethylsilane.

(2-allyloxyphenyl) [2,7-di(3-n-butylphenyl)fluoren-9-yl]dimethylsilane, (2-allyloxy-3-methylphenyl) [2,7-di(3-n-butylphenyl)fluoren-9-yl]dimethylsilane, (2-allyloxy-3,5-dimethylphenyl) [2,7-di(3-n-butylphenyl)fluoren-9-yl]dimethylsilane, (2-allyloxy-3-tert-butylphenyl) [2,7-di(3-n-butylphenyl)fluoren-9-yl]dimethylsilane, (2-allyloxy-3-tert-butyl-5-methylphenyl) [2,7-di(3-n-butylphenyl)fluoren-9-yl]dimethylsilane, (2-allyloxy-3,5-di-tert-butylphenyl) [2,7-di(3-n-butylphenyl)fluoren-9-yl]dimethylsilane, (2-allyloxy-5-methyl-3-phenylphenyl) [2,7-di(3-n-butylphenyl)fluoren-9-yl]dimethylsilane, (2-allyloxy-5-methyl-3-trimethylsilylphenyl) [2,7-di(3-n-butylphenyl)fluoren-9-yl]dimethylsilane, (2-allyloxy-3-tert-butyldimethylsilyl-5-methylphenyl) [2,7-di(3-n-butylphenyl)fluoren-9-yl]dimethylsilane, (2-allyloxy-3,5-diamylphenyl) [2,7-di(3-n-butylphenyl)fluoren-9-yl]dimethylsilane, (2-allyloxy-3-tert-butyl-5-methoxyphenyl) [2,7-di(3-n-butylphenyl)fluoren-9-yl]dimethylsilane, (2-allyloxy-5-tert-butyl-3-chlorophenyl) [2,7-di(3-n-butylphenyl)fluoren-9-yl]dimethylsilane and (1-allyloxynaphthalen-2-yl) [2,7-di(3-n-butylphenyl)fluoren-9-yl]dimethylsilane.

(2-allyloxyphenyl) [2,7-di(4-n-butylphenyl)fluoren-9-yl]dimethylsilane, (2-allyloxy-3-methylphenyl) [2,7-di(4-n-butylphenyl)fluoren-9-yl]dimethylsilane, (2-allyloxy-3,5-dimethylphenyl) [2,7-di(4-n-butylphenyl)fluoren-9-yl]dimethylsilane, (2-allyloxy-3-tert-butylphenyl) [2,7-di(4-n-butylphenyl)fluoren-9-yl]dimethylsilane, (2-allyloxy-3-tert-butyl-5-methylphenyl) [2,7-di(4-n-butylphenyl)fluoren-9-yl]dimethylsilane, (2-allyloxy-3,5-di-tert-butylphenyl) [2,7-di(4-n-butylphenyl)fluoren-9-yl]dimethylsilane, (2-allyloxy-5-methyl-3-phenylphenyl) [2,7-di(4-n-butylphenyl)fluoren-9-yl]dimethylsilane, (2-allyloxy-5-methyl-3-trimethylsilylphenyl) [2,7-di(4-n-butylphenyl)fluoren-9-yl]dimethylsilane, (2-allyloxy-3-tert-butyldimethylsilyl-5-methylphenyl) [2,7-di(4-n-butylphenyl)fluoren-9-yl]dimethylsilane, (2-allyloxy-3,5-diamylphenyl) [2,7-di(4-n-butylphenyl)fluoren-9-yl]dimethylsilane, (2-allyloxy-3-tert-butyl-5-methoxyphenyl) [2,7-di(4-n-butylphenyl)fluoren-9-yl]dimethylsilane, (2-allyloxy-5-tert-butyl-3-chlorophenyl) [2,7-di(4-n-butylphenyl)fluoren-9-yl]dimethylsilane and (1-allyloxynaphthalen-2-yl) [2,7-di(4-n-butylphenyl)fluoren-9-yl]dimethylsilane.

(2-allyloxyphenyl) [2,7-di(2-sec-butylphenyl)fluoren-9-yl]dimethylsilane, (2-allyloxy-3-methylphenyl) [2,7-di(2-sec-butylphenyl)fluoren-9-yl]dimethylsilane, (2-allyloxy-3,5-dimethylphenyl) [2,7-di(2-sec-butylphenyl)fluoren-9-yl]dimethylsilane, (2-allyloxy-3-tert-butylphenyl) [2,7-di(2-sec-butylphenyl)fluoren-9-yl]dimethylsilane, (2-allyloxy-3-tert-butyl-5-methylphenyl) [2,7-di(2-sec-butylphenyl)fluoren-9-yl]dimethylsilane, (2-allyloxy-3,5-di-tert-butylphenyl) [2,7-di(2-sec-butylphenyl)fluoren-9-yl]dimethylsilane, (2-allyloxy-5-methyl-3-phenylphenyl) [2,7-di(2-sec-butylphenyl)fluoren-9-yl]dimethylsilane, (2-allyloxy-5-methyl-3-trimethylsilylphenyl) [2,7-di(2-sec-butylphenyl)fluoren-9-yl]dimethylsilane, (2-allyloxy-3-tert-butyldimethylsilyl-5-methylphenyl) [2,7-di(2-sec-butylphenyl)fluoren-9-yl]dimethylsilane, (2-allyloxy-3,5-diamylphenyl) [2,7-di(2-sec-butylphenyl)fluoren-9-yl]dimethylsilane, (2-allyloxy-3-tert-butyl-5-methoxyphenyl) [2,7-di(2-sec-butylphenyl)fluoren-9-yl]dimethylsilane, (2-allyloxy-5-tert-butyl-3-chlorophenyl) [2,7-di(2-sec-butylphenyl)fluoren-9-yl]dimethylsilane and (1-allyloxynaphthalen-2-yl) [2,7-di(2-sec-butylphenyl)fluoren-9-yl]dimethylsilane.

(2-allyloxyphenyl) [2,7-di(3-sec-butylphenyl)fluoren-9-yl]dimethylsilane, (2-allyloxy-3-methylphenyl) [2,7-di(3-sec-butylphenyl)fluoren-9-yl]dimethylsilane, (2-allyloxy-3,5-dimethylphenyl) [2,7-di(3-sec-butylphenyl)fluoren-9-yl]dimethylsilane, (2-allyloxy-3-tert-butylphenyl) [2,7-di(3-sec-butylphenyl)fluoren-9-yl]dimethylsilane, (2-allyloxy-3-tert-butyl-5-methylphenyl) [2,7-di(3-sec-butylphenyl)fluoren-9-yl]dimethylsilane, (2-allyloxy-3,5-di-tert-butylphenyl) [2,7-di(3-sec-butylphenyl)fluoren-9-yl]dimethylsilane, (2-allyloxy-5-methyl-3-phenylphenyl) [2,7-di(3-sec-butylphenyl)fluoren-9-yl]dimethylsilane, (2-allyloxy-5-methyl-3-trimethylsilylphenyl) [2,7-di(3-sec-butylphenyl)fluoren-9-yl]dimethylsilane, (2-allyloxy-3-tert-butyldimethylsilyl-5-methylphenyl) [2,7-di(3-sec-butylphenyl)fluoren-9-yl]dimethylsilane, (2-allyloxy-3,5-diamylphenyl) [2,7-di(3-sec-butylphenyl)fluoren-9-yl]dimethylsilane, (2-allyloxy-3-tert-butyl-5-methoxyphenyl) [2,7-di(3-sec-butylphenyl)fluoren-9-yl]dimethylsilane, (2-allyloxy-5-tert-butyl-3-chlorophenyl) [2,7-di(3-sec-butylphenyl)fluoren-9-yl]dimethylsilane and (1-allyloxynaphthalen-2-yl) [2,7-di(3-sec-butylphenyl)fluoren-9-yl]dimethylsilane.

(2-allyloxyphenyl) [2,7-di(4-sec-butylphenyl)fluoren-9-yl]dimethylsilane, (2-allyloxy-3-methylphenyl) [2,7-di(4-sec-butylphenyl)fluoren-9-yl]dimethylsilane, (2-allyloxy-3,5-dimethylphenyl) [2,7-di(4-sec-butylphenyl)fluoren-9-yl]dimethylsilane, (2-allyloxy-3-tert-butylphenyl) [2,7-di(4-sec-butylphenyl)fluoren-9-yl]dimethylsilane, (2-allyloxy-3-tert-butyl-5-methylphenyl) [2,7-di(4-sec-butylphenyl)fluoren-9-yl]dimethylsilane, (2-allyloxy-3,5-di-tert-butylphenyl) [2,7-di(4-sec-butylphenyl)fluoren-9-yl]dimethylsilane, (2-allyloxy-5-methyl-3-phenylphenyl) [2,7-di(4-sec-butylphenyl)fluoren-9-yl]dimethylsilane, (2-allyloxy-5-methyl-3-trimethylsilylphenyl) [2,7-di(4-sec-butylphenyl)fluoren-9-yl]dimethylsilane, (2-allyloxy-3-tert-butyldimethylsilyl-5-methylphenyl) [2,7-di(4-sec-butylphenyl)fluoren-9-yl]dimethylsilane, (2-allyloxy-3,5-diamylphenyl) [2,7-di(4-sec-butylphenyl)fluoren-9-yl]dimethylsilane, (2-allyloxy-3-tert-butyl-5-methoxyphenyl) [2,7-di(4-sec-butylphenyl)fluoren-9-yl]dimethylsilane, (2-allyloxy-5-tert-butyl-3-chlorophenyl) [2,7-di(4-sec-butylphenyl)fluoren-9-yl]dimethylsilane and (1-allyloxynaphthalen-2-yl) [2,7-di(4-sec-butylphenyl)fluoren-9-yl]dimethylsilane.

(2-allyloxyphenyl) [2,7-di(2-t-butylphenyl)fluoren-9-yl]dimethylsilane, (2-allyloxy-3-methylphenyl) [2,7-di(2-t-butylphenyl)fluoren-9-yl]dimethylsilane, (2-allyloxy-3,5-dimethylphenyl) [2,7-di(2-t-butylphenyl)fluoren-9-yl]dimethylsilane, (2-allyloxy-3-tert-butylphenyl) [2,7-di(2-t-butylphenyl)fluoren-9-yl]dimethylsilane, (2-allyloxy-3-tert-butyl-5-methylphenyl) [2,7-di(2-t-butylphenyl)fluoren-9-yl]dimethylsilane, (2-allyloxy-3,5-di-tert-butylphenyl) [2,7-di(2-t-butylphenyl)fluoren-9-yl]dimethylsilane, (2-allyloxy-5-methyl-3-phenylphenyl) [2,7-di(2-t-butylphenyl)fluoren-9-yl]dimethylsilane, (2-allyloxy-5-methyl-3-trimethylsilylphenyl) [2,7-di(2-t-butylphenyl)fluoren-9-yl]dimethylsilane, (2-allyloxy-3-tert-butyldimethylsilyl-5-methylphenyl) [2,7-di(2-t-butylphenyl)fluoren-9-yl]dimethylsilane, (2-allyloxy-3,5-diamylphenyl) [2,7-di(2-t-butylphenyl)fluoren-9-yl]dimethylsilane, (2-allyloxy-3-tert-butyl-5-methoxyphenyl) [2,7-di(2-t-butylphenyl)fluoren-9-yl]dimethylsilane, (2-allyloxy-5-tert-butyl-3-chlorophenyl) [2,7-di(2-t-butylphenyl)fluoren-9-yl]dimethylsilane and (1-allyloxynaphthalen-2-yl) [2,7-di(2-t-butylphenyl)fluoren-9-yl]dimethylsilane.

(2-allyloxyphenyl) [2,7-di(3-t-butylphenyl)fluoren-9-yl]dimethylsilane, (2-allyloxy-3-methylphenyl) [2,7-di(3-t-butylphenyl)fluoren-9-yl]dimethylsilane, (2-allyloxy-3,5-dimethylphenyl) [2,7-di(3-t-butylphenyl)fluoren-9-yl]dimethylsilane, (2-allyloxy-3-tert-butylphenyl) [2,7-di(3-t-butylphenyl)fluoren-9-yl]dimethylsilane, (2-allyloxy-3-tert-butyl-5-methylphenyl) [2,7-di(3-t-butylphenyl)fluoren-9-yl]dimethylsilane, (2-allyloxy-3,5-di-tert-butylphenyl) [2,7-di(3-t-butylphenyl)fluoren-9-yl]dimethylsilane, (2-allyloxy-5-methyl-3-phenylphenyl) [2,7-di(3-t-butylphenyl)fluoren-9-yl]dimethylsilane, (2-allyloxy-5-methyl-3-trimethylsilylphenyl) [2,7-di(3-t-butylphenyl)fluoren-9-yl]dimethylsilane, (2-allyloxy-3-tert-butyldimethylsilyl-5-methylphenyl) [2,7-di(3-t-butylphenyl)fluoren-9-yl]dimethylsilane, (2-allyloxy-3,5-diamylphenyl) [2,7-di(3-t-butylphenyl)fluoren-9-yl]dimethylsilane, (2-allyloxy-3-tert-butyl-5-methoxyphenyl) [2,7-di(3-t-butylphenyl)fluoren-9-yl]dimethylsilane, (2-allyloxy-5-tert-butyl-3-chlorophenyl) [2,7-di(3-t-butylphenyl)fluoren-9-yl]dimethylsilane and (1-allyloxynaphthalen-2-yl) [2,7-di(3-t-butylphenyl)fluoren-9-yl]dimethylsilane.

(2-allyloxyphenyl) [2,7-di(4-t-butylphenyl)fluoren-9-yl]dimethylsilane, (2-allyloxy-3-methylphenyl) [2,7-di(4-t-butylphenyl)fluoren-9-yl]dimethylsilane, (2-allyloxy-3,5-dimethylphenyl) [2,7-di(4-t-butylphenyl)fluoren-9-yl]dimethylsilane, (2-allyloxy-3-tert-butylphenyl) [2,7-di(4-t-butylphenyl)fluoren-9-yl]dimethylsilane, (2-allyloxy-3-tert-butyl-5-methylphenyl) [2,7-di(4-t-butylphenyl)fluoren-9-yl]dimethylsilane, (2-allyloxy-3,5-di-tert-butylphenyl) [2,7-di(4-t-butylphenyl)fluoren-9-yl]dimethylsilane, (2-allyloxy-5-methyl-3-phenylphenyl) [2,7-di(4-t-butylphenyl)fluoren-9-yl]dimethylsilane, (2-allyloxy-5-methyl-3-trimethylsilylphenyl) [2,7-di(4-t-butylphenyl)fluoren-9-yl]dimethylsilane, (2-allyloxy-3-tert-butyldimethylsilyl-5-methylphenyl) [2,7-di(4-t-butylphenyl)fluoren-9-yl]dimethylsilane, (2-allyloxy-3,5-diamylphenyl) [2,7-di(4-t-butylphenyl)fluoren-9-yl]dimethylsilane, (2-allyloxy-3-tert-butyl-5-methoxyphenyl) [2,7-di(4-t-butylphenyl)fluoren-9-yl]dimethylsilane, (2-allyloxy-5-tert-butyl-3-chlorophenyl) [2,7-di(4-t-butylphenyl)fluoren-9-yl]dimethylsilane and (1-allyloxynaphthalen-2-yl) [2,7-di(4-t-butylphenyl)fluoren-9-yl]dimethylsilane.

It includes compounds in which dimethylsilane in the above-mentioned compounds is changed to diethylsilane, diphenylsilane, ethylmethylsilane, methylphenylsilane or dimethylgermanium.

The substituted fluorene compound (2) is useful as a precursor of a transition metal complex, particularly a ligand precursor of the transition metal complex (1). The substituted fluorene compound (2) can be used as a ligand precursor of a transition metal complex for homopolymerization of 1-butene. Namely, the substituted fluorene compound (2) is useful as a material of a transition metal complex, particularly the transition metal complex (1).

### <Dihalogenated Diamido Transition Metal Complex Represented by the Formula (3)>

In the formula (3), the Group 4 element of the Periodic Table of elements represented by M includes, for example, a titanium atom, a zirconium atom and a hafnium atom, preferably a titanium atom.

In the formula (3), R¹³, R¹⁴, R¹⁵ and R¹⁶ each independently represents an alkyl group having 1 to 20 carbon atoms, an aryl group having 6 to 20 carbon atoms, or an aralkyl group having 7 to 20 carbon atoms. The alkyl group, the aryl group and the aralkyl group may be substituted with a halogen atom. R¹³ and R¹⁴ may be joined to form a ring. R¹⁵ and R¹⁶ may be joined to form a ring.

Examples of the alkyl group, aryl group, aralkyl group and halogen atom respectively include the same groups as those mentioned for R¹, R², R³, R⁴, R⁵ and R⁶ in the formula (1).

R¹³, R¹⁴, R¹⁵ and R¹⁶ each is preferably an alkyl group having 1 to 5 carbon atoms, an alkyl group having 1 to 5 carbon atoms substituted with a halogen atom, an aryl group having 6 to 10 carbon atoms, or an aralkyl group having 7 to 10 carbon atoms, and more preferably an alkyl group having 1 to 5 carbon atoms, a phenyl group or a benzyl group.

X³ and X⁴ each represents a halogen atom. Examples of each of X³ and X⁴ include the groups mentioned for X¹ and X². X³ and X⁴ each is preferably a chlorine atom.

The dihalogenated diamido transition metal complex (3) includes, for example, dichlorobis(dimethylamido)titanium, dichlorobis(diethylamido)titanium, dichlorobis(di-n-propylamido) titanium, dichlorobis(diisopropylamido)titanium, dichlorobis(di-n-butylamido)titanium, dichlorobis(diphenylamido)titanium, dichlorobis(dibenzylamido)titanium, dichlorobis(di-1-pyrrolidinyl)titanium, dichlorobis(di-1-piperidinyl)titanium, and compounds in which titanium of the above respective compounds is changed to zirconium or hafnium.

Among them, dichlorobis[di(C1-C4 alkyl)amido]titanium is preferable, and dichlorobis(dimethylamido)titanium and dichlorobis(diethylamido)titanium are more preferable.

The dihalogenated diamido transition metal complex (3) can be obtained, for example, by a dismutation reaction between a tetraamido transition metal complex and a tetrahydrogenated transition metal complex in accordance with a known method (see, for example, Inorg. Chem., 1996, 35, 6742).

### <Step I>

Step I is a step of reacting the substituted fluorene compound (2) with a metal element-containing basic compound.

Step I is preferably conducted in a solvent which is inert to the reaction.

The solvent includes polar solvents, for example, an ether-based solvent such as diethylether, tetrahydrofuran and 1,4-dioxane; an amide-based solvent such as hexamethylphosphoric amide and dimethylformamide; and acetonitrile, propionitrile, acetone, diethylketone, methyl isobutyl ketone and cyclohexanone; and

aprotic solvents, for example, an aromatic hydrocarbon-based solvent such as benzene and toluene; an aliphatic hydrocarbon-based solvent such as hexane and heptane; and a halogen-based solvent such as dichloromethane, dichloroethane, chlorobenzene and dichlorobenzene.

These solvents may be respectively used alone, or in combination of two or more kinds thereof.

The use amount of the solvent is preferably from 1 to 200 parts by weight, and more preferably from 3 to 50 parts by weight, per part by weight of the substituted fluorene compound (2).

The metal element-containing basic compound means a compound which has a metal element, and also can form an anion by withdrawing an H-cation from the substituted fluorene compound (2).

The metal element-containing basic compound in the present step is not particularly limited as long as it is a metal element-containing compound which can form an anion by withdrawing an H-cation from the substituted fluorene compound (2) and includes, for example, an organic alkaline metal compound such as an organolithium compound; a metal hydride such as sodium hydride and potassium hydride. The organic alkaline metal compound may be a metal alkoxide such as sodium methoxide and potassium butoxide. The organolithium compound includes, for example, methyllithium, ethyllithium, n-butyllithium, sec-butyllithium, tert-butyllithium, lithium trimethylsilyl acetylide, lithium acetylide, trimethylsilylmethyllithium, vinyllithium, phenyllithium and allyllithium. The metal element-containing basic compound is preferably an organic alkaline metal compound.

The use amount of the metal element-containing basic compound in step I is preferably from 0.5 to 5 mol per mol of the substituted fluorene compound (2).

In the reaction between the substituted fluorene compound (2) and the metal element-containing basic compound, an amine compound can also be used together with the metal element-containing basic compound.

The amine compound includes, for example, a primary amine compound such as methylamine, ethylamine, n-propylamine, isopropylamine, n-butylamine, tert-butylamine, n-octylamine, n-decylamine, aniline and ethylenediamine; a secondary amine compound such as dimethylamine, diethylamine, di-n-propylamine, di-n-propylamine, di-n-butylamine, di-tert-butylamine, di-n-octylamine, di-n-decylamine, pyrrolidine, hexamethyldisilazane and diphenylamine; a tertiary amine compound such as trimethylamine, triethylamine, tri-n-propylamine, tri-n-butylamine, diisopropylethylamine, tri-n-octylamine, tri-n-decylamine, triphenylamine, N,N-dimethylaniline, N,N,N′,N′-tetramethylethylenediamine, N-methylpyrrolidine and 4-dimethylaminopyridine.

The use amount of the amino compound is preferably 10 mol or less, more preferably from 0.5 to 10 mol, and still more preferably from 1 to 3 mol, per mol of the metal element-containing basic compound.

The temperature of the reaction between the substituted fluorene compound (2) and the metal element-containing basic compound in step I is preferably within a range from −100° C. to a boiling point of the solvent, and more preferably from −80° C. to 60° C. when an organic alkaline metal compound is used as the metal element-containing basic compound.

### <Step II>

Step II is a step of reacting the compound obtained by step I with the dihalogenated diamido transition metal complex represented by the formula (3).

The reaction in step II is preferably conducted by adding the dihalogenated diamido transition metal complex (3) to the reaction solution obtained by step I.

After adding the substituted fluorene compound (2) and the metal element-containing basic compound, a solid is sometimes precipitated. In this case, the solid may be taken out from the reaction system and added to the solvent, followed by adding the dihalogenated diamido transition metal complex (3).

In step II, the use amount of the dihalogenated diamido transition metal complex (3) is preferably within a range from 0.5 to 3 mol, and more preferably from 1.0 to 2 mol, per mol of the substituted fluorene compound (2). From the viewpoint of obtaining the transition metal complex (1) in a better yield, it is particularly preferably within a range from 1.2 to 1.5 mol.

In step II, after adding the dihalogenated diamido transition metal complex (3) to the reaction solution obtained by step I, the reaction temperature is preferably raised, commonly.

The reaction temperature at adding the dihalogenated diamido transition metal complex (3) to the reaction solution obtained by step I is preferably within a range from −100° C. to a boiling point of the solvent, more preferably from −80° C. to 60° C., and still more preferably from −80° C. to 0° C.

In step II, after adding the dihalogenated diamido transition metal complex (3), the reaction temperature is preferably within a range from 0° C. to a boiling point of the solvent, and more preferably from 60° C. to 110° C., since the transition metal complex (1) can be obtained in a good yield.

### <Step III>

The method for producing a transition metal complex of the present invention more preferably further includes step III of reacting the complex obtained by step II with a halogenated silyl compound represented by the formula (4):

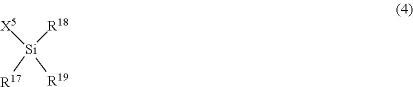

in the formula (4), R¹⁷, R¹⁸ and R¹⁹ each independently represents a halogen atom, an alkyl group having 1 to 20 carbon atoms, an aryl group having 6 to 20 carbon atoms, or an aralkyl group having 7 to 20 carbon atoms. The alkyl group, the aryl group and the aralkyl group may be substituted with a halogen atom. Two of R¹⁷, R¹⁸ and R¹⁹ may be joined to form a ring. Examples of each of the alkyl group, aryl group, aralkyl group and halogen atom include the same groups as those mentioned as R¹, R², R³, R⁴, R⁵ and R⁶ in the formula (1).

X⁵ represents a halogen atom. Examples of X⁵ include the groups mentioned as each of X¹ and X².

The halogenated silyl compound represented by the formula (4) (hereinafter referred to as a halogenated silyl compound (4)) includes, for example, chlorotrimethylsilane, chlorotriethylsilane, chlorotriisopropylsilane, chlorotri-n-propylsilane, chlorotri-n-butylsilane, chlorotri-sec-butylsilane, chlorotri-tert-butylsilane, tert-butyldimethylchlorosilane, dimethylphenylchlorosilane, chloromethylsilacyclohexane, chloromethylsilacyclobutane, chloromethylsilacyclopentane, chlorotriphenylsilane, 3-chloropropyldimethylchlorosilane, dichlorodimethylsilane, methyltrichlorosilane, benzyltrichlorosilane, tetrachlorosilane, and compounds in which a chlorine atom in any one of the compounds is changed to a fluorine atom, a bromine atom or an iodine atom. Among them, chlorotrimethylsilane, tert-butyldimethylchlorosilane and the like are preferable.

The reaction temperature in step III is preferably within a range from −100° C. to a boiling point of the solvent, and more preferably from −80° C. to 60° C.

The reaction mixture obtained by the reaction in step II usually contains a metal halide compound produced as a by-product. In order to remove the by-product, an operation such as filtration may be conducted before or after the reaction in step III.

The reaction mixture obtained by the reaction in step II usually contains a diamido transition metal complex as an intermediate. The reaction mixture may be reacted as it is in step III, or the diamido transition metal complex may be collected from the reaction mixture and further purified before the reaction. When the diamido transition metal complex is collected and purified before the reaction in step III, it is added to a solvent which can be used in step III and then a halogenated silyl compound (4) is added to the obtained complex solution, and thus the reaction can be conducted.

The halogenated amido transition metal complex is sometimes produced as an intermediate by the reaction in step III. The halogenated amido transition metal complex may be collected from the reaction mixture obtained by step III and purified, and then further reacted with the halogenated silyl compound (4), or may be further reacted with the halogenated silyl compound (4) without taking out from the reaction mixture. When the halogenated amido transition metal complex is taken out from the reaction mixture and then purified, it is added to the solvent and then the halogenated silyl compound (4) is added to the obtained complex solution, and thus the reaction can be conducted.

Step III is also useful as a step of changing the kind of each substituent X¹ or X² in the transition metal complex (1) obtained by a method other than the method for producing a transition metal complex of the present invention.

Regardless of the method for producing the transition metal complex (1), the kind of each substituent X¹ or X² can also be changed by a known method.

The method of changing the kind of each substituent X¹ or X² includes, for example, methods of reacting the obtained transition metal complex with various compounds, described in JP-A-2000-086678, JP-A-2000-119286 and JP-A-2000-119287.

Transition metal complex (1) obtained by the production method of the present invention includes the following ones.

Dimethylsilylene[2,7-di(2-methylphenyl)fluoren-9-yl](3,5-dimethyl-2-phenoxy)titaniumdichloride, dimethylsilylene[2,7-di(2-methylphenyl)fluoren-9-yl](3-tert-butyl-2-phenoxy)titaniumdichloride, dimethylsilylene[2,7-di(2-methylphenyl)fluoren-9-yl](3-tert-butyl-5-methyl-2-phenoxy)titaniumdichloride, dimethylsilylene[2,7-di(2-methylphenyl)fluoren-9-yl](3-phenyl-2-phenoxy)titaniumdichloride, dimethylsilylene[2,7-di(2-methylphenyl)fluoren-9-yl](3-tert-butyldimethylsilyl-5-methyl-2-phenoxy)titaniumdichloride, dimethylsilylene[2,7-di(2-methylphenyl)fluoren-9-yl](3-trimethylsilyl-5-methyl-2-phenoxy)titaniumdichloride, dimethylsilylene[2,7-di(2-methylphenyl)fluoren-9-yl] (3-tert-butyl-5-methoxy-2-phenoxy)titaniumdichloride and dimethylsilylene[2,7-di(2-methylphenyl)fluoren-9-yl](3-tert-butyl-5-chloro-2-phenoxy)titaniumdichloride.

Dimethylsilylene[2,7-di(3-methylphenyl)fluoren-9-yl](3,5-dimethyl-2-phenoxy)titaniumdichloride, dimethylsilylene[2,7-di(3-methylphenyl)fluoren-9-yl](3-tert-butyl-2-phenoxy)titaniumdichloride, dimethylsilylene[2,7-di(3-methylphenyl)fluoren-9-yl](3-tert-butyl-5-methyl-2-phenoxy)titaniumdichloride, dimethylsilylene[2,7-di(3-methylphenyl)fluoren-9-yl](3-phenyl-2-phenoxy)titaniumdichloride, dimethylsilylene[2,7-di(3-methylphenyl)fluoren-9-yl](3-tert-butyldimethylsilyl-5-methyl-2-phenoxy)titaniumdichloride, dimethylsilylene[2,7-di(3-methylphenyl)fluoren-9-yl](3-trimethylsilyl-5-methyl-2-phenoxy)titaniumdichloride, dimethylsilylene[2,7-di(3-methylphenyl)fluoren-9-yl](3-tert-butyl-5-methoxy-2-phenoxy)titaniumdichloride and dimethylsilylene[2,7-di(3-methylphenyl)fluoren-9-yl](3-tert-butyl-5-chloro-2-phenoxy)titaniumdichloride.

Dimethylsilylene[2,7-di(4-methylphenyl)fluoren-9-yl](3,5-dimethyl-2-phenoxy)titaniumdichloride, dimethylsilylene[2,7-di(4-methylphenyl)fluoren-9-yl](3-tert-butyl-2-phenoxy)titaniumdichloride, dimethylsilylene[2,7-di(4-methylphenyl)fluoren-9-yl](3-tert-butyl-5-methyl-2-phenoxy)titaniumdichloride, dimethylsilylene[2,7-di(4-methylphenyl)fluoren-9-yl](3-phenyl-2-phenoxy)titaniumdichloride, dimethylsilylene[2,7-di(4-methylphenyl)fluoren-9-yl](3-tert-butyldimethylsilyl-5-methyl-2-phenoxy)titaniumdichloride, dimethylsilylene[2,7-di(4-methylphenyl)fluoren-9-yl](3-trimethylsilyl-5-methyl-2-phenoxy)titaniumdichloride, dimethylsilylene[2,7-di(4-methylphenyl)fluoren-9-yl](3-tert-butyl-5-methoxy-2-phenoxy)titaniumdichloride and dimethylsilylene[2,7-di(4-methylphenyl)fluoren-9-yl](3-tert-butyl-5-chloro-2-phenoxy)titaniumdichloride.

Dimethylsilylene[2,7-di(2-ethylphenyl)fluoren-9-yl](3,5-dimethyl-2-phenoxy)titaniumdichloride, dimethylsilylene[2,7-di(2-ethylphenyl)fluoren-9-yl](3-tert-butyl-2-phenoxy)titaniumdichloride, dimethylsilylene[2,7-di(2-ethylphenyl)fluoren-9-yl](3-tert-butyl-5-methyl-2-phenoxy)titaniumdichloride, dimethylsilylene[2,7-di(2-ethylphenyl)fluoren-9-yl](3-phenyl-2-phenoxy) titaniumdichloride, dimethylsilylene[2,7-di(2-ethylphenyl)fluoren-9-yl](3-tert-butyldimethylsilyl-5-methyl-2-phenoxy)titaniumdichloride, dimethylsilylene[2,7-di(2-ethylphenyl)fluoren-9-yl](3-trimethylsilyl-5-methyl-2-phenoxy)titaniumdichloride, dimethylsilylene[2,7-di(2-ethylphenyl)fluoren-9-yl](3-tert-butyl-5-methoxy-2-phenoxy) titaniumdichloride and dimethylsilylene[2,7-di(2-ethylphenyl)fluoren-9-yl](3-tert-butyl-5-chloro-2-phenoxy) titaniumdichloride.

Dimethylsilylene[2,7-di(3-ethylphenyl)fluoren-9-yl](3,5-dimethyl-2-phenoxy)titaniumdichloride, dimethylsilylene[2,7-di(3-ethylphenyl)fluoren-9-yl](3-tert-butyl-2-phenoxy)titaniumdichloride, dimethylsilylene[2,7-di(3-ethylphenyl)fluoren-9-yl](3-tert-butyl-5-methyl-2-phenoxy)titaniumdichloride, dimethylsilylene[2,7-di(3-ethylphenyl)fluoren-9-yl](3-phenyl-2-phenoxy) titaniumdichloride, dimethylsilylene[2,7-di(3-ethylphenyl)fluoren-9-yl](3-tert-butyldimethylsilyl-5-methyl-2-phenoxy)titaniumdichloride, dimethylsilylene[2,7-di(3-ethylphenyl)fluoren-9-yl](3-trimethylsilyl-5-methyl-2-phenoxy)titaniumdichloride, dimethylsilylene[2,7-di(3-ethylphenyl)fluoren-9-yl](3-tert-butyl-5-methoxy-2-phenoxy) titaniumdichloride and dimethylsilylene[2,7-di(3-ethylphenyl)fluoren-9-yl](3-tert-butyl-5-chloro-2-phenoxy) titaniumdichloride.

Dimethylsilylene[2,7-di(4-ethylphenyl)fluoren-9-yl](3,5-dimethyl-2-phenoxy)titaniumdichloride, dimethylsilylene[2,7-di(4-ethylphenyl)fluoren-9-yl](3-tert-butyl-2-phenoxy)titaniumdichloride, dimethylsilylene[2,7-di(4-ethylphenyl)fluoren-9-yl](3-tert-butyl-5-methyl-2-phenoxy)titaniumdichloride, dimethylsilylene[2,7-di(4-ethylphenyl)fluoren-9-yl](3-phenyl-2-phenoxy) titaniumdichloride, dimethylsilylene[2,7-di(4-ethylphenyl)fluoren-9-yl](3-tert-butyldimethylsilyl-5-methyl-2-phenoxy)titaniumdichloride, dimethylsilylene[2,7-di(4-ethylphenyl)fluoren-9-yl](3-trimethylsilyl-5-methyl-2-phenoxy)titaniumdichloride, dimethylsilylene[2,7-di(4-ethylphenyl)fluoren-9-yl](3-tert-butyl-5-methoxy-2-phenoxy) titaniumdichloride and dimethylsilylene[2,7-di(4-ethylphenyl)fluoren-9-yl](3-tert-butyl-5-chloro-2-phenoxy) titaniumdichloride.

Dimethylsilylene[2,7-di(2-n-butylphenyl)fluoren-9-yl](3,5-dimethyl-2-phenoxy)titaniumdichloride, dimethylsilylene[2,7-di(2-n-butylphenyl)fluoren-9-yl](3-tert-butyl-2-phenoxy)titaniumdichloride, dimethylsilylene[2,7-di(2-n-butylphenyl)fluoren-9-yl](3-tert-butyl-5-methyl-2-phenoxy)titaniumdichloride, dimethylsilylene[2,7-di(2-n-butylphenyl)fluoren-9-yl](3-phenyl-2-phenoxy)titaniumdichloride, dimethylsilylene[2,7-di(2-n-butylphenyl)fluoren-9-yl](3-tert-butyldimethylsilyl-5-methyl-2-phenoxy)titaniumdichloride, dimethylsilylene[2,7-di(2-n-butylphenyl)fluoren-9-yl](3-trimethylsilyl-5-methyl-2-phenoxy) titaniumdichloride, dimethylsilylene[2,7-di(2-n-butylphenyl)fluoren-9-yl](3-tert-butyl-5-methoxy-2-phenoxy)titaniumdichloride and dimethylsilylene[2,7-di(2-n-butylphenyl)fluoren-9-yl](3-tert-butyl-5-chloro-2-phenoxy)titaniumdichloride.

Dimethylsilylene[2,7-di(3-n-butylphenyl)fluoren-9-yl](3,5-dimethyl-2-phenoxy)titaniumdichloride, dimethylsilylene[2,7-di(3-n-butylphenyl)fluoren-9-yl](3-tert-butyl-2-phenoxy)titaniumdichloride, dimethylsilylene[2,7-di(3-n-butylphenyl)fluoren-9-yl](3-tert-butyl-5-methyl-2-phenoxy)titaniumdichloride, dimethylsilylene[2,7-di(3-n-butylphenyl)fluoren-9-yl](3-phenyl-2-phenoxy)titaniumdichloride, dimethylsilylene[2,7-di(3-n-butylphenyl)fluoren-9-yl](3-tert-butyldimethylsilyl-5-methyl-2-phenoxy)titaniumdichloride, dimethylsilylene[2,7-di(3-n-butylphenyl)fluoren-9-yl](3-trimethylsilyl-5-methyl-2-phenoxy)titaniumdichloride, dimethylsilylene[2,7-di(3-n-butylphenyl)fluoren-9-yl](3-tert-butyl-5-methoxy-2-phenoxy)titaniumdichloride and dimethylsilylene[2,7-di(3-n-butylphenyl)fluoren-9-yl](3-tert-butyl-5-chloro-2-phenoxy)titaniumdichloride.

Dimethylsilylene[2,7-di(4-n-butylphenyl)fluoren-9-yl](3,5-dimethyl-2-phenoxy)titaniumdichloride, dimethylsilylene[2,7-di(4-n-butylphenyl)fluoren-9-yl](3-tert-butyl-2-phenoxy)titaniumdichloride, dimethylsilylene[2,7-di(4-n-butylphenyl)fluoren-9-yl](3-tert-butyl-5-methyl-2-phenoxy)titaniumdichloride, dimethylsilylene[2,7-di(4-n-butylphenyl)fluoren-9-yl](3-phenyl-2-phenoxy)titaniumdichloride, dimethylsilylene[2,7-di(4-n-butylphenyl)fluoren-9-yl](3-tert-butyldimethylsilyl-5-methyl-2-phenoxy)titaniumdichloride, dimethylsilylene[2,7-di(4-n-butylphenyl)fluoren-9-yl](3-trimethylsilyl-5-methyl-2-phenoxy)titaniumdichloride, dimethylsilylene[2,7-di(4-n-butylphenyl)fluoren-9-yl](3-tert-butyl-5-methoxy-2-phenoxy)titaniumdichloride and dimethylsilylene[2,7-di(4-n-butylphenyl)fluoren-9-yl](3-tert-butyl-5-chloro-2-phenoxy)titaniumdichloride.

Dimethylsilylene[2,7-di(2-sec-butylphenyl)fluoren-9-yl](3,5-dimethyl-2-phenoxy)titaniumdichloride, dimethylsilylene[2,7-di(2-sec-butylphenyl)fluoren-9-yl](3-tert-butyl-2-phenoxy)titaniumdichloride, dimethylsilylene[2,7-di(2-sec-butylphenyl)fluoren-9-yl](3-tert-butyl-5-methyl-2-phenoxy)titaniumdichloride, dimethylsilylene[2,7-di(2-sec-butylphenyl)fluoren-9-yl](3-phenyl-2-phenoxy)titaniumdichloride, dimethylsilylene[2,7-di(2-sec-butylphenyl)fluoren-9-yl](3-tert-butyldimethylsilyl-5-methyl-2-phenoxy)titaniumdichloride, dimethylsilylene[2,7-di(2-sec-butylphenyl)fluoren-9-yl](3-trimethylsilyl-5-methyl-2-phenoxy)titaniumdichloride, dimethylsilylene[2,7-di(2-sec-butylphenyl)fluoren-9-yl](3-tert-butyl-5-methoxy-2-phenoxy)titaniumdichloride and dimethylsilylene[2,7-di(2-sec-butylphenyl)fluoren-9-yl](3-tert-butyl-5-chloro-2-phenoxy)titaniumdichloride.

Dimethylsilylene[2,7-di(3-sec-butylphenyl)fluoren-9-yl](3,5-dimethyl-2-phenoxy)titaniumdichloride, dimethylsilylene[2,7-di(3-sec-butylphenyl)fluoren-9-yl](3-tert-butyl-2-phenoxy)titaniumdichloride, dimethylsilylene[2,7-di(3-sec-butylphenyl)fluoren-9-yl](3-tert-butyl-5-methyl-2-phenoxy)titaniumdichloride, dimethylsilylene[2,7-di(3-sec-butylphenyl)fluoren-9-yl](3-phenyl-2-phenoxy)titaniumdichloride, dimethylsilylene[2,7-di(3-sec-butylphenyl)fluoren-9-yl](3-tert-butyldimethylsilyl-5-methyl-2-phenoxy)titaniumdichloride, dimethylsilylene[2,7-di(3-sec-butylphenyl)fluoren-9-yl](3-trimethylsilyl-5-methyl-2-phenoxy)titaniumdichloride, dimethylsilylene[2,7-di(3-sec-butylphenyl)fluoren-9-yl](3-tert-butyl-5-methoxy-2-phenoxy)titaniumdichloride and dimethylsilylene[2,7-di(3-sec-butylphenyl)fluoren-9-yl](3-tert-butyl-5-chloro-2-phenoxy)titaniumdichloride.

Dimethylsilylene[2,7-di(4-sec-butylphenyl)fluoren-9-yl](3,5-dimethyl-2-phenoxy)titaniumdichloride, dimethylsilylene[2,7-di(4-sec-butylphenyl)fluoren-9-yl](3-tert-butyl-2-phenoxy)titaniumdichloride, dimethylsilylene[2,7-di(4-sec-butylphenyl)fluoren-9-yl](3-tert-butyl-5-methyl-2-phenoxy)titaniumdichloride, dimethylsilylene[2,7-di(4-sec-butylphenyl)fluoren-9-yl](3-phenyl-2-phenoxy)titaniumdichloride, dimethylsilylene[2,7-di(4-sec-butylphenyl)fluoren-9-yl](3-tert-butyldimethylsilyl-5-methyl-2-phenoxy)titaniumdichloride, dimethylsilylene[2,7-di(4-sec-butylphenyl)fluoren-9-yl](3-trimethylsilyl-5-methyl-2-phenoxy)titaniumdichloride, dimethylsilylene[2,7-di(4-sec-butylphenyl)fluoren-9-yl](3-tert-butyl-5-methoxy-2-phenoxy)titaniumdichloride and dimethylsilylene[2,7-di(4-sec-butylphenyl)fluoren-9-yl](3-tert-butyl-5-chloro-2-phenoxy)titaniumdichloride.

Dimethylsilylene[2,7-di(2-t-butylphenyl)fluoren-9-yl](3,5-dimethyl-2-phenoxy)titaniumdichloride, dimethylsilylene[2,7-di(2-t-butylphenyl)fluoren-9-yl](3-tert-butyl-2-phenoxy)titaniumdichloride, dimethylsilylene[2,7-di(2-t-butylphenyl)fluoren-9-yl](3-tert-butyl-5-methyl-2-phenoxy)titaniumdichloride, dimethylsilylene[2,7-di(2-t-butylphenyl)fluoren-9-yl](3-phenyl-2-phenoxy)titaniumdichloride, dimethylsilylene[2,7-di(2-t-butylphenyl)fluoren-9-yl](3-tert-butyldimethylsilyl-5-methyl-2-phenoxy)titaniumdichloride, dimethylsilylene[2,7-di(2-t-butylphenyl)fluoren-9-yl](3-trimethylsilyl-5-methyl-2-phenoxy)titaniumdichloride, dimethylsilylene[2,7-di(2-t-butylphenyl)fluoren-9-yl](3-tert-butyl-5-methoxy-2-phenoxy)titaniumdichloride and dimethylsilylene[2,7-di(2-t-butylphenyl)fluoren-9-yl](3-tert-butyl-5-chloro-2-phenoxy)titaniumdichloride.

Dimethylsilylene[2,7-di(3-t-butylphenyl)fluoren-9-yl](3,5-dimethyl-2-phenoxy)titaniumdichloride, dimethylsilylene[2,7-di(3-t-butylphenyl)fluoren-9-yl](3-tert-butyl-2-phenoxy)titaniumdichloride, dimethylsilylene[2,7-di(3-t-butylphenyl)fluoren-9-yl](3-tert-butyl-5-methyl-2-phenoxy)titaniumdichloride, dimethylsilylene[2,7-di(3-t-butylphenyl)fluoren-9-yl](3-phenyl-2-phenoxy)titaniumdichloride, dimethylsilylene[2,7-di(3-t-butylphenyl)fluoren-9-yl](3-tert-butyldimethylsilyl-5-methyl-2-phenoxy)titaniumdichloride, dimethylsilylene[2,7-di(3-t-butylphenyl)fluoren-9-yl](3-trimethylsilyl-5-methyl-2-phenoxy)titaniumdichloride, dimethylsilylene[2,7-di(3-t-butylphenyl)fluoren-9-yl](3-tert-butyl-5-methoxy-2-phenoxy)titaniumdichloride and dimethylsilylene[2,7-di(3-t-butylphenyl)fluoren-9-yl](3-tert-butyl-5-chloro-2-phenoxy)titaniumdichloride.

Dimethylsilylene[2,7-di(4-t-butylphenyl)fluoren-9-yl](3,5-dimethyl-2-phenoxy)titaniumdichloride, dimethylsilylene[2,7-di(4-t-butylphenyl)fluoren-9-yl](3-tert-butyl-2-phenoxy)titaniumdichloride, dimethylsilylene[2,7-di(4-t-butylphenyl)fluoren-9-yl](3-tert-butyl-5-methyl-2-phenoxy)titaniumdichloride, dimethylsilylene[2,7-dit-n-butylphenyl]fluoren-9-yl](3-phenyl-2-phenoxy)titaniumdichloride, dimethylsilylene[2,7-di(4-t-butylphenyl)fluoren-9-yl](3-tert-butyldimethylsilyl-5-methyl-2-phenoxy)titaniumdichloride, dimethylsilylene[2,7-di(4-t-butylphenyl)fluoren-9-yl](3-trimethylsilyl-5-methyl-2-phenoxy)titaniumdichloride, dimethylsilylene[2,7-di(4-t-butylphenyl)fluoren-9-yl](3-tert-butyl-5-methoxy-2-phenoxy)titaniumdichloride, dimethylsilylene[2,7-di(4-t-butylphenyl)fluoren-9-yl](3-tert-butyl-5-chloro-2-phenoxy)titaniumdichloride, compounds in which 2-phenoxy of these compounds is changed to 3-phenyl-2-phenoxy, 3-trimethylsilyl-2-phenoxy or 3-tert-butyldimethylsilyl-2-phenoxy, compounds in which dimethylsilylene is changed to diethylsilylene, diphenylsilylene, ethylmethylsilylene, methylphenylsilylene, dimethylgermirene or dimethoxysilylene, compound in which titanium is changed to zirconium or hafnium, and compounds in which chloride is changed to bromide or iodide.

### [Olefin Polymerization Catalyst]

The olefin polymerization catalyst of the present invention contains, as a constituent component, the transition metal complex of the present invention, i.e. the transition metal complex (1).

The olefin polymerization catalyst of the present invention can be commonly used as a catalyst for polymerization of an olefin having 2 to 20 carbon atoms and can be suitably used as an olefin polymerization catalyst for polymerization of 1-butene, and also can be particularly suitably used as an olefin polymerization catalyst for homopolymerization of 1-butene.

When the olefin polymerization catalyst is used for solution polymerization, it is preferably used in the amount of 0.0001 to 5 mmol/liter, and more preferably 0.001 to 1 mmol/liter in terms of the amount of the transition metal complex (1), relative to the solution.

In the case where homopolymerization of 1-butene is particularly conducted, regarding the transition metal complex (1) used as a constituent component of a catalyst for olefin polymerization, in R⁷, R⁸, R⁹, R¹⁰ and R¹¹ of the formula (1), preferably R⁷ and R¹¹ are hydrogen atoms; more preferably R⁷, R⁸, R¹⁰ and R¹¹ are hydrogen atoms and also R⁹ is an alkyl group; and further preferably R⁷, R⁸, R¹⁰ and R¹¹ are hydrogen atoms and also R⁹ is a n-butyl group.

If the olefin polymerization catalyst of the present invention is used for polymerization, an organoaluminum compound and a boron compound known as co-catalysts may be used. The co-catalyst includes, for example, a combination of at least one kind of the compound group (B) (hereinafter the compound of this group is referred to as a compound (B)) and any one of compounds described in (C) (hereinafter the compound of this group is referred to as a compound (C)).

### (B) Following Compounds (B1) to (B3)

Organoaluminum compound (B1) represented by the formula: E¹ₐAlZ₃₋ₐ.

Cyclic aluminoxane (B2) having a structure represented by the formula: {—Al(E²)-O—}_{b}

Chain aluminoxane (B3) having a structure represented by the formula: E³{-Al(E³)-O—}_{c}AlE³₂ (wherein E¹, E² and E³ each independently represents a hydrocarbon group having 1 to 8 carbon atoms and, when a plurality of E¹(s), E²(s) and E³(s) are respectively present, they may be the same or different; Z represents a hydrogen atom or a halogen atom and, when a plurality of Z(s) are present, they may be the same or different; a represents a number satisfying the relation: 0<a≦3; b represents an integer of 2 or more; and c represents an integer of 1 or more.)

### (C) Following Compounds (C1) to (C3)

Boron compound (C1) represented by the formula: BQ¹Q²Q³

Boron compound (C2) represented by the formula: Z⁺(BQ¹Q²Q³Q⁴)⁻

Boron compound (C3) represented by the formula: (L-H)⁺(BQ¹Q²Q³Q⁴)⁻

(wherein B represents a boron atom in a state of a trivalent atomic value; and Q¹, Q², Q³ and Q⁴ represent a halogen atom, a hydrocarbon group having 1 to 20 carbon atoms, a hydrogenated hydrocarbon group having 1 to 20 carbon atoms, a hydrocarbon-substituted silyl group having 1 to 20 carbon atoms, an alkoxy group having 1 to 20 carbon atoms, or a hydrocarbon-disubstituted amino group having 2 to 20 carbon atoms, and they may be the same or different.)

Specific examples of the organoaluminum compound (B1) include trialkylaluminum such as trimethylaluminum, triethylaluminum, tripropylaluminum, triisobutylaluminum and trihexylaluminum; dialkylaluminum chloride such as dimethylaluminum chloride, diethylaluminum chloride, dipropylaluminum chloride, diisobutylaluminum chloride and dihexylaluminum chloride; alkylaluminum dichloride such as methylaluminum dichloride, ethylaluminum dichloride, propylaluminum dichloride, isobutylaluminum dichloride and hexylaluminum dichloride; and dialkylaluminum hydride such as dimethylaluminum hydride, diethylaluminum hydride, dipropylaluminum hydride, diisobutylaluminum hydride and dihexylaluminum hydride. Trialkylaluminum is preferable, and triethylaluminum and triisobutylaluminum are more preferable.

Specific examples of E² and E³ in the cyclic aluminoxane (B2) and the chain aluminoxane (B3) include an alkyl group such as a methyl group, an ethyl group, a normal propyl group, an isopropyl group, a normal butyl group, an isobutyl group, a normal pentyl group and a neopentyl group. b is an integer of 2 or more, and c is an integer of 1 or more. Preferably, E² and E³ are methyl groups or isobutyl groups, b is from 2 to 40, and c is from 1 to 40.

The cyclic aluminoxane (B2) and the chain aluminoxane (B3) can be produced by various methods. There is no particular limitation on the method, and they may be produced in accordance with a known method.

For example, it is possible to produce them by bringing a solution prepared by dissolving a trialkylaluminum (for example, trimethylaluminum) in a proper organic solvent (for example, benzene and aliphatic hydrocarbon) into contact with water. Also, mentioned is a method which comprises bringing a trialkylaluminum (for example, trimethylaluminum) into contact with a metal salt containing crystal water (for example, copper sulfate hydrate).

In the boron compound (C1), Q¹, Q² and Q³ are preferably halogen atoms, hydrocarbon groups having 1 to 20 carbon atoms or hydrogenated hydrocarbon groups having 1 to 20 carbon atoms.

Specific examples of the boron compound (C1) include tris(pentafluorophenyl)borane, tris(2,3,5,6-tetrafluorophenyl)borane, tris(2,3,4,5-tetrafluorophenyl)borane, tris(3,4,5-trifluorophenyl)borane, tris(2,3,4-trifluorophenyl)borane and phenyl bis(pentafluorophenyl)borane, most preferably tris(pentafluorophenyl)borane.

In the boron compound (C2), examples of Z⁺ include an inorganic cation such as a ferrocenium cation, an alkyl-substituted ferrocenium cation and a silver cation; and an organic cation such as a triphenylmethyl cation. Examples of (BQ¹Q²Q³Q⁴)⁻ include tetrakis(pentafluorophenyl)borate, tetrakis(2,3,5,6-tetrafluorophenyl)borate, tetrakis(2,3,4,5-tetrafluorophenyl)borate, tetrakis(3,4,5-trifluorophenyl)borate, tetrakis(2,2,4-trifluorophenyl) borate, phenyl bis(pentafluorophenyl)borate and tetrakis(3,5-bistrifluoromethylphenyl)borate.

The boron compound (C2) includes, for example, ferrocenium tetrakis(pentafluorophenyl)borate, 1,1′-dimethylferrocenium tetrakis(pentafluorophenyl)borate, silver tetrakis(pentafluorophenyl)borate, triphenylmethyl tetrakis(pentafluorophenyl)borate and triphenylmethyl tetrakis(3,5-bistrifluoromethylphenyl)borate, most preferably triphenylmethyl tetrakis(pentafluorophenyl) borate.

In the boron compound (C3), examples of Broensted acid represented by (L-H)⁺ include trialkyl-substituted ammonium, N,N-dialkylanilinium, dialkylammonium and triarylphosphonium, and examples of (BQ¹Q²Q³Q⁴)⁻ include the same compounds as those described above.

Examples of the boron compound (C3) include triethylammonium tetrakis(pentafluorophenyl)borate, tripropylammonium tetrakis(pentafluorophenyl)borate, tri(n-butyl)ammonium tetrakis(pentafluorophenyl)borate, tri(n-butyl)ammonium tetrakis(3,5-bistrifluoromethylphenyl) borate, N,N-dimethylanilinium tetrakis(pentafluorophenyl) borate, N,N-diethylanilinium tetrakis(pentafluorophenyl) borate, N,N-2,4,6-pentamethylanilinium tetrakis(pentafluorophenyl)borate, N,N-dimethylanilinium tetrakis(3,5-bistrifluoromethylphenyl)borate, diisopropylammonium tetrakis(pentafluorophenyl)borate, dicyclohexylammonium tetrakis(pentafluorophenyl)borate, triphenylphosphonium tetrakis(pentafluorophenyl)borate, tri(methylphenyl)phosphonium tetrakis(pentafluorophenyl) borate and tri(dimethylphenyl)phosphonium tetrakis(pentafluorophenyl)borate, most preferably tri(n-butyl)ammonium tetrakis(pentafluorophenyl)borate or N,N-dimethylanilinium tetrakis(pentafluorophenyl)borate.

In the present invention, the transition metal complex (1) and the compound (B) and, optionally, the compound (C) can be charged in no particular order and used at polymerization. Alternatively, a reaction product obtained by bringing a combination of any compounds into contact with each other in advance may be used.

If it is added to the solution, the use amount of the compound (B) is preferably from 0.01 to 500 mmol/liter, and more preferably from 0.1 to 100 mmol/liter, in terms of an Al atom, relative to the solution. If it is added to the solution, the use amount of the compound (C) is preferably from 0.0001 to 5 mmol/liter, and more preferably from 0.001 to 1 mmol/liter, relative to the solution.

Regarding the use amount of each catalyst component, a molar ratio of the compound (B) to the transition metal complex (1) is preferably from 0.1 to 10,000, and more preferably from 5 to 2,000, and a molar ratio of the compound (C) to the transition metal complex (1) is preferably from 0.01 to 100, and more preferably from 0.5 to 10.

### [Method for Producing Polyolefin Resin]

The method for producing a polyolefin resin of the present invention includes the step of polymerizing an olefin in the presence of the olefin polymerization catalyst.

The method for producing a polyolefin resin of the present invention is suitable for polymerization of an olefin having 2 to 20 carbon atoms, more suitable for polymerization of an olefin having 2 to 5 carbon atoms, still more suitable for polymerization of 1-butene, and particularly suitable for homopolymerization of 1-butene.

According to the method for producing a polyolefin resin of the present invention, it is possible to obtain a high molecular weight poly-1-butene having an average molecular weight of about 40,000 or more, which was not easily obtained by the method of the prior art.

As the olefin used for polymerization, a chain olefin, a cyclic olefin and the like can be used. Homopolymerization may be conducted using one kind of an olefin, and copolymerization can also be conducted using two or more kinds of olefins. As the olefin, an olefin having 2 to 20 carbon atoms is preferably used.

Examples of the chain olefin include an α-olefin having 3 to 20 carbon atoms such as ethylene, propylene, 1-butene, 1-pentene, 1-hexene, 1-heptene, 1-octene, 1-nonene, 1-decene, 3-methyl-1-pentene, 4-methyl-1-pentene, 3,3-dimethyl-1-butene, 5-methyl-1-hexene and 3,3-dimethyl-1-pentene;

a non-conjugated diene such as 1,5-hexadiene, 1,4-hexadiene, 1,4-pentadiene, 1,5-heptadiene, 1,6-heptadiene, 1,6-octadiene, 1,7-octadiene, 1,7-nonadiene, 1,8-nonadiene, 1,8-decadiene, 1,9-decadiene, 1,12-tetradecadiene, 1,13-tetradecadiene, 4-methyl-1,4-hexadiene, 5-methyl-1,4-hexadiene, 7-methyl-1,6-octadiene, 3-methyl-1,4-hexadiene, 3-methyl-1,5-hexadiene, 3-ethyl-1,4-hexadiene, 3-ethyl-1,5-hexadiene, 3,3-dimethyl-1,4-hexadiene and 3,3-dimethyl-1,5-hexadiene; and
a conjugated diene such as 1,3-butadiene, isoprene, 1,3-hexadiene and 1,3-octadiene.

Examples of the cyclic olefin include an alicyclic ethylenically unsaturated compound and an aromatic ethylenically unsaturated compound.

Examples of the alicyclic ethylenically unsaturated compound include a monoolefin such as vinylcyclopentane, vinylcyclohexane, vinylcycloheptane, norbornene, 5-methyl-2-norbornene, 5-ethyl-2-norbornene, 5-butyl-2-norbornene, tetracyclododecene, tricyclodecene, tricycloundecene, pentacyclopentadecene, pentacyclohexadecene, 8-methyltetracyclododecene and 8-ethyltetracyclododecene; a non-conjugated diene such as 5-ethylidene-2-norbornene, dicyclopentadiene, 5-vinyl-2-norbornene, norbornadiene, 5-methylene-2-norbornene, 1,5-cyclooctadiene, 7-methyl-2,5-norbornadiene, 7-ethyl-2,5-norbornadiene, 7-propyl-2,5-norbornadiene, 7-butyl-2,5-norbornadiene, 7-pentyl-2,5-norbornadiene, 7-hexyl-2,5-norbornadiene, 7,7-dimethyl-2,5-norbornadiene, 7,7-methylethyl-2,5-norbornadiene, 7-chloro-2,5-norbornadiene, 7-bromo-2,5-norbornadiene, 7-fluoro-2,5-norbornadiene, 7,7-dichloro-2,5-norbornadiene, 1-methyl-2,5-norbornadiene, 1-ethyl-2,5-norbornadiene, 1-propyl-2,5-norbornadiene, 1-butyl-2,5-norbornadiene, 1-chloro-2,5-norbornadiene, 1-bromo-2,5-norbornadiene, 5,8-endomethylenehexahydronaphthalene and vinylcyclohexene; and a conjugated diene such as 1,3-cyclooctadiene and 1,3-cyclohexadiene.

Examples of the aromatic ethylenically unsaturated compound include styrene, o-methylstyrene, m-methylstyrene, p-methylstyrene, o,p-dimethylstyrene, o-ethylstyrene, m-ethylstyrene, p-ethylstyrene, α-methylstyrene and divinylbenzene.

If copolymerization of the olefin is conducted, the combination of olefins includes, for example, combinations of chain olefin/chain olefin, such as ethylene/propylene, ethylene/1-butene, ethylene/1-hexene, ethylene/propylene/1-butene, ethylene/propylene/1-hexene, propylene/1-butene and propylene/1-hexene; combinations of chain olefin/cyclic olefin, such as ethylene/vinylcyclohexane, ethylene/norbornene, ethylene/tetracyclododecene, ethylene/5-ethylidene-2-norbornene, propylene/vinylcyclohexane, propylene/norbornene, propylene/tetracyclododecene, propylene/5-ethylidene-2-norbornene and ethylene/propylene/5-ethylidene-2-norbornene.

As the olefin used for polymerization, 1-butene is used particularly preferably, and only 1-butene is used most preferably, since a high molecular weight polyolefin resin is obtained.

In the method for producing a polyolefin resin of the present invention, the polymerization method is not particularly limited and includes, for example, solvent polymerization, or slurry polymerization, bulk polymerization, and vapor phase polymerization in a gaseous monomer. When solvent polymerization is conducted, it is possible to use, as a solvent, an aliphatic hydrocarbon such as butane, pentane, hexane, heptane and octane; an aromatic hydrocarbon such as benzene and toluene; and a hydrogenated hydrocarbon such as methylene dichloride. The polymerization may be any of continuous polymerization and batchwise polymerization.

The polymerization temperature can be within a range from −50° C. to 200° C., and particularly preferably from about −20° C. to 100° C. The polymerization pressure is preferably from a normal pressure to 6 MPa (60 kg/cm²G). Commonly, the polymerization time is appropriately selected according to the kind of the objective polymer and a reactor, but can be within a range from 1 minute to 20 hours.

In the method for producing a polyolefin resin of the present invention, a chain transfer agent such as hydrogen can also be added to the reaction system so as to adjust the molecular weight of the polymer.

### [Method for Producing Substituted Fluorene Compound (2)]

There is no particular limitation on the method for producing a substituted fluorene compound (2). For example, it can be produced by a known method, e.g., a method described in JP-A-9-87313, preferably a production method including step Ia of reacting a substituted fluorene compound represented by the formula (5) with a metal element-containing basic compound, and step IIa of reacting the compound obtained by step Ia with a compound represented by the formula (6).

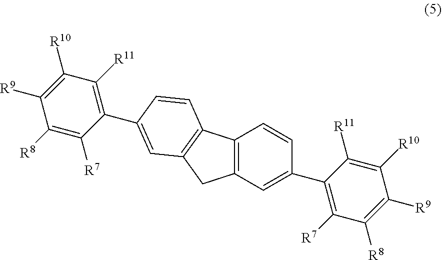

in the formula (5), R⁷, R⁸, R⁹, R¹⁰ and R¹¹ are respectively as defined above;

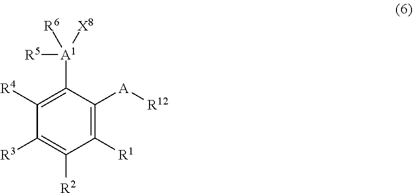

in the formula (6), A, A¹, R¹, R², R³, R⁴, R⁵, R⁶, R¹² and X⁸ are respectively as defined above.

R⁷, R⁸, R⁹, R¹⁰ and R¹¹ in the substituted fluorene compound represented by the formula (5) respectively have the same meanings as those of R⁷, R⁸, R⁹, R¹⁰ and R¹¹ in the formula (1), and preferable range is also the same.

A, A¹, R¹, R², R³, R⁴, R⁵, R⁶ and R¹² in the compound represented by the formula (6) respectively have the same meanings as those of A, B, R¹, R², R³, R⁴, R⁵, R⁶ and R¹² in the formula (2), and preferable range is also the same.

X⁸ in the compound represented by the formula (6) represents a halogen atom and examples thereof include a fluorine atom, a chlorine atom, a bromine atom and an iodine atom, preferably a chlorine atom.

The substituted fluorene compound represented by the formula (5) includes, for example, the following compounds.

2,7-di(2-methylphenyl)fluorene, 2,7-di(3-methylphenyl)fluorene, 2,7-di(4-methylphenyl)fluorene, 2,7-di(2-ethylphenyl)fluorene, 2,7-di(3-ethylphenyl)fluorene, 2,7-di(4-ethylphenyl)fluorene, 2,7-di(2-n-butylphenyl)fluorene, 2,7-di(3-n-butylphenyl)fluorene, 2,7-di(4-n-butylphenyl)fluorene, 2,7-di(2-sec-butylphenyl)fluorene, 2,7-di(3-sec-butylphenyl)fluorene, 2,7-di(4-sec-butylphenyl)fluorene, 2,7-di(2-t-butylphenyl)fluorene, 2,7-di(3-t-butylphenyl)fluorene and 2,7-di(4-t-butylphenyl)fluorene.

The substituted fluorene compound represented by the formula (5) can be produced by a known method, for example, a method described in Organometallics, 23, 1777 (2004).

The metal element-containing basic compound in step Ia means a compound having the same definition as that of the metal element-containing basic compound in step I. The metal element-containing basic compound in step Ia includes, for example, an organic alkaline metal compound such as an organolithium compound; and a metal hydride such as sodium hydride and potassium hydride. The organic alkaline metal compound may be a metal alkoxide such as sodium methoxide and potassium butoxide. The organolithium compound includes, for example, methyllithium, ethyllithium, n-butyllithium, sec-butyllithium, tert-butyllithium, lithium trimethylsilyl acetylide, lithium acetylide, trimethylsilylmethyllithium, vinyllithium, phenyllithium and allyllithium.

The use amount of the metal element-containing basic compound in step Ia is preferably from 0.5 to 5 mol per mol of the substituted fluorene compound represented by the formula (5).

The reaction in step IIa is preferably conducted by adding a compound represented by the formula (6) to the reaction mixture obtained by step Ia.

The use amount of the compound represented by the formula (6) is preferably from 1 to 200 parts by weight, and more preferably from 3 to 50 parts by weight, per part by weight of the substituted fluorene compound represented by the formula (5).

The reaction temperature in a reaction of a substituted fluorene compound represented by the formula (5) with a metal element-containing basic compound, and a reaction of the compound obtained by the reaction with a compound represented by the formula (6) is preferably within a range from −100° C. to a boiling point of the solvent. In the reaction of the substituted fluorene compound represented by the formula (5) with the metal element-containing basic compound, when an organic alkaline metal compound is used as the metal element-containing basic compound, the reaction temperature is more preferably within a range from −80° C. to 40° C.

The reaction of the substituted fluorene compound represented by the formula (5) with the metal element-containing basic compound, and the reaction of the compound obtained by the reaction with the compound represented by the formula (6) is preferably conducted in a solvent which is inert to the reaction.

Examples of the solvent includes polar solvents, for example, an ether-based solvent such as diethylether, tetrahydrofuran and 1,4-dioxane; an amide-based solvent such as hexamethylphosphoric amide and dimethylformamide; and acetonitrile, propionitrile, acetone, diethylketone, methyl isobutyl ketone and cyclohexanone; and aprotic solvents, for example, an aromatic hydrocarbon-based solvent such as benzene and toluene; an aliphatic hydrocarbon-based solvent such as hexane and heptane; and a halogen-based solvent such as dichloromethane, dichloroethane, chlorobenzene and dichlorobenzene.

These solvents can be used alone or in combination of two or more kinds thereof.

The obtained reaction mixture containing a substituted fluorene compound (2) may be used for the subsequent step as it is in the form of a solution, or it may be used after adding water or an aqueous acidic solution, separating the organic layer therefrom, drying and then distilling it off the solvent. However, after distilling off the solvent from the obtained reaction mixture under reduced pressure, the filtrate obtained by removing insoluble substances through filtration with a hydrocarbon-based solvent is preferably concentrated under reduced pressure and used.

The obtained substituted fluorene compound (2) may be further purified by a method such as recrystallization, distillation and column chromatography.

### EXAMPLES

The present invention will be described in more detail by way of Examples, but the scope of the present invention is not limited to these Examples.

### [Production of Hydrogenated-Transition Metal Complex]

Physical properties were measured by the following method.

### (1) Proton Nuclear Magnetic Resonance Spectrum (¹H-NMR)

Apparatus: EX270 manufactured by JEOL, Ltd., or DPX-300 manufactured by Bruker C
Sample cell: 5 mmφ tube
Measuring solvent: CDCl₃ or toluene-d₈
Concentration of sample: 10 mg/0.5 mL (CDCl₃ or toluene-d₈)
Measuring temperature: room temperature (about 25° C.)
Measuring parameter: 5 mmφ probe, MENUF NON, OBNUC ¹H,
Number of integrations: 16 times
Pulse angle: 45 degrees
Repeating time: ACQTM 3 seconds, PD 4 seconds
Internal standard: CDCl₃ (7.26 ppm) or toluene-d₈ (2.09 ppm)

### (2) Mass Spectrum

### [Electron Ionization Mass Spectrometry (EI-MS)]

Apparatus: JMS-T100GC, manufactured by JEOL, Ltd.
Ionization voltage: 70 eV
Ion source temperature: 230° C.
Acceleration voltage: 7 kV

### MASS RANGE: m/z 35-1,000

### Example 1

### Synthesis of diethylsilylene[2,7-di(4-n-butylphenyl)fluoren-9-yl](3-tert-butyl-5-methyl-2-phenoxy)titanium dichloride (Hereinafter Referred to as a Complex 1)

To a tetrahydrofuran [THF] solution (45 mL) of 2,7-di(4-n-butylphenyl)fluorene (2.00 g, 4.64 mmol), a 1.58 mol/L hexane solution (3.09 mL, 4.88 mmol) of n-butyllithium was added dropwise at −78° C. After the dropwise addition, the mixture was warmed to 35° C., followed by stirring at the same temperature for 4 hours.

To the reaction mixture, a solution prepared by dissolving (2-allyloxy-3-tert-butyl-5-methylphenyl) chlorodiethylsilane (1.66 g, 5.11 mmol) in toluene (9 mL) was added dropwise at −78° C., and the mixture was warmed to 35° C., followed by stirring at the same temperature for 3 hours.

To a mixture of 22 mL of aqueous 10% sodium hydrogen carbonate solution and 22 mL of aqueous 10% sodium carbonate solution, the reaction solution was added dropwise at 0° C., followed by extraction with 22 mL of toluene. After drying over sodium sulfate, the solvent was concentrated under reduced pressure to quantitatively obtain (2-allyloxy-3-tert-butyl-5-methylphenyl)[2,7-di(4-n-butylphenyl)fluoren-9-yl]diethylsilane.

¹H-NMR (toluene-d₈): δ (ppm)=0.70-1.10 (m, 16H), 1.22-1.40 (m, 4H), 1.42 (s, 9H), 1.48-1.63 (m, 4H), 2.20 (s, 3H), 2.54 (t, J=7.7 Hz, 4H), 4.28-4.38 (m, 2H), 4.66 (s, 1H), 5.10 (dd, J=10.7, 1.8 Hz, 1H), 5.52 (dd, J=17.3, 1.8 Hz, 1H), 5.81 (ddt, J=17.3, 10.7, 4.0 Hz, 1H), 6.94-7.21 (m, 8H), 7.45-7.70 (m, 6H), 7.78 (d, J=8.6 Hz, 2H)

To a toluene solution (54 mL) of (2-allyloxy-3-tert-butyl-5-methylphenyl)[2,7-di(4-n-butylphenyl)fluoren-9-yl]diethylsilane (3.34 g, 4.64 mmol) and triethylamine (2.11 g, 20.90 mmol), a 1.58 mol/L hexane solution (6.61 mL, 10.45 mmol) of n-butyllithium was added dropwise at −78° C. Furthermore, the mixture was warmed to 35° C., followed by stirring at the same temperature for 4 hours.

To the reaction mixture, a slurry prepared by dispersing dichlorobis(dimethylamido)titanium (1.15 g, 5.57 mmol) in toluene (6 mL) was added dropwise at −78° C. and the mixture was warmed to room temperature. Furthermore, the mixture was heated to 90° C., followed by stirring at the same temperature for 3 hours.

After cooling, the solvent was removed under reduced pressure. Insoluble materials were removed by filtration with heptane and the solvent was removed under reduced pressure. Pentane was added to obtain diethylsilylene[2,7-di(4-n-butylphenyl)fluoren-9-yl](3-tert-butyl-5-methyl-2-phenoxy)bis(dimethylamido)titanium (hereinafter referred to as complex 2) as a yellow solid (1.74 g, yield 46%).

¹H-NMR (CDCl₃): δ (ppm)=0.56 (t, J=7.7 Hz, 6H), 0.82-1.10 (m, 12H), 1.18-1.54 (m, 6H), 1.50 (s, 9H), 1.58-1.74 (m, 4H), 2.36 (s, 3H), 2.68 (s, 12H), 7.11 (s, 1H), 7.25 (s, 1H), 7.23 (d, J=8.1 Hz, 4H), 7.45 (d, J=8.1 Hz, 2H), 7.60 (d, J=8.1 Hz, 2H), 7.85 (s, 2H), 8.01 (d, J=8.1 Hz, 2H)

Mass spectrum (EI, m/z): 812 (M⁺)

The complex 2 (1.00 g, 1.23 mmol) was dissolved in toluene (17 mL), followed by cooling to 0° C. Chlorotrimethylsilane (1.34 g, 12.30 mmol) was added dropwise and the mixture was warmed to 35° C., followed by stirring at the same temperature for 3 hours. The solvent was distilled off under reduced pressure and pentane was added to obtain a solid. The solid was dried under vacuum to obtain complex 1 as a brown solid (0.43 g, yield 43%).

¹H-NMR (CDCl₃): δ (ppm)=0.86-1.00 (m, 6H), 1.05-1.16 (m, 6H), 1.17 (s, 9H), 1.24-1.52 (m, 8H), 1.56-1.70 (m, 4H), 2.47 (s, 3H), 2.65 (t, J=7.6 Hz, 4H), 7.19-7.28 (m, 5H), 7.19-7.40 (m, 5H), 7.79 (s, 2H), 7.82 (d, J=8.6 Hz, 2H), 8.39 (d, J=8.6 Hz, 2H)

Mass spectrum (EI, m/z): 794 (M⁺)

### Example 2

### Synthesis of diethylsilylene[2,7-di(3-methylphenyl)fluoren-9-yl](3-tert-butyl-5-methyl-2-phenoxy)titaniumdichloride (Hereinafter Referred to as a Complex 3)

To a THF solution (56 mL) of 2,7-di(3-methylphenyl)fluorene (2.50 g, 7.22 mmol), a 1.58 mol/L hexane solution (4.80 mL, 7.58 mmol) of n-butyllithium was added dropwise at −78° C. Furthermore, the mixture was warmed to 35° C., followed by stirring at the same temperature for 4 hours.

To the reaction mixture, a solution prepared by dissolving (2-allyloxy-3-tert-butyl-5-methylphenyl) chlorodiethylsilane (2.58 g, 7.94 mmol) in toluene (12 mL) was added dropwise at −78° C. and the mixture was warmed to room temperature. Furthermore, the mixture was warmed to 35° C., followed by stirring at the same temperature for 3 hours.

To a mixture of 28 mL of aqueous 10% sodium hydrogen carbonate solution and 28 mL of aqueous 10% sodium carbonate solution, the reaction solution was added dropwise at 0° C., followed by extraction with 28 mL of toluene. After drying over sodium sulfate, the solvent was concentrated under reduced pressure to quantitatively obtain (2-allyloxy-3-tert-butyl-5-methylphenyl)[2,7-di(3-methylphenyl)fluoren-9-yl]diethylsilane.

¹H-NMR (tolene-d₈): δ (ppm)=0.63-1.09 (m, 10H), 1.42 (s, 9H), 2.19 (s, 3H), 2.26 (s, 6H), 4.29-4.36 (m, 2H), 4.70 (s, 1H), 5.10 (dd, J=10.7, 1.6 Hz, 1H), 5.53 (dd, J=17.3, 1.6 Hz, 1H), 5.82 (ddt, J=17.3, 10.7, 4.0 Hz, 1H), 6.94-7.13 (m, 4H), 7.21 (t, J=7.6 Hz, 2H), 7.30-7.42 (m, 4H), 7.49-7.63 (m, 4H), 7.81 (d, J=8.1 Hz, 2H)

To a toluene solution (74 mL) of (2-allyloxy-3-tert-butyl-5-methylphenyl)[2,7-di(3-methylphenyl)fluoren-9-yl]diethylsilane (4.58 g, 7.21 mmol) and triethylamine (3.28 g, 32.46 mmol), a 1.58 mol/L hexane solution (10.27 mL, 16.23 mmol) of n-butyllithium was added dropwise at −78° C. Furthermore, the mixture was warmed to 35° C., followed by stirring at the same temperature for 4 hours.

To the reaction mixture, a slurry prepared by dispersing dichlorobis(dimethylamido)titanium (1.79 g, 8.66 mmol) in toluene (9 mL) was added dropwise at −78° C. and the mixture was warmed to 90° C., followed by stirring at the same temperature for 3 hours.

After cooling, the solvent was distilled off under reduced pressure. Insoluble materials were removed by filtration with heptane and the solvent was distilled off under reduced pressure. Pentane was added to obtain diethylsilylene[2,7-di(3-methylphenyl)fluoren-9-yl](3-tert-butyl-5-methyl-2-phenoxy)bis(dimethylamido)titanium (hereinafter referred to as complex 4) as a yellow orange solid (2.67 g, yield 51%).

¹H-NMR (CDCl₃): δ (ppm)=0.56 (t, J=7.7 Hz, 6H), 0.80-1.18 (m, 4H), 1.50 (s, 9H), 2.37 (s, 3H), 2.41 (s, 6H), 2.70 (s, 12H), 7.08-7.17 (m, 3H), 7.26 (s, 1H), 7.31 (t, J=7.7 Hz, 2H), 7.40-7.60 (m, 6H), 7.85 (s, 2H), 8.04 (d, J=7.7 Hz, 2H)

Mass spectrum (EI, m/z): 728 (M⁺)

The complex 4 (1.00 g, 1.37 mmol) was dissolved in toluene (17 mL), followed by cooling to 0° C. Chlorotrimethylsilane (1.49 g, 13.72 mmol) was added dropwise and the mixture was warmed to 35° C., followed by stirring at the same temperature for 3 hours. The solvent was distilled off under reduced pressure and pentane was added to obtain a solid. The solid was dried under vacuum to obtain complex 3 as a brown solid (0.77 g, yield 78%).

¹H-NMR (CDCl₃): δ (ppm)=1.15-1.26 (m, 6H), 1.18 (s, 9H), 1.30-1.56 (m, 4H), 2.38 (s, 6H), 2.47 (s, 3H), 7.12-7.23 (m, 4H), 7.26-7.36 (m, 6H), 7.79 (s, 2H), 7.83 (d, J=8.7 Hz, 2H), 8.37 (d, J=8.7 Hz, 2H)

Mass spectrum (EI, m/z): 710 (M⁺)

### Example 3

### Synthesis of diethylsilylene[2,7-di(2-methylphenyl)fluoren-9-yl](3-tert-butyl-5-methyl-2-phenoxy)titaniumdichloride (Hereinafter Referred to as a Complex 5)

To a THF solution (67 mL) of 2,7-di(2-methylphenyl)fluorene (3.00 g, 8.66 mmol), a 1.59 mol/L hexane solution (5.72 mL, 9.09 mmol) of n-butyllithium was added dropwise at −78° C. Furthermore, the mixture was warmed to 35° C., followed by stirring at the same temperature for 4 hours.

To the reaction mixture, a solution prepared by dissolving (2-allyloxy-3-tert-butyl-5-methylphenyl) chlorodiethylsilane (3.10 g, 9.52 mmol) in toluene (14 mL) was added dropwise at −78° C. and the mixture was warmed to room temperature. Furthermore, the mixture was warmed to 35° C., followed by stirring at the same temperature for 3 hours.

To a mixture of 35 mL of aqueous 10% sodium hydrogen carbonate solution and 35 mL of aqueous 10% sodium carbonate solution, the reaction solution was added dropwise at 0° C., followed by extraction with 35 mL of toluene. After drying over sodium sulfate, the solvent was concentrated under reduced pressure to quantitatively obtain (2-allyloxy-3-tert-butyl-5-methylphenyl)[2,7-di(2-methylphenyl)fluoren-9-yl]diethylsilane.

¹H-NMR (CDCl₃): δ (ppm)=0.50-1.00 (m, 10H), 1.28 (s, 9H), 2.18 (s, 6H), 2.25 (s, 3H), 4.37-4.43 (m, 2H), 4.60 (s, 1H), 5.23 (dd, J=10.8, 1.8 Hz, 1H), 5.52 (dd, J=17.3, 1.8 Hz, 1H), 6.01 (ddt, J=17.3, 10.8, 4.0 Hz, 1H), 6.94 (d, J=1.8 Hz, 1H), 7.10-7.35 (m, 13H), 7.86 (d, J=7.7 Hz, 2H)

To a toluene solution (89 mL) of (2-allyloxy-3-tert-butyl-5-methylphenyl)[2,7-di(2-methylphenyl)fluoren-9-yl]diethylsilane (5.50 g, 8.66 mmol) and triethylamine (3.94 g, 38.98 mmol), a 1.58 mol/L hexane solution (12.34 mL, 19.49 mmol) of n-butyllithium was added dropwise at −78° C. Furthermore, the mixture was warmed to 35° C., followed by stirring at the same temperature for 4 hours.

To the reaction mixture, a slurry prepared by dispersing dichlorobis(dimethylamido)titanium (2.15 g, 10.39 mmol) in toluene (10 mL) was added dropwise at −78° C. and the mixture was warmed to 90° C., followed by stirring at the same temperature for 3 hours. After cooling, the solvent was distilled off under reduced pressure. Insoluble materials were removed by filtration with heptane and the solvent was distilled off under reduced pressure.

Toluene (109 mL) was added, followed by cooling to 0° C. Chlorotrimethylsilane (9.40 g, 86.57 mmol) was added dropwise and the mixture was warmed to room temperature. Furthermore, the mixture was warmed to 35° C., followed by stirring at the same temperature for 3 hours. The solvent was distilled off under reduced pressure and pentane was added to obtain a solid. The solid was dried under vacuum to obtain diethylsilylene[2,7-di(2-methylphenyl)fluoren-9-yl](3-tert-butyl-5-methyl-2-phenoxy)(dimethylamido)titanium chloride (hereinafter referred to as a complex 6) as a brown solid (3.29 g, yield 53%).

¹H-NMR (CDCl₃): δ (ppm)=0.85-1.50 (m, 10H), 1.19 (s, 9H), 2.09 (s, 3H), 2.36 (s, 3H), 2.41 (s, 3H), 2.78 (s, 6H), 6.96 (d, J=7.6 Hz, 1H), 7.05-7.23 (m, 6H), 7.28-7.48 (m, 6H), 7.72 (s, 1H), 8.20 (d, J=8.4 Hz, 1H), 8.36 (d, J=8.4 Hz, 1H)

Mass spectrum (EI, m/z): 719 (M⁺)

The complex 6 (1.00 g, 1.39 mmol) was dissolved in toluene (17 mL), followed by cooling to 0° C. Chlorotrimethylsilane (1.51 g, 13.88 mmol) was added dropwise and the mixture was warmed to 35° C., followed by stirring at the same temperature for 3 hours. The solvent was distilled off under reduced pressure and pentane was added to obtain a solid, which was vacuum-dried to obtain Complex 5 as a brown solid (0.83 g, yield 84%).

¹H-NMR (CDCl₃): δ (ppm)=1.04 (t, J=7.6 Hz, 6H), 1.17-1.48 (m, 4H), 1.23 (s, 9H), 2.21 (s, 6H), 2.37 (s, 3H), 7.12 (s, 1H), 7.15-7.33 (m, 9H), 7.60 (d, J=8.4 Hz, 2H), 7.62 (s, 2H), 8.34 (d, J=8.4 Hz, 2H)

Mass spectrum (EI, m/z): 710 (M⁺)

### [Polymerization]

Physical properties of the polymer in Examples were measured by the following method.

### [Molecular Weight and Molecular Weight Distribution]

Using Rapid GPC (manufactured by Symyx), the measurement was conducted under the following conditions.

Delivery apparatus: (LC pump), manufactured by Gilson

Model 305 (pump head 25.SC)

Column: polymer, manufactured by PolymerLaboratories (PL)

PLgel Mixed-B 10 μm

7.5 mmφ×300 mm

Mobile phase: o-dichlorobenzene
Dissolving solvent: 1,2,4-trichlorobenzene
Flow rate: 2 ml/minute
Column temperature: 160° C.
Calibration curve: Standard polystyrene (PS), 8 samples manufactured by PL (Standard PS molecular weight: 5,000, 10,050, 28,500, 65,500, 185, 400, 483,000, 1,013,000, 3,390,000)

Using DSC6200R manufactured by Seiko Instruments Inc., DSC was measured under the following conditions.

20° C.→temperature rising at 20° C./minute→200° C. (holding for 10 minutes)→temperature falling at −20° C./minute→−100° C. (holding for 10 minutes)→temperature rise at 20° C./minute→200° C. (holding for 10 minutes)

### Example 4

In an autoclave, 5.0 mL of toluene was charged under nitrogen and stabilized at 40° C., and then 1-butene was pressurized to 0.10 MPa and stabilized. Thereto, triisobutylaluminum (toluene solution, 40 μmol), diethylsilylene[2,7-di(3-methylphenyl)fluoren-9-yl](3-tert-butyl-5-methyl-2-phenoxy)titaniumdichloride (complex 3, toluene solution, 0.1 μmol) and N,N-dimethylanilinium tetrakis(pentafluorophenyl)borate (toluene solution, 0.3 μmol) were charged and polymerized at 40° C. for 18 minutes. As a result of the polymerization, a polymer was produced in the amount of 3.6×10⁶ g per mol of a complex per hour. Mw was 43,000 and Mw/Mn was 1.6. By the measurement of DSC, a melting point was not observed. It was considered from the results of the measurement of DSC that the obtained polymer has an atactic structure.

### Example 5

The same operation was carried out, except that diethylsilylene[2,7-di(3-methylphenyl)fluoren-9-yl](3-tert-butyl-5-methyl-2-phenoxy)titaniumdichloride (complex 3) was changed to diethylsilylene[2,7-di(4-n-butylphenyl)fluoren-9-yl](3-tert-butyl-5-methyl-2-phenoxy)titaniumdichloride (complex 1) and the polymerization time was changed to 11 minutes in Example 4. As a result of the polymerization, a polymer was produced in the amount of 22.7×10⁶ g per mol of a complex per hour.

Mw was 280,000 and Mw/Mn was 1.9. By the measurement of DSC, a melting point was not observed. It was considered from the results of the measurement of DSC that the obtained polymer has an atactic structure.

### Comparative Example 1

The same operation was carried out, except that diethylsilylene[2,7-di(3-methylphenyl)fluoren-9-yl](3-tert-butyl-5-methyl-2-phenoxy)titaniumdichloride (complex 3) was changed to diethylsilylene(2,7-diphenylfluoren-9-yl)(3-tert-butyl-5-methyl-2-phenoxy)titaniumdichloride and the polymerization time was changed to 3 minutes in Example 4. As a result of the polymerization, a polymer was produced in the amount of 34.6×10⁶ g per mol of a complex per hour. Mw was 35,000 and Mw/Mn was 1.5. By the measurement of DSC, a melting point was not observed. It was considered from the results of the measurement of DSC that the obtained polymer has an atactic structure.

### INDUSTRIAL APPLICABILITY

The transition metal complex of the present invention is useful as a catalyst for olefin polymerization in the production of a poly-1-butene polymer. Since a method for producing a polyolefin resin of the present invention uses the transition metal complex as a catalyst, the poly-1-butene polymer can be easily obtained. The substituted fluorene compound of the present invention is useful as a precursor of the transition metal complex.

1. A transition metal complex represented by the following formula (1): 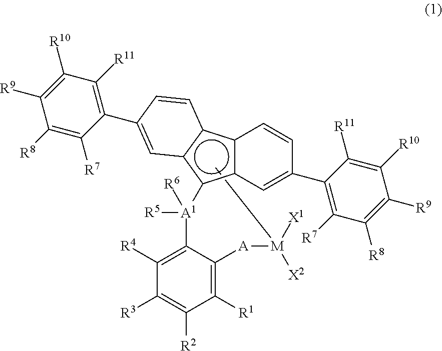
in the formula (1), M represents a Group 4 transition metal atom of the Periodic Table of elements; A represents a Group 16 atom of the Periodic Table of elements; A¹ represents a Group 14 atom of the Periodic Table of elements; X¹ and X² each independently represents a hydrogen atom, a halogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom, or a hydrocarbon disubstituted amino group having 2 to 20 carbon atoms; R¹, R², R³ and R⁴ each independently represents a hydrogen atom, a halogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, a hydrocarbon-substituted silyl group having 1 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom, or a hydrocarbon disubstituted amino group having 2 to 20 carbon atoms; R⁵ and R⁶ each independently represents a hydrogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, a hydrocarbon-substituted silyl group having 1 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom, or a hydrocarbon disubstituted amino group having 2 to 20 carbon atoms and, in R¹, R², R³, R⁴, R⁵ and R⁶, adjacent groups are optionally joined to form a ring; and R⁷, R⁸, R⁹, R¹⁰ and R¹¹ each independently represents a hydrogen atom or an alkyl group having 1 to 20 carbon atoms optionally substituted with a halogen atom and at least one of them is not a hydrogen atom.

2. The transition metal complex according to claim 1, wherein R⁷ and R¹¹ are hydrogen atoms.

3. The transition metal complex according to claim 1, wherein A is an oxygen atom.

4. The transition metal complex according to claim 1, wherein R¹ is an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, or a hydrocarbon-substituted silyl group having 1 to 20 carbon atoms optionally substituted with a halogen atom.

5. The transition metal complex according to claim 1, wherein M is a titanium atom.

6. The transition metal complex according to claim 1, wherein A¹ is a silicon atom.

7. The transition metal complex according to claim 1, wherein X¹ and X² each independently is a halogen atom.

8. The transition metal complex according to claim 1, wherein at least one of R⁸, R⁹ and R¹⁰ is an alkyl group having 1 to 20 carbon atoms.

9. The transition metal complex according to claim 1, wherein R⁹ is an alkyl group having 1 to 20 carbon atoms.

10. The transition metal complex according to claim 9, wherein R⁹ is a n-butyl group.

11. The transition metal complex according to claim 1, wherein R⁹ is an alkyl group having 1 to 20 carbon atoms, and all of R⁷, R⁸, R¹⁰ and R¹¹ are hydrogen atoms.

12. The transition metal complex according to claim 11, wherein R⁹ is a n-butyl group, and all of R⁷, R⁸, R¹⁰ and R¹¹ are hydrogen atoms.

13. The transition metal complex according to claim 1, which is a transition metal complex represented by the following formula (1-1):

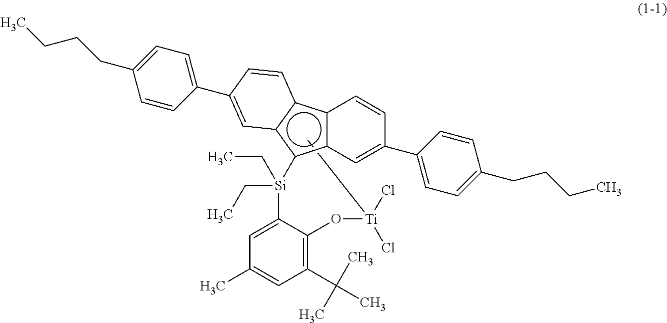

14. A method for producing the transition metal complex according to claim 1, comprising the step I and II:
step I: reacting a substituted fluorene compound represented by the formula (2) with a metal element-containing basic compound, and
step II: reacting the compound obtained by step I with a dihalogenated diamido transition metal complex represented by the formula (3). 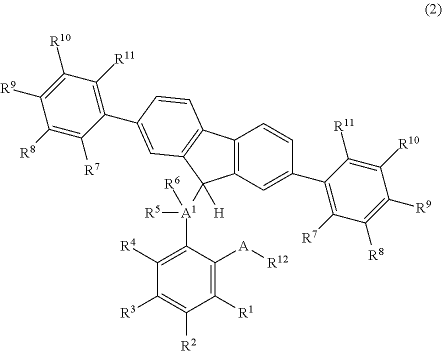
in the formula (2), A represents a Group 16 atom of the Periodic Table of elements; A¹ represents a Group 14 atom of the Periodic Table of elements; R¹, R², R³ and R⁴ each independently represents a hydrogen atom, a halogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, a hydrocarbon-substituted silyl group having 1 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom, or a hydrocarbon disubstituted amino group having 2 to 20 carbon atoms; R⁵ and R⁶ each independently represents a hydrogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, a hydrocarbon-substituted silyl group having 1 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom, or a hydrocarbon disubstituted amino group having 2 to 20 carbon atoms and, in R¹, R², R³, R⁴, R⁵ and R⁶, adjacent groups are optionally joined to form a ring; R⁷, R⁸, R⁹, R¹⁰ and R¹¹ each independently represents a hydrogen atom, or an alkyl group having 1 to 20 carbon atoms optionally substituted with a halogen atom, and at least one of them is not a hydrogen atom; and R¹² represents a hydrocarbon group or a trisubstituted silyl group, and the hydrocarbon group is optionally substituted with a halogen atom or an alkoxy group; 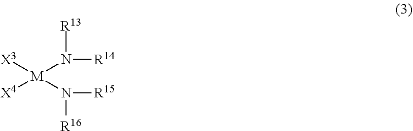
in the formula (3), M represents a Group 4 element of the Periodic Table of elements; R¹³, R¹⁴, R¹⁵ and R¹⁶ each independently represents an alkyl group having 1 to 20 carbon atoms, an aryl group having 6 to 20 carbon atoms, or an aralkyl group having 7 to 20 carbon atoms and, in R¹³, R¹⁴, R¹⁵ and R¹⁶, the alkyl group, the aryl group or the aralkyl group is optionally substituted with a halogen atom, R¹³ and R¹⁴ are optionally joined to form a ring, R¹⁵ and R¹⁶ are optionally joined to form a ring; and X³ and X⁴ represent halogen atoms.

15. The method for producing the transition metal complex according to claim 14, which further comprises step III.
step III: reacting the transition metal complex obtained by step II with a halogenated silyl compound represented by the formula (4): 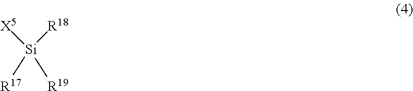
in the formula (4), R¹⁷, R¹⁸ and R¹⁹ each independently represents a halogen atom, an alkyl group having 1 to 20 carbon atoms, an aryl group having 6 to 20 carbon atoms, or an aralkyl group having 7 to 20 carbon atoms and, in R¹⁷, R¹⁸ and R¹⁹, the alkyl group, the aryl group or the aralkyl group is optionally substituted with a halogen atom, and two of R¹⁷, R¹⁸ and R¹⁹ are optionally joined to form a ring; and X⁵ represents a halogen atom.

16. An olefin polymerization catalyst comprising the transition metal complex according to claim 1 as a constituent component.

17. The olefin polymerization catalyst according to claim 16, which is for homopolymerization of 1-butene.

18. A method for producing a polyolefin resin, which comprises the step of polymerizing an olefin in the presence of the olefin polymerization catalyst according to claim 16.

19. The method for producing a polyolefin resin according to claim 18, wherein the olefin is 1-butene.

20. A substituted fluorene compound represented by the formula (2): 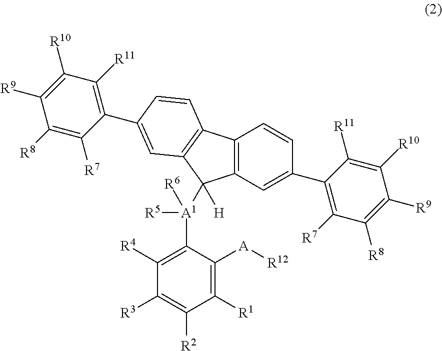
in the formula (2), A represents a Group 16 atom of the Periodic Table of elements; A¹ represents a Group 14 atom of the Periodic Table of elements; R¹, R², R³ and R⁴ each independently represents a hydrogen atom, a halogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, a hydrocarbon-substituted silyl group having 1 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom, or a hydrocarbon disubstituted amino group having 2 to 20 carbon atoms; R⁵ and R⁶ each independently represents a hydrogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, a hydrocarbon-substituted silyl group having 1 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom, or a hydrocarbon disubstituted amino group having 2 to 20 carbon atoms and, in R¹, R², R³, R⁴, R⁵ and R⁶, adjacent groups are optionally joined to form a ring; R⁷, R⁸, R⁹, R¹⁰ and R¹¹ each independently represents a hydrogen atom or an alkyl group having 1 to 20 carbon atoms optionally substituted with a halogen atom, and at least one of them is not a hydrogen atom; and R¹² represents a hydrocarbon group or a trisubstituted silyl group, and the hydrocarbon group is optionally substituted with a halogen atom or an alkoxy group.

21. The substituted fluorene compound according to claim 20, wherein R⁷ and R¹¹ are hydrogen atoms.

22. The substituted fluorene compound according to claim 20, wherein A¹ is a silicon atom.

23. The substituted fluorene compound according to claim 20, which is a ligand precursor of a transition metal complex.

24. The substituted fluorene compound according to claim 20, which is a ligand precursor of a transition metal complex for homopolymerization of 1-butene.

25. A method for producing the substituted fluorene compound according to claim 20, which comprises step Ia and IIa:
step Ia: reacting a substituted fluorene compound represented by the formula (5) with a metal element-containing basic compound, and
step IIa: reacting the compound obtained by step Ia with a compound represented by the formula (6): 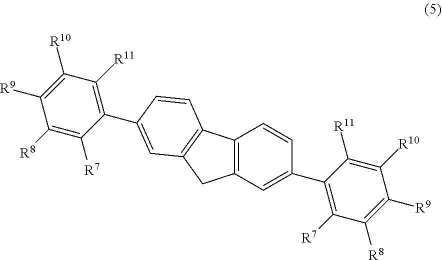
in the formulas (5), R⁷, R⁸, R⁹, R¹⁰ and R¹¹ each independently represents a hydrogen atom or an alkyl group having 1 to 20 carbon atoms optionally substituted with a halogen atom, and at least one of R⁷, R⁸, R⁹, R¹⁰ and R¹¹ is not a hydrogen atom; 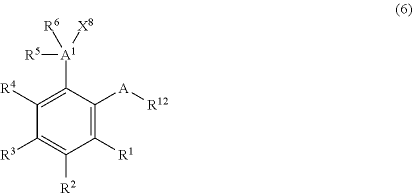
in the formula (6), A represents a Group 16 atom of the Periodic Table of elements; A¹ represents a Group 14 atom of the Periodic Table of elements; R¹, R², R³ and R⁴ each independently represents a hydrogen atom, a halogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, a hydrocarbon-substituted silyl group having 1 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom, or a hydrocarbon disubstituted amino group having 2 to 20 carbon atoms; R⁵ and R⁶ each independently represents a hydrogen atom, an alkyl group having 1 to 20 carbon atoms optionally substituted with a halogen atom, an aralkyl group having 7 to 20 carbon atoms optionally substituted with a halogen atom, an aryl group having 6 to 20 carbon atoms optionally substituted with a halogen atom, a hydrocarbon-substituted silyl group having 1 to 20 carbon atoms optionally substituted with a halogen atom, an alkoxy group having 1 to 20 carbon atoms optionally substituted with a halogen atom, an aralkyloxy group having 7 to 20 carbon atoms optionally substituted with a halogen atom, an aryloxy group having 6 to 20 carbon atoms optionally substituted with a halogen atom or a hydrocarbon disubstituted amino group having 2 to 20 carbon atoms and, in R¹, R², R³, R⁴, R⁵ and R⁶, adjacent groups are optionally joined to form a ring; R¹² represents a hydrocarbon group or a trisubstituted silyl group, and the hydrocarbon group is optionally substituted with a halogen atom or an alkoxy group; and X⁸ represents a halogen atom.
